(19) United States
(12) Patent Application Publication
(10) Pub. No.: US 2001/0047284 A1
(43) Pub. Date: Nov. 29, 2001

(54) Method and system for negotiating transportation contracts via a global computer network

(76) Inventors: Paul Clark Blalock, Lakeland, FL (US); Matthew R. Craft, Lexington, KY (US); Benjamin Lee Kessinger III, Lexington, KY (US); Thomas Warfield Kinkead III, Lexington, KY (US); Robert Hunter Jackson, Raleigh, NC (US)

Correspondence Address: STITES & HARBISON, PLLC, 400 W MARKET ST, SUITE 1800, LOUISVILLE, KY, 40202-3352, US

(21) Appl. No.: 09/775,265

(22) Filed: Feb. 1, 2001

Related U.S. Application Data
(60) Provisional application No. 60/178,919, filed on Feb. 1, 2000.

(51) Int. Cl. G06F 17/60

(52) U.S. Cl. 705/8; 705/37

(57) ABSTRACT

A method and system for the negotiation of transportation contracts between shippers and carriers is implemented via a computer network—preferably the Internet. Through an Internet web site interface, a shipper can post a request for quotation (“RFQ”), soliciting bids for a plurality of transportation lanes from approved carriers through an automated bidding and negotiation process. Carriers can then view the posted RFQ, identify the lanes they would like to bid on, and then can submit such bids through the web site interface. Once bidding has closed, through the same web site interface, the shipper can view all bids and award lanes to selected carriers. Finally, again using the web site interface, each carrier can view the awards that have been made to it and choose whether or not to accept them.

### BACKGROUND OF THE INVENTION

This application claims priority from U.S. provisional application 60/178,919 filed Feb. 1, 2000 and relates to a method and system for the negotiation of transportation contracts between shippers and carriers (and/or other third parties, such and third party logistics providers and freight forwarders) which is preferably implemented through an Internet web site. The entire disclosure contained in U.S. provisional application 60/178,919, including the attachments thereto, is incorporated herein by this reference.

Manufacturers, wholesalers, and retailers of consumer and other products expend substantial time and resources in arranging for transportation to ship their products. Currently, it is common for mid-size and large shippers to solicit bids from and negotiate annual contracts with freight carriers to meet their shipping needs. Such a bidding and negotiation process is exceedingly cumbersome, time-consuming and often inefficient. Typically, a shipper will provide representatives of various freight carriers with a packet of information that defines the shipper's requirements and sets forth all transportation routes (commonly referred to as “lanes”) for which the shipper needs coverage, along with other information to aid the carriers in submitting informed bids, such as contractual parameters. Since, in the case of a large shipper, the packet of information may refer to more than 7500 lanes for which the shipper needs coverage, the packet is often distributed in electronic form on a magnetic diskette or other machine-readable medium. Alternatively, a shipper may choose not to open bidding at all because of the costs and time associated with the bidding and negotiation process, and/or the lack of expertise in conducting such formal bidding.

Once a freight carrier receives such a packet of information, it must be manually reviewed and analyzed so that the carrier can determine which lanes it would like to bid on. The carrier must then consider many variables that ultimately factor into its bid, including, but not limited to: point of origin, point of destination, demand, weight, accessorials, distance, or other special requirements or needs of the shipper. After taking all of these variables into account, the carrier must then consider its own internal requirements and limitations, such as equipment availability and allocation and the potential profitability of the business. Finally, after careful analysis, the carrier makes a decision as to which lanes to bid on, and the appropriate bid data is entered into a spreadsheet, e.g., price per mile and truck capacity. In addition, the carrier is often required to provide quotes for accessorials, equipment commitments to shipping facilities, rates for “Freight of All Kinds” (“FAK”) matrices, and other information related to its ability to handle the business. A completed bid package is returned to the shipper either in hard-copy form or on a magnetic diskette or other machine-readable medium.

The shipper receiving completed bid packages is then saddled with the onerous task of sifting through each package, aggregating and analyzing the bids for each lane. Based on such analysis, the shipper then chooses a carrier for each lane and offers the carrier a transportation contract for that lane.

Finally, the awards are communicated to the carriers for review and acceptance.

It is a paramount object of the present invention to provide a method and system that establishes an efficient marketplace for the negotiation of transportation contracts between shippers and carriers, and/or other third parties, such and third party logistics providers and freight forwarders.

It is a further object of the present invention to provide a method and system that provides for a dynamic negotiation of single and multi-modal contracts through blind bidding or through a competitive marketplace employing a quasi-reverse auction format.

It is a still another object of the present invention to provide a method and system that includes a database for maintaining identifying information, including profiles, associated with each participating shipper and carrier, along with all pertinent data and information associated with the bidding and negotiation process.

It is yet another object of the present invention to provide a method and system that includes an approval/qualification component for determining which carriers are eligible to participate in the bid process for any specific offering.

It is still yet another object of the present invention to provide a method and system that allows for customization based on participating shipper requirements and needs.

These and other objects and advantages of the present invention will become apparent upon a reading of the following description.

### SUMMARY OF THE INVENTION

The present invention is a method and system for the negotiation of transportation contracts between shippers and carriers which is implemented via a computer network—preferably the Internet. Specifically, through an Internet web site interface, the method and system of the present invention allows shippers to post a request for quotation (“RFQ”), soliciting bids for a plurality of transportation lanes from approved carriers through an automated bidding and negotiation process. Carriers can view each and every detail of a posted RFQ, including identification of each of the lanes, bidding parameters, etc. Carriers can also filter and/or sort lane information, viewing only lanes meeting certain criteria, such as origin, destination, mileage, and/or equipment. Through such filtering and sorting techniques, each carrier can identify which lanes it would like to bid on and then can submit such bids through the web site interface.

During the bidding process, the carriers can also view accessorial and Freight Any Kind (“FAK”) matrices associated with each RFQ, submitting appropriate bids for these components of the RFQ as well. Once bidding has closed, through the same web site interface, the shipper can view all bids and then award lanes to selected carriers. Finally, again using the web site interface, each carrier can view the awards that have been made to it and choose whether or not to accept them.

### DESCRIPTION OF THE FIGURES

FIG. 1 is a flow chart depicting general operation of and movement through a preferred embodiment of the method and system of the present invention from the perspective of a shipper;

FIG. 2 depicts the LOGIN SCREEN, as displayed in an Internet browser, in a preferred embodiment of the method and system of the present invention;

FIG. 3 depicts the MAIN SHIPPER SCREEN, as displayed in an Internet browser, in a preferred embodiment of the method and system of the present invention;

FIG. 4 depicts the PERSONAL PROFILE SCREEN, as displayed in an Internet browser, in a preferred embodiment of the method and system of the present invention;

FIG. 5 depicts the RFQ SCREEN, as displayed in an Internet browser, in a preferred embodiment of the method and system of the present invention;

FIG. 6 depicts the RFQ SUMMARY SCREEN, as displayed in an Internet browser, in a preferred embodiment of the method and system of the present invention;

FIG. 7 depicts the RFQ LANES SCREEN, as displayed in an Internet browser, in a preferred embodiment of the method and system of the present invention;

FIG. 8 depicts the RFQ FILTERS SCREEN, as displayed in an Internet browser, in a preferred embodiment of the method and system of the present invention;

FIG. 9 depicts the LANES DETAIL SCREEN, as displayed in an Internet browser, in a preferred embodiment of the method and system of the present invention;

FIG. 10 depicts the RFQ ACCESSORIALS SCREEN, as displayed in an Internet browser, in a preferred embodiment of the method and system of the present invention;

FIG. 11 depicts the RFQ MATRIX SCREEN, as displayed in an Internet browser, in a preferred embodiment of the method and system of the present invention;

FIG. 12 depicts the CARRIERS STATUS SCREEN, as displayed in an Internet browser, in a preferred embodiment of the method and system of the present invention;

FIG. 13 depicts the RFQ AWARDS SUMMARY SCREEN, as displayed in an Internet browser, in a preferred embodiment of the method and system of the present invention;

FIG. 14 depicts the RFQ AWARD DETAILS BY CARRIER SCREEN, as displayed in an Internet browser, in a preferred embodiment of the method and system of the present invention;

FIG. 15 depicts the RFQ ATTACHMENTS SCREEN, as displayed in an Internet browser, in a preferred embodiment of the method and system of the present invention;

FIG. 16 depicts the RFQ BID PROGRESS SCREEN, as displayed in an Internet browser, in a preferred embodiment of the method and system of the present invention;

FIG. 17 depicts the CARRIER LIST SCREEN, as displayed in an Internet browser, in a preferred embodiment of the method and system of the present invention;

FIG. 18 depicts the CARRIER LIST DETAIL SCREEN, as displayed in an Internet browser, in a preferred embodiment of the method and system of the present invention;

FIG. 19 depicts the CARRIER STOREFRONT SCREEN, as displayed in an Internet browser, in a preferred embodiment of the method and system of the present invention;

FIG. 20 depicts the SHIP SITES SCREEN, as displayed in an Internet browser, in a preferred embodiment of the method and system of the present invention;

FIG. 21 depicts the SHIPPER PROFILE SCREEN, as displayed in an Internet browser, in a preferred embodiment of the method and system of the present invention;

FIG. 22 depicts a pop-up help window, as displayed in an Internet browser, in a preferred embodiment of the method and system of the present invention;

FIG. 23 is a flow chart depicting general operation of and movement through a preferred embodiment of the method and system of the present invention from the perspective of a carrier;

FIG. 24 depicts the MAIN CARRIER SCREEN, as displayed in an Internet browser, in a preferred embodiment of the method and system of the present invention;

FIG. 25 depicts the RFQ SCREEN, as displayed in an Internet browser, in a preferred embodiment of the method and system of the present invention;

FIG. 26 depicts the RFQ SUMMARY SCREEN, as displayed in an Internet browser, in a preferred embodiment of the method and system of the present invention;

FIG. 27 depicts the RFQ LANES SCREEN, as displayed in an Internet browser, in a preferred embodiment of the method and system of the present invention;

FIG. 28 depicts the ACCESSORIALS SCREEN, as displayed in an Internet browser, in a preferred embodiment of the method and system of the present invention;

FIG. 29 depicts the MATRIX FILTER SCREEN, as displayed in an Internet browser, in a preferred embodiment of the method and system of the present invention;

FIG. 30 depicts the RFQ MATRIX SCREEN, as displayed in an Internet browser, in a preferred embodiment of the method and system of the present invention;

FIG. 31 depicts the AWARDS DETAIL SCREEN, as displayed in an Internet browser, in a preferred embodiment of the method and system of the present invention;

FIG. 32 depicts the SHIPPERS SEARCH SCREEN, as displayed in an Internet browser, in a preferred embodiment of the method and system of the present invention;

FIG. 33 depicts the SHIPPER STOREFRONT SCREEN, as displayed in an Internet browser, in a preferred embodiment of the method and system of the present invention;

FIG. 34 depicts the CARRIER PROFILE SCREEN, as displayed in an Internet browser, in a preferred embodiment of the method and system of the present invention;

FIG. 35 depicts a pop-up help window, as displayed in an Internet browser, in a preferred embodiment of the method and system of the present invention; and

FIG. 36 is a schematic representation of the computer network associated with a preferred embodiment of the method and system of the present invention.

### DESCRIPTION OF THE PRESENT INVENTION

The following invention pertains to a method and system for the negotiation of transportation contracts between shippers and carriers which is preferably implemented through an Internet web site.

Of particular importance, the terms “shipper” and carrier” are used generically throughout this description and the appended claims. A “shipper” includes actual shippers of products and/or other third parties (e.g., a third party logistics provider or freight forwarder) serving as intermediaries, arranging product shipment for a manufacturer, wholesaler, or retailer. Similarly, a “carrier” includes providers of transportation services and/or other third parties and intermediaries who arrange for such services.

Also, at the outset, it should be understood that the Internet is but one computer network over which the method and system of the present invention could be practiced. Other public and private computer networks could be used without departing from the spirit and scope of the present invention. Nevertheless, because it can be easily accessed through almost any existing personal computer and without the need for specialized hardware or software, the Internet is the preferred network for implementation of the method and system of the present invention.

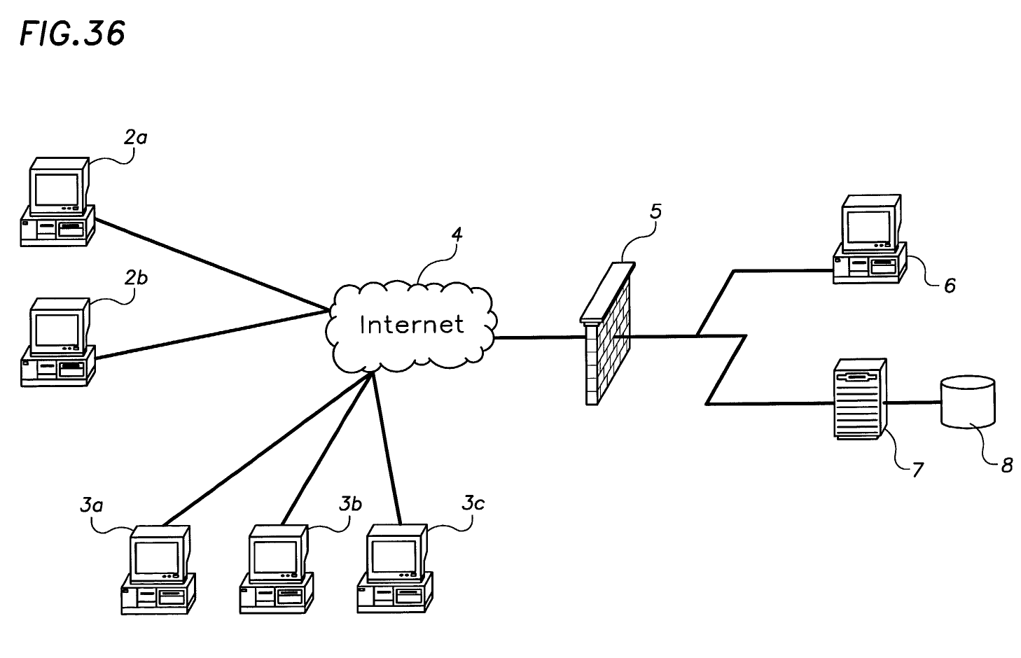

FIG. 36 is a schematic representation of the computer network associated with a preferred embodiment of the method and system of the present invention. Specifically, each individual user, whether a shipper (generally indicated by reference numerals 2a, 2b) or a carrier (generally indicated by reference numerals 3a, 3b, 3c), has access to the Internet 4. Via the Internet 4, shippers and carriers can access a web server 7 hosting the web site of the method and system of the present invention. However, as shown in FIG. 36, to protect the web server 7 from unauthorized access, the server 7 is preferably secured behind a firewall 5.

Associated with the web server is an integral database 8, which is the storage location for all data about users of the system, whether they be shippers or carriers, along with all pertinent data and information associated with the bidding and negotiation process. This integral database 8 will be described in further detail below.

Lastly, with respect to the schematic representation of FIG. 36, one or more administrative computers 6 may provide direct access to the web server 7 and associated integral database 8.

The most widely used portion of the Internet is the World Wide Web (“WWW”) which provides for navigation through the selection of, or “clicking” of, hypertext images and text. Such hypertext images and text are an important feature of standard Hypertext Markup Language (HTML), the programming language that forms the backbone of the WWW. To carry out execution of the routines and subroutines of the preferred system as described herein, it is understood that standard Hypertext Markup Language (HTML) and associated programming languages and techniques would be used. With benefit of the following description, such programming is readily accomplished by one of ordinary skill in the art.

Prior to viewing the various components and features of the preferred method and system as implemented through an Internet web site, the operation of the method and system is best explained by an example:

ABC Company is an appliance manufacturer who ships products nationwide from its five manufacturing and distribution facilities. Because of its nationwide distribution, it must secure carrier contracts for more than 5,000 different transportation lanes. Working with system administrators, ABC Company prepares its annual Request for Quotation (“RFQ”) in electronic form for viewing through the Internet web site implementing the method and system of the present invention. Specifically, the RFQ is stored in an integral database resident on an Internet-accessible web server.

Through the Internet web site, participating carriers can view each and every detail of the RFQ, including identification of each of the lanes, bidding parameters, etc. Moreover, participating carriers can quickly and easily filter and/or sort lane information contained the RFQ, viewing only lanes meeting certain criteria, such as origin, destination, mileage, and/or equipment. Through such filtering and sorting techniques, each carrier can identify which lanes it would like to bid on, and which lanes its equipment availability and allocation will allow it to bid on. After making such determinations, rather than preparing a complete written bid package, each carrier can submit its bids, lane by lane, through the web site interface.

Throughout the bidding process, ABC Company can monitor the progress of bidding through the web site. ABC Company can also focus on particular lanes through filtering and sorting techniques. Furthermore, with respect to each lane, ABC Company can see how many bids have been submitted along with summary data such the low, average, and high bids. Once bidding has closed, through the same web site interface, ABC Company can accept certain bids and award business to selected carriers. The awards may be of varying levels (indicating preference) and may also vary by anticipated volume of business.

In this regard, depending on shipper preference, the method and system of the present invention conducts the negotiations though a blind bidding process or in a quasi-reverse auction format. Specifically, a shipper may choose not to allow carriers to view information associated with other carrier bids, or the shipper may choose to post bids “publicly” via the web site to create a dynamic bidding process. In any event, most shippers have a variety of selection criteria with respect to an award of a transportation contract, and, as such, low bidding does not guarantee a carrier an award.

Finally, in the last step of the bidding and negotiation process, the carriers can view the awards that have been made and choose whether or not to accept them. Once accepted, the negotiation is complete. An electronic notification is sent to ABC Company, and appropriate written contracts may be executed.

As will become clearer with a review of the complete disclosure contained herein, a shipper (e.g., ABC Company) negotiating its transportation contracts though the method and system of the present invention will realize many benefits, including the following:

(a) Shippers can reduce labor, time, and costs associated with manual RFQ methods;

(b) Shippers can obtain true marketplace pricing because contracts are awarded based on bids received a few days ago instead of months ago;

(c) Shippers can conduct bids on a seasonal basis for specific requirements;

(d) Shippers can conduct more frequent RFQs with less effort;

(e) Shippers can access the method and system of the present invention through a standard Internet browser;

(f) Shippers can specify which carriers are granted or denied access to certain RFQs;

(g) Shippers can receive RFQ updates instantly;

(h) Shippers can review and analyze submitted bids according to their individual specifications through filtering and sorting techniques;

(i) Shippers can notify, accept or reject bids electronically based on their individual criteria;

(j) Shippers can access carrier profile information; and

(k) Shippers can electronically exchange other information or messages with carriers before, during, and after the bidding and negotiation process.

Similarly, as will become clearer with a review of the complete disclosure contained herein, a carrier negotiating transportation contracts though the method and system of the present invention will also realize many benefits, including the following:

(a) Carriers can submit frequently requested information, e.g., equipment type, driver information, payment terms, insurance, and certificates one time and store the information online for shipper access;

(b) Carriers can increase profitability by reviewing lane data to determine which opportunities best fit their respective equipment availability and allocation;

(c) Carriers can optimize assets and better forecast demand;

(d) Carriers can receive timely electronic notification of bid acceptance or rejection from shippers;

(e) Carriers can improve accuracy as contracts are being awarded based on bids received a few days ago instead of months ago; and

(f) Carriers can see how their bids compare to other carriers' bids, thus allowing to better position their bids with an understanding of current market pricing.

The appended Figures depict various exemplary screen shots of a preferred method and system in accordance with the present invention, along with flow charts that demonstrate general use of and movement through the system by users.

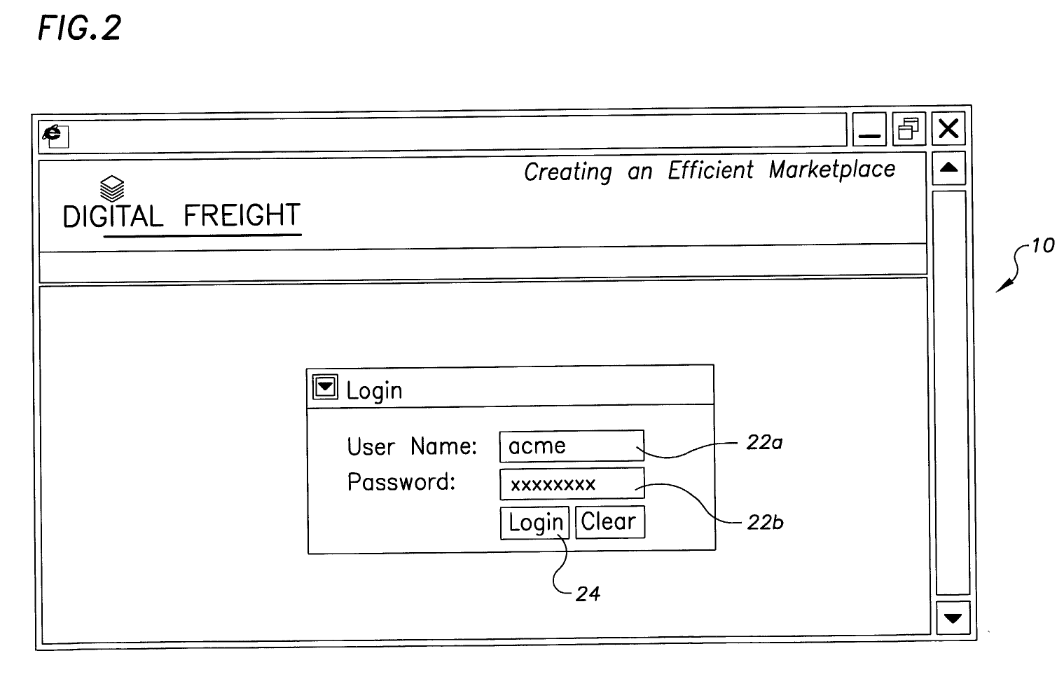

FIG. 2 depicts the LOGIN SCREEN 10 for a preferred embodiment of the method and system of with the present invention, said screen 10 being displayed in an Internet browser, in this case, the commonly used Microsoft Internet Explorer®. To gain entry into the system, a registered user of the system, whether it is a shipper or carrier, enters the appropriate “User Name” and “Password” in the appropriate data entry fields 22a, 22b. The requisite information can be entered into the data entry fields 22a, 22b using a conventional computer keyboard or similar peripheral device. Once the requisite data has been entered, the user can select the LOGIN button 24. When the user selects the LOGIN button 24, the system first verifies that the user name and password entered in data entry fields 22a and 22b match records maintained in the integral database (as indicated by reference numeral 8 in FIG. 36), and the user is directed to the appropriate customized home page, as will be described in further detail below. In this regard, the integral database is the storage location for all data about users of the system, whether they be shippers or carriers, along with all pertinent data and information associated with the bidding and negotiation process. The specific architecture and design of this database is not essential to the method and system of the present invention provided that the database can meet the storage and retrieval requirements set forth herein. Various commercial software packages and/or programming techniques could be used by those skilled in the art to develop this database without departing from the spirit and scope of the present invention.

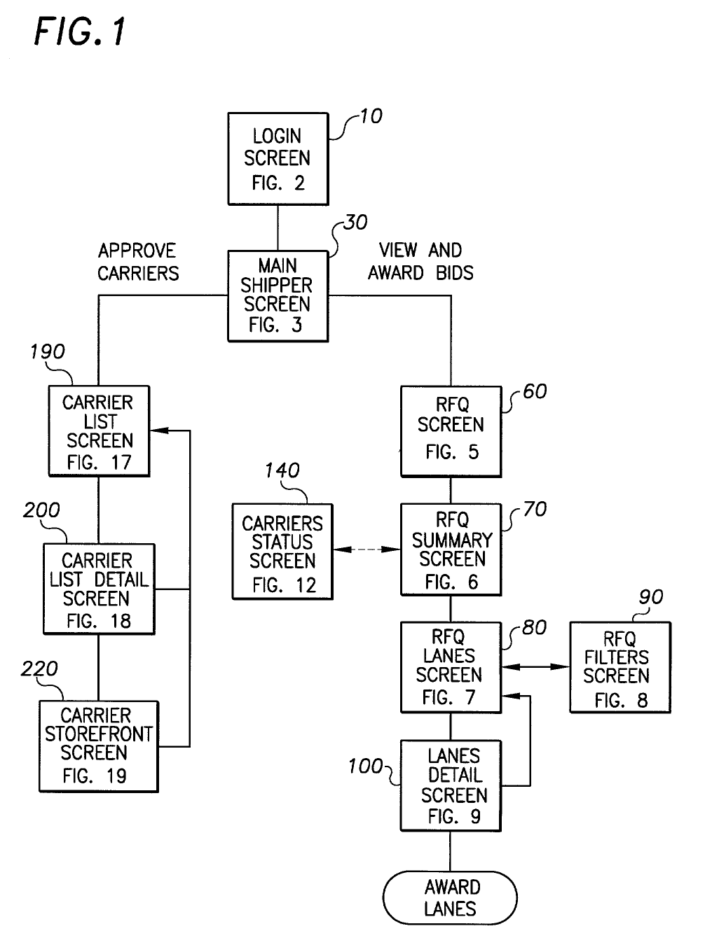

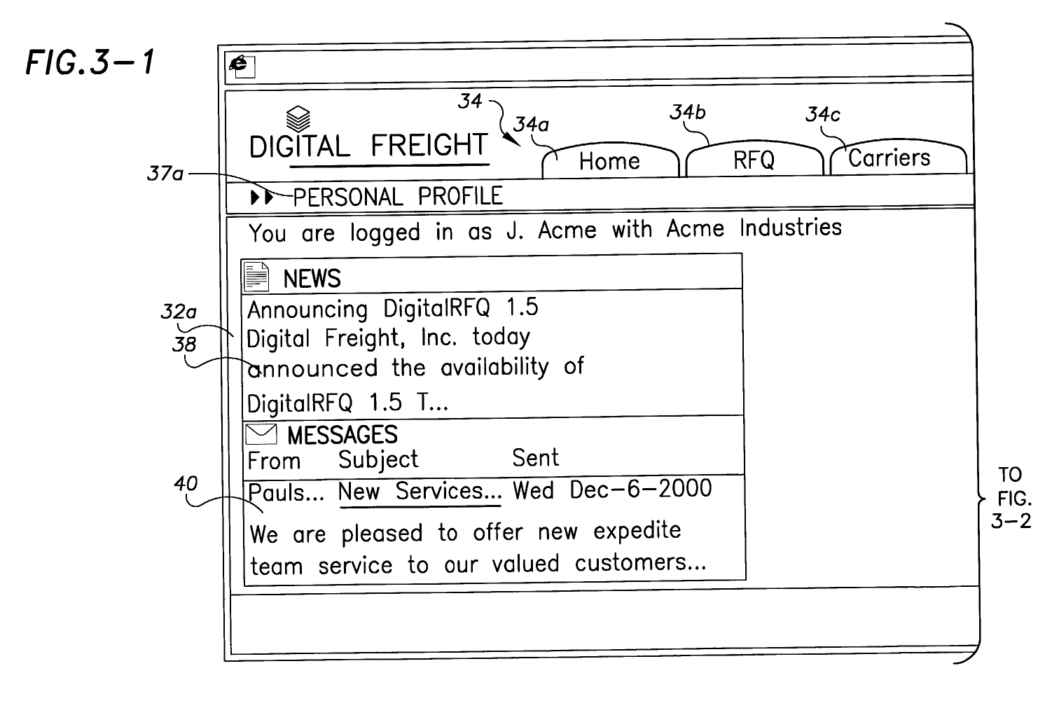

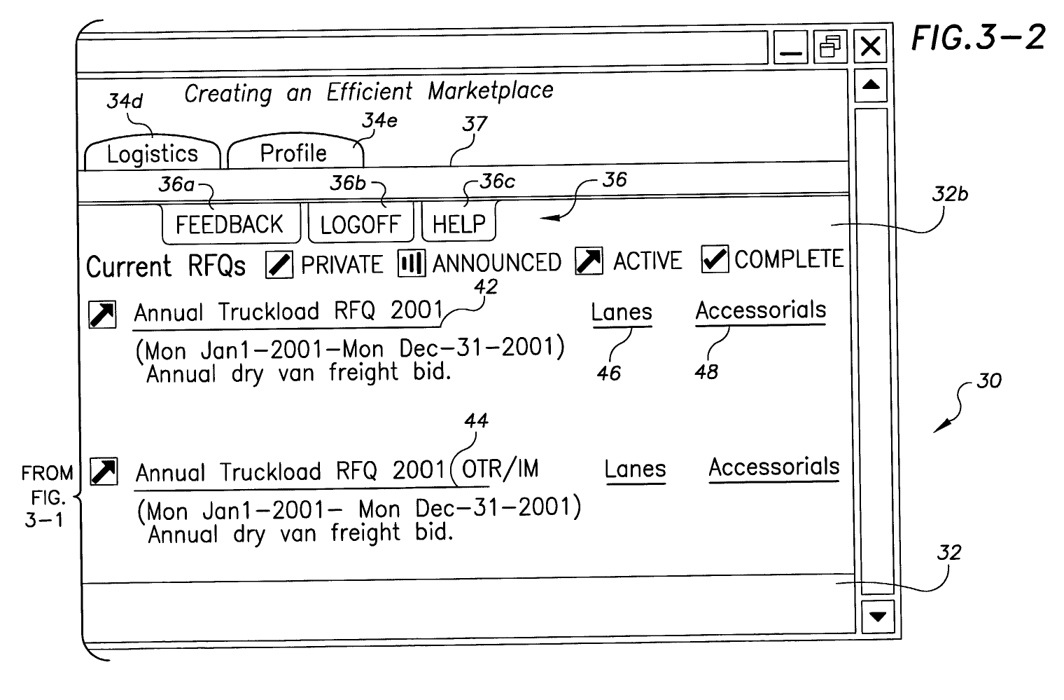

FIG. 1 is a flow chart depicting general operation of and movement through the preferred embodiment from the perspective of a shipper. As shown in FIG. 1, assuming a verification of a valid username and password, a registered shipper entering the system is directed from the LOGIN SCREEN 10 to a MAIN SHIPPER SCREEN 30, an example of which is depicted in FIG. 3. Of course, it is contemplated and preferred that the MAIN SHIPPER SCREEN 30, along with all web pages accessible only by registered users, be stored on a secure server.

The MAIN SHIPPER SCREEN 30 is comprised primarily of a central display window 32 having a left pane 32a and a right pane 32b. Such a central display window 32 is a common feature of all the “shipper” screens in this preferred embodiment. Various text messages, images, and/or hyperlinks can be displayed in these panes 32a, 32b. Along the top of this central display window 32 are a series of tabs 34 and a series of buttons 36. For purposes of this description, a “button” is an image that can be selected through the clicking of a computer mouse or use of a similar input device to re-direct a user to another Internet web page. A “tab” is an image that can similarly be selected through the clicking of a computer mouse or use of a similar input device to either re-direct a user to another Internet web page or to open a new document or image into the central display window 32.

In this preferred embodiment, there are five tabs arrayed along the top of the central display window 32: a HOME tab 34a, an RFQ tab 34b, a CARRIERS tab 34c, a LOGISTICS tab 34d, and a PROFILE tab 34e. It is important to note that, although these tabs 34 are not particularly pointed out with reference to all of the screens described in this specification, these five tabs do appear on each and every “shipper” screen in the preferred embodiment described herein. In this regard, a “shipper” screen is distinguished from a “carrier” screen, a distinction that will be clarified below. Furthermore, the function of each of these tabs 34 will be explained in more detail below.

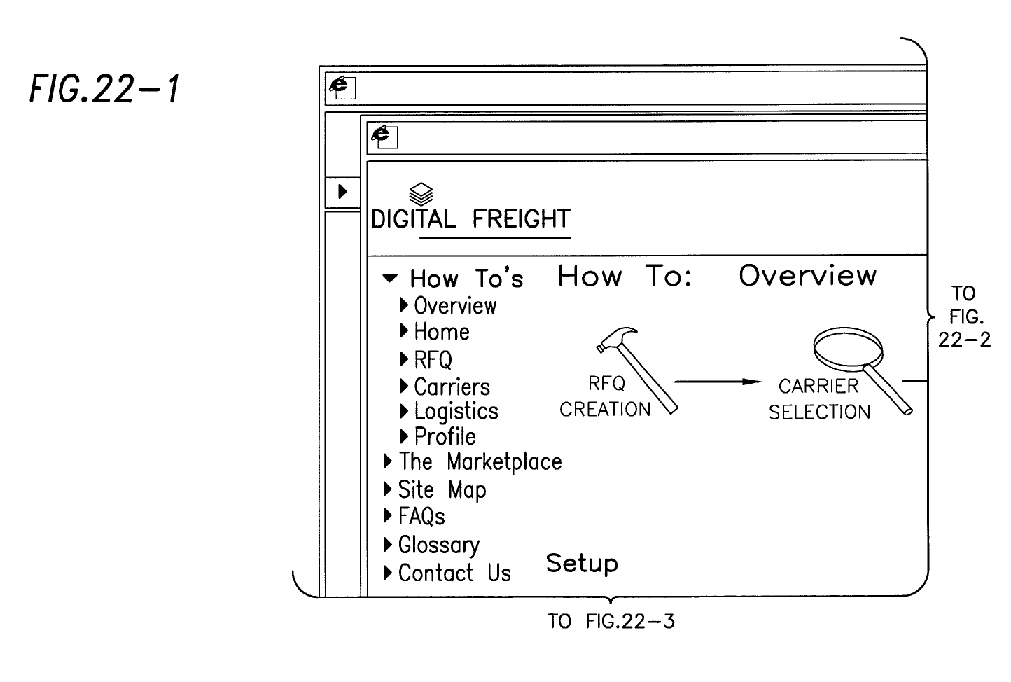

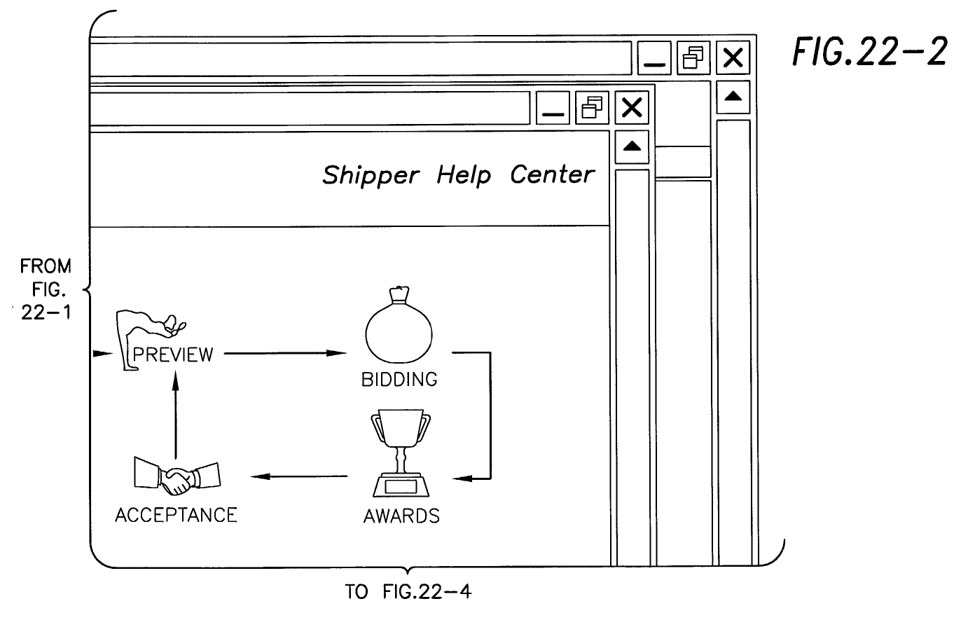

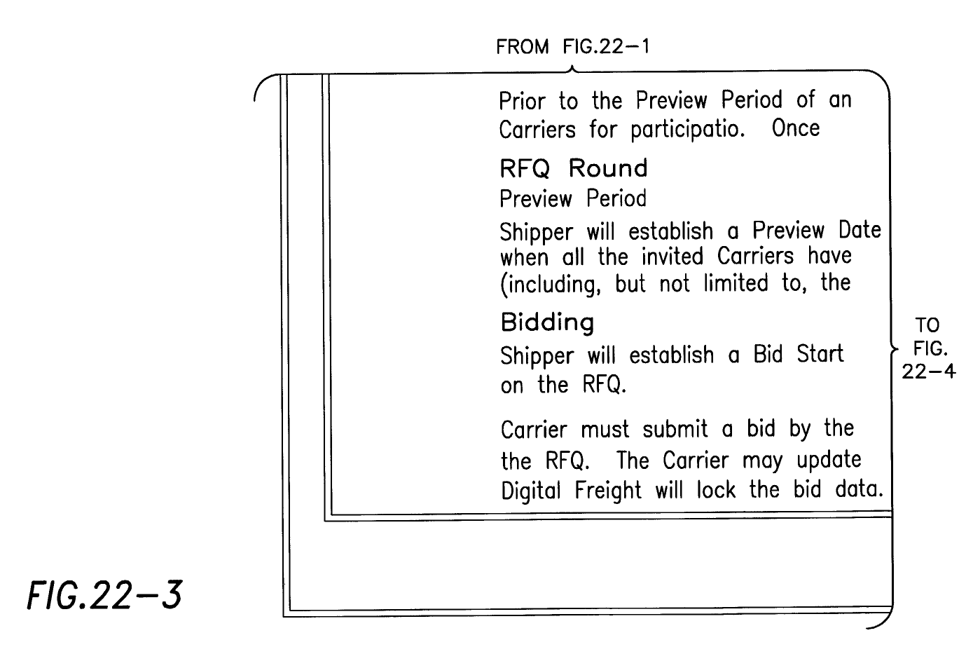

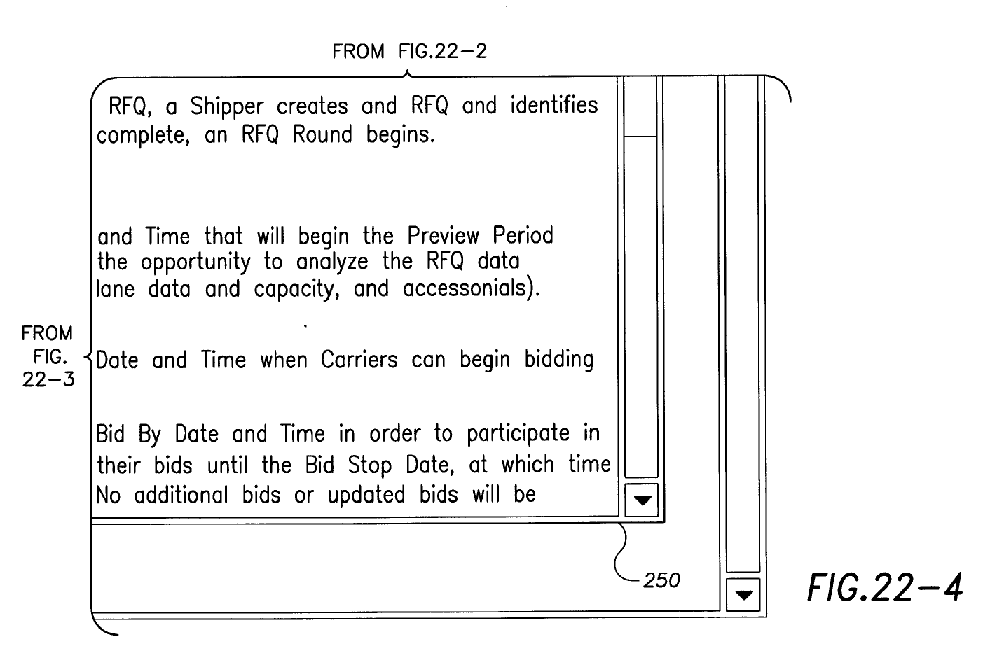

In this preferred embodiment, positioned just below the tabs 34 are a series of buttons 36: a FEEDBACK button 36a, a LOGOFF button 36b, and a HELP button 36c. Selection of the FEEDBACK button 36a re-directs the user to Internet-based mailing form (not shown) that can be used to send electronic mail concerning comments or concerns to system administrators. Selection of the LOGOFF button 36b effectively disconnects the user from the system, re-directing the user the LOGIN SCREEN 10, as depicted in FIG. 2, or another Internet web page. Finally, selection of the HELP button 36c causes a pop-up window 250 to be displayed in the Internet browser, an example of which is depicted in FIG. 22.

Similar to the tabs described above, it is important to note that, although these buttons 36 are not particularly pointed out with reference to all of the screens described in this specification, these three buttons 36 do appear on each and every “shipper” screen in this preferred embodiment. These buttons 36 each perform the identical function when selected regardless of which screen is being displayed at the time the button is selected.

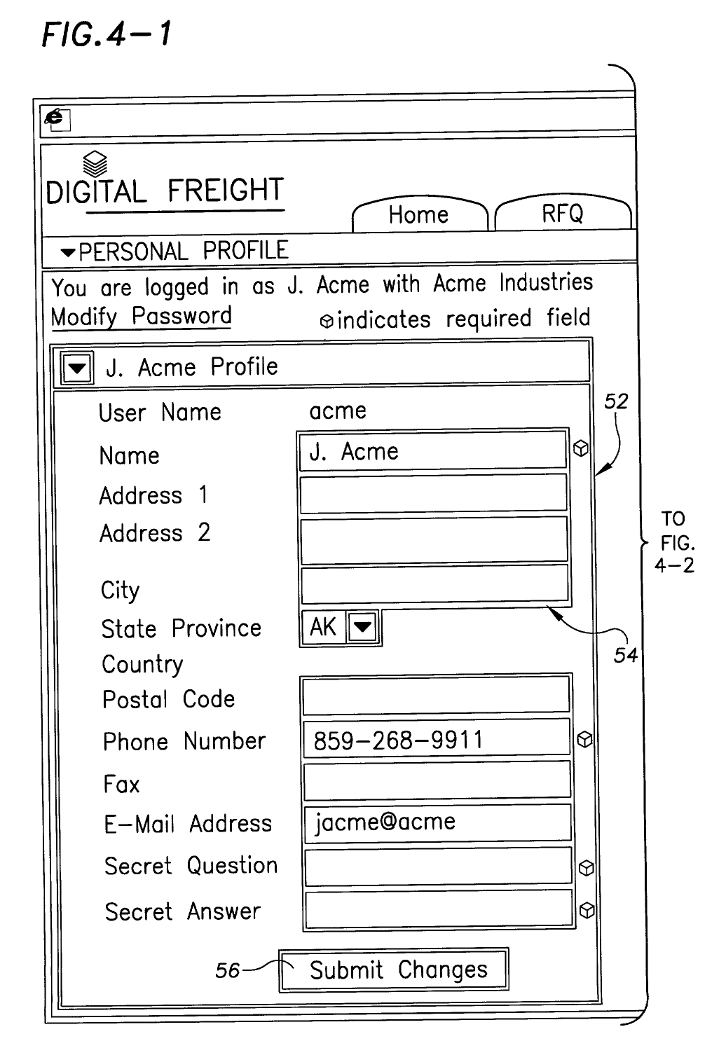

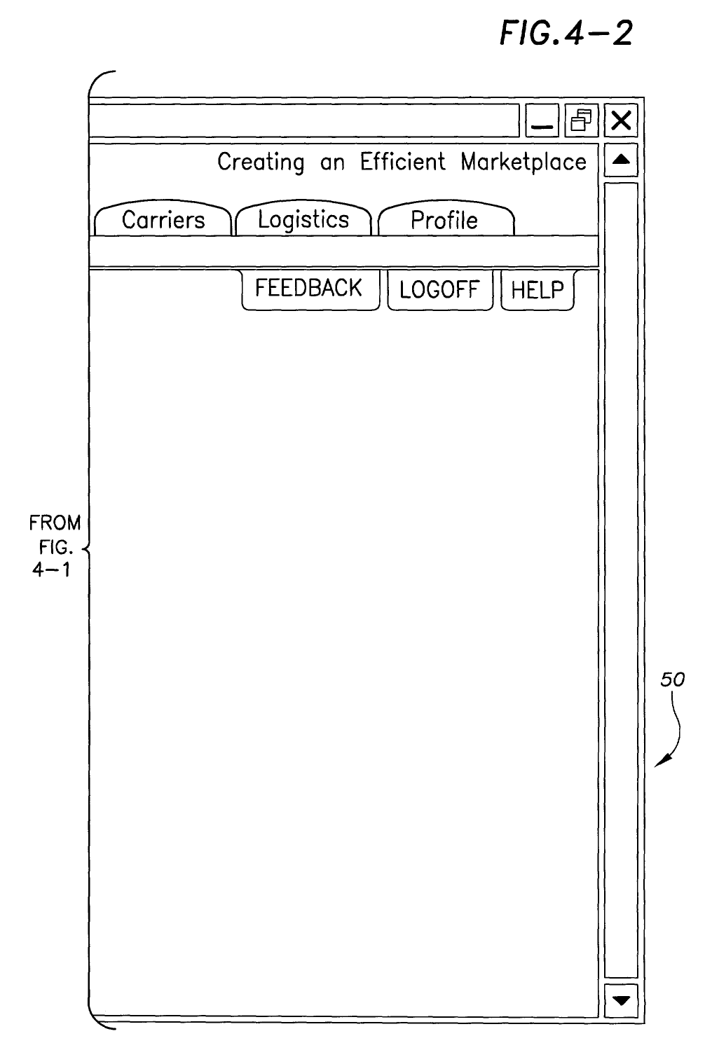

In this preferred embodiment, on the MAIN SHIPPER SCREEN 30 of FIG. 3, there is also a menu bar 37 positioned between the tabs 34 and buttons 36 described above which allows for yet another option. By selecting the PERSONAL PROFILE hyperlink 37a on the menu bar 37, the shipper is re-directed to the PERSONAL PROFILE SCREEN 50, an example of which is depicted in FIG. 4 and described in further detail below.

Returning to the central display window 32 of the MAIN SHIPPER SCREEN 30, it is contemplated and preferred that the left pane 32a display (1) summaries of and/or hyperlinks 38 to news stories of interest to the registered shipper; and (2) summaries of and/or hyperlinks 40 to messages directed to the registered shipper. It is contemplated and preferred that the right pane 32b display pending requests for quotation (“RFQ”)—the aforementioned packets of information that define the shipper's requirements and sets forth all transportation routes or lanes for which the shipper needs coverage, such packets being previously submitted in electronic form and stored in the integral database in accordance with the method and system of the present invention. In the example of FIG. 3, two RFQs 42, 44 are displayed in the right pane 32b of the central display window 32 of the MAIN SHIPPER SCREEN 30.

Also, with respect to each RFQ displayed in the right pane 32b of the central display window 32, it is contemplated and preferred that an icon appear to the left of the RFQ description displaying whether the RFQ is (1) Private; (2) Announced; (3) Active, or (4) Complete.

It is important to note that, in this preferred embodiment, an RFQ is established and posted through system administrators. At the same time, selected carriers (e.g., carriers with whom the shipper has a continuing business relationship) can be pre-approved for participation with respect to the particular RFQ. However, it is contemplated and preferred that, in alternate embodiments, establishment of a new RFQ can be accomplished directly through the user interface without the necessity of administrative assistance.

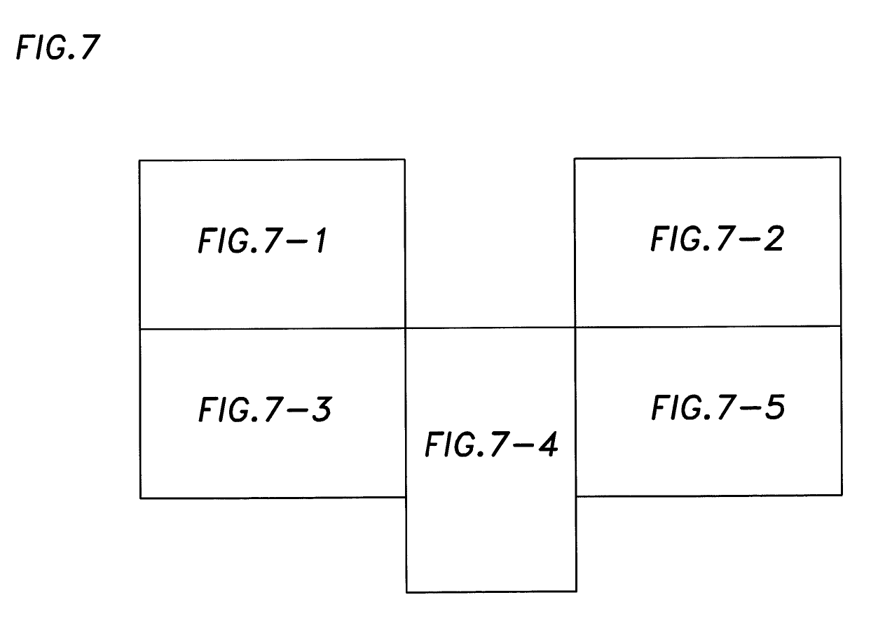

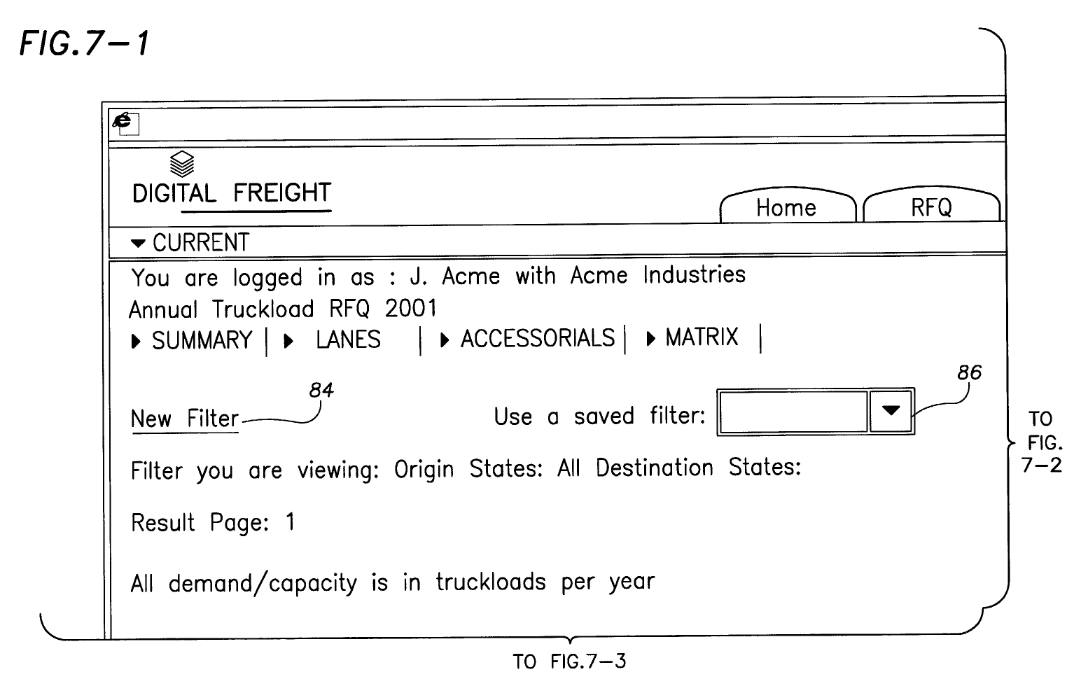

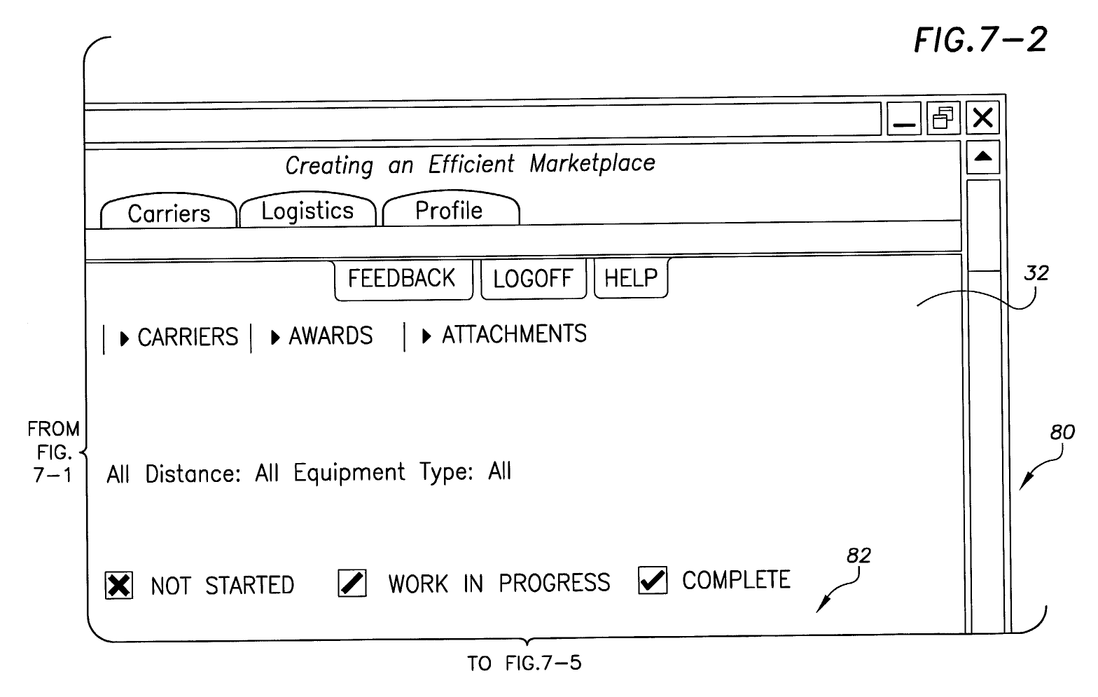

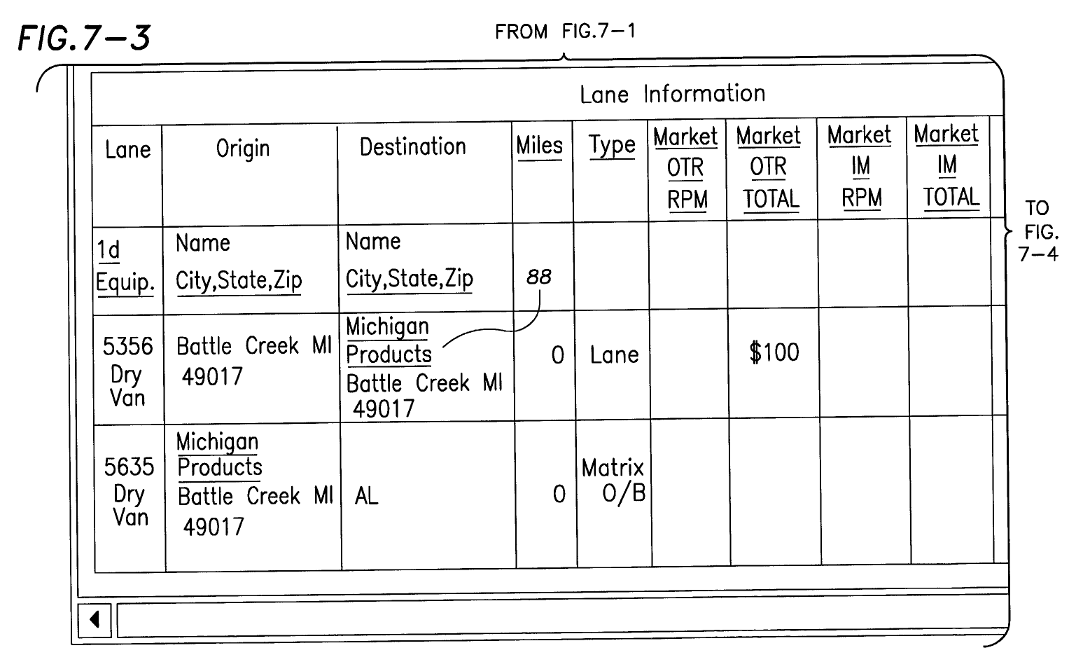

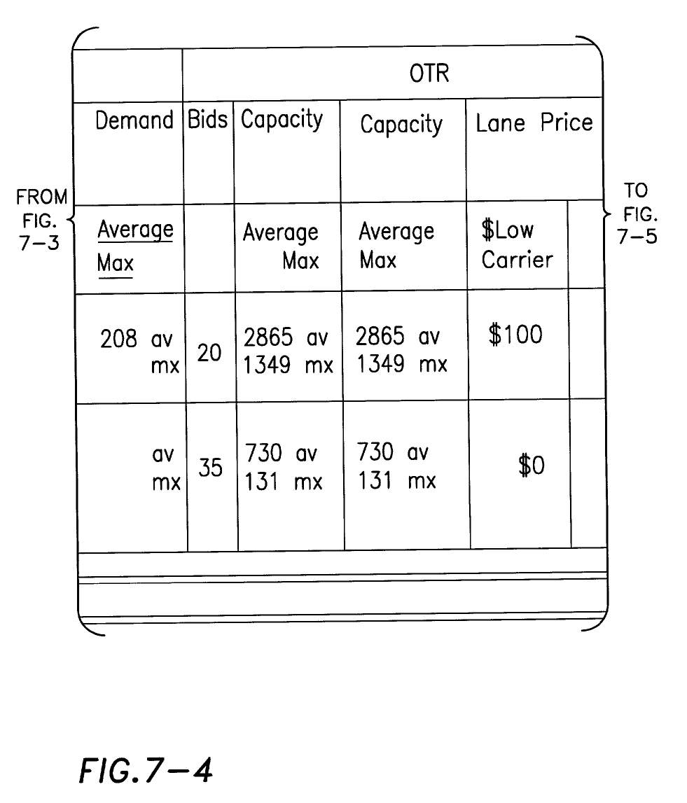

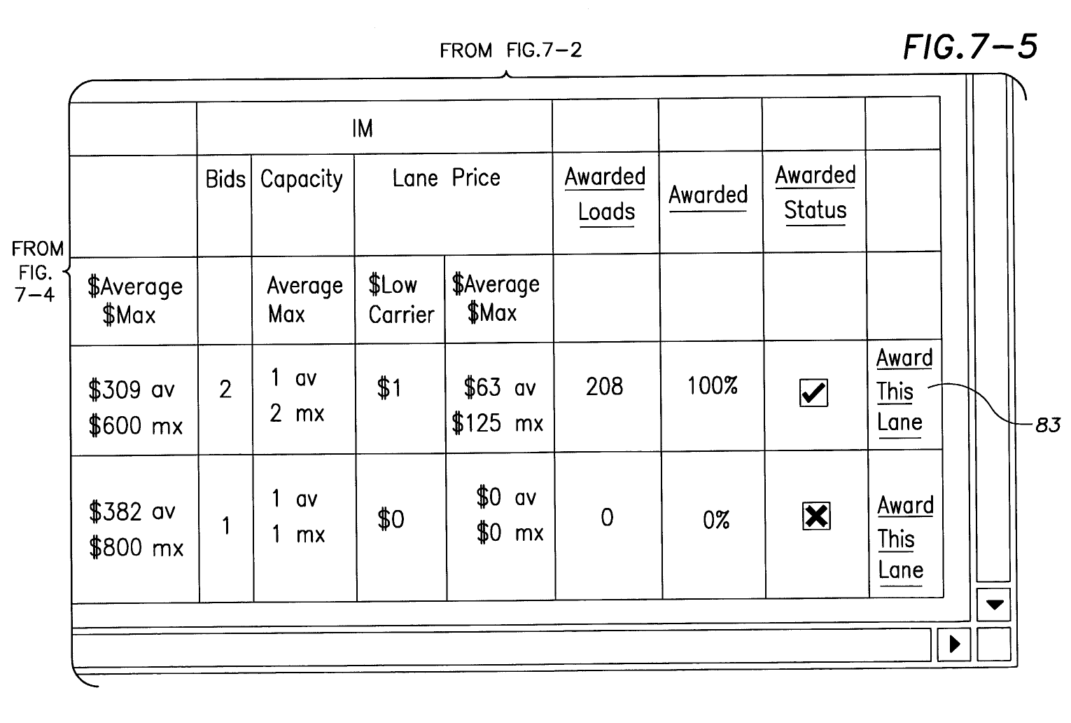

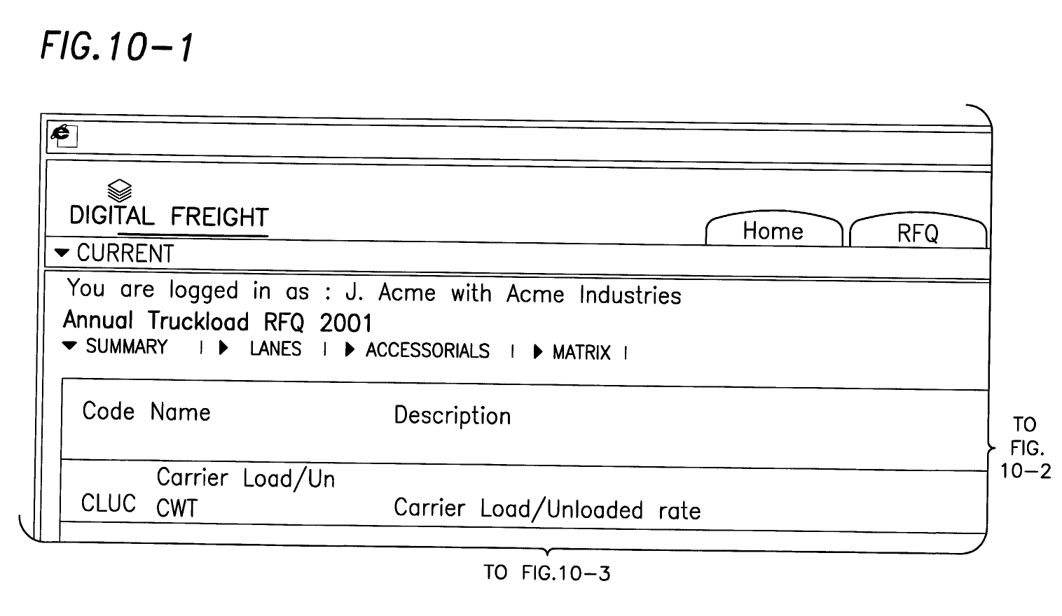

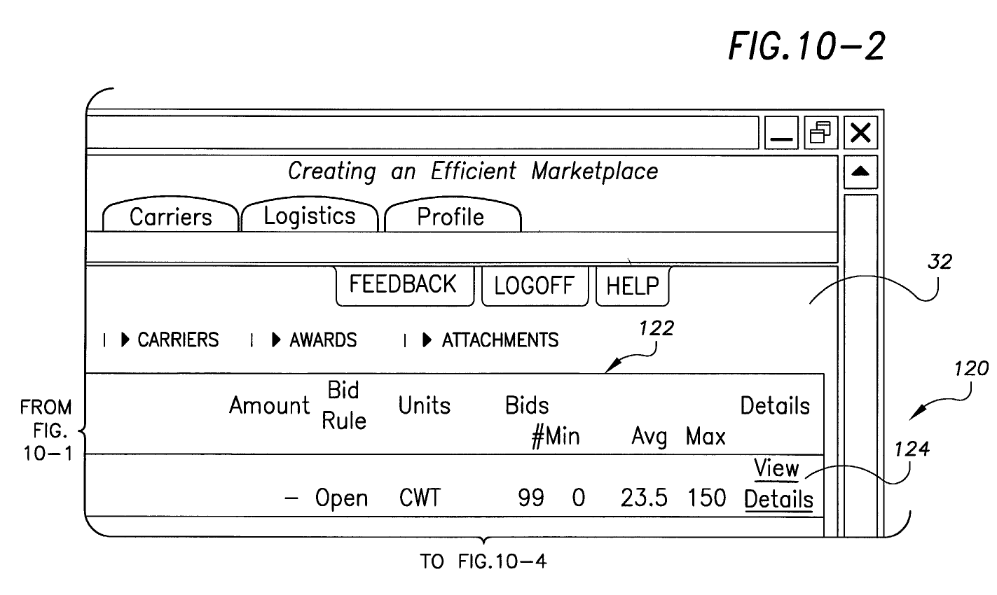

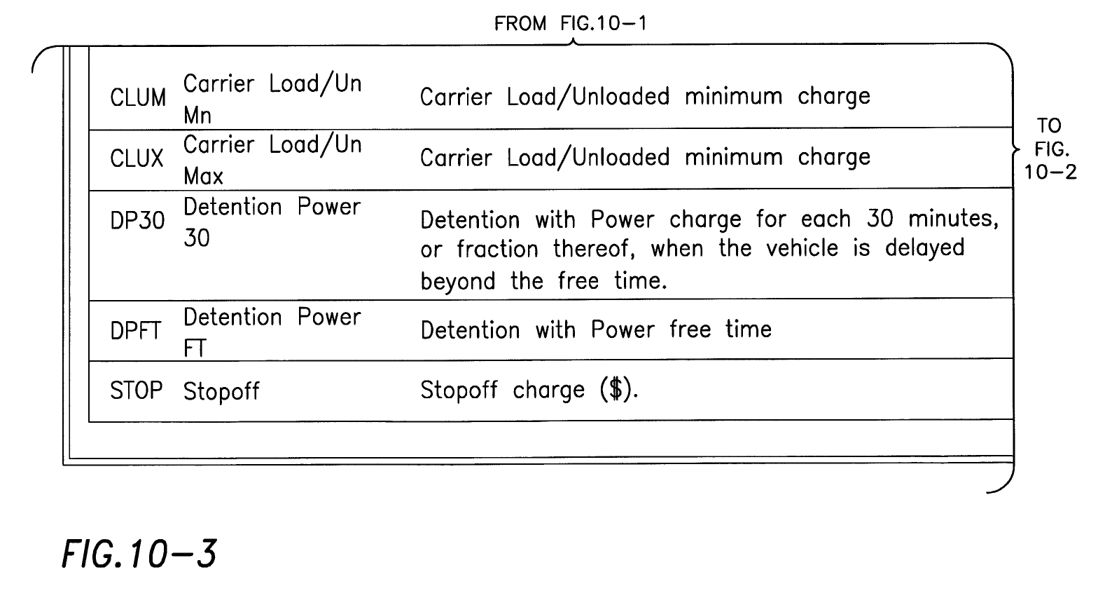

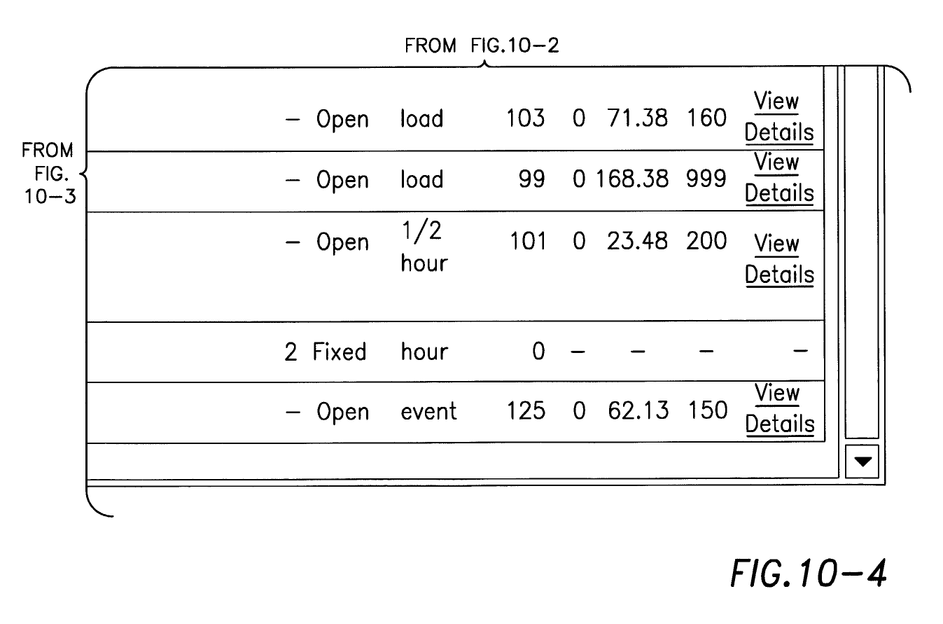

Returning to the MAIN SHIPPER SCREEN 30, associated with each of the RFQs that are displayed in the right pane 32b of the central display window 32, there is a pair of hyperlinks labeled “Lanes” (generally indicated by reference numeral 46) and “Accessorials” (generally indicated by reference numeral 48). Selection of the “Lanes” hyperlink 46 re-directs the shipper to a RFQ LANES SCREEN 80 associated with the RFQ, an example of which is depicted in FIG. 7 and described below. Selection of the “Accessorials” hyperlink 48 re-directs the shipper to an RFQ ACCESSORIALS SCREEN 120 associated with the RFQ, an example of which is depicted in FIG. 10 and described below.

FIG. 4 depicts the PERSONAL PROFILE SCREEN 50 in this preferred embodiment. As described above, by selecting the PERSONAL PROFILE hyperlink 37a of the menu bar 37 of the MAIN SHIPPER SCREEN 30, the shipper is re-directed to this screen. The PERSONAL PROFILE SCREEN 50 includes a data entry window 52 with multiple data entry fields, indicated generally by reference numeral 54, that allow the logged-in shipper to revise its personal profile data. In this particular embodiment, the following information may be revised:

TABLE A

| Name | Address 1 | Address 2 | City | State/Province | Postal Code |
|---|---|---|---|---|---|
| Phone Number | Fax | E-Mail Address | Secret Question | Secret Answer | |

It is contemplated and preferred that this information be entered through a conventional computer keyboard or similar peripheral device. Although not depicted in the flow chart of FIG. 1, once the shipper has entered all of the requisite data, selection of the SUBMIT CHANGES button 56 causes this information to be stored in the integral database, and the system returns the shipper to the MAIN SHIPPER SCREEN 30, as depicted in FIG. 3.

Returning to the flow chart of FIG. 1, aside from administrative features, such the modification of the personal profile as described above, a shipper primarily has two courses of action through the preferred system. The shipper can (1) view and award lanes for a particular RFQ, or (2) approve carriers for participation with respect to a particular RFQ.

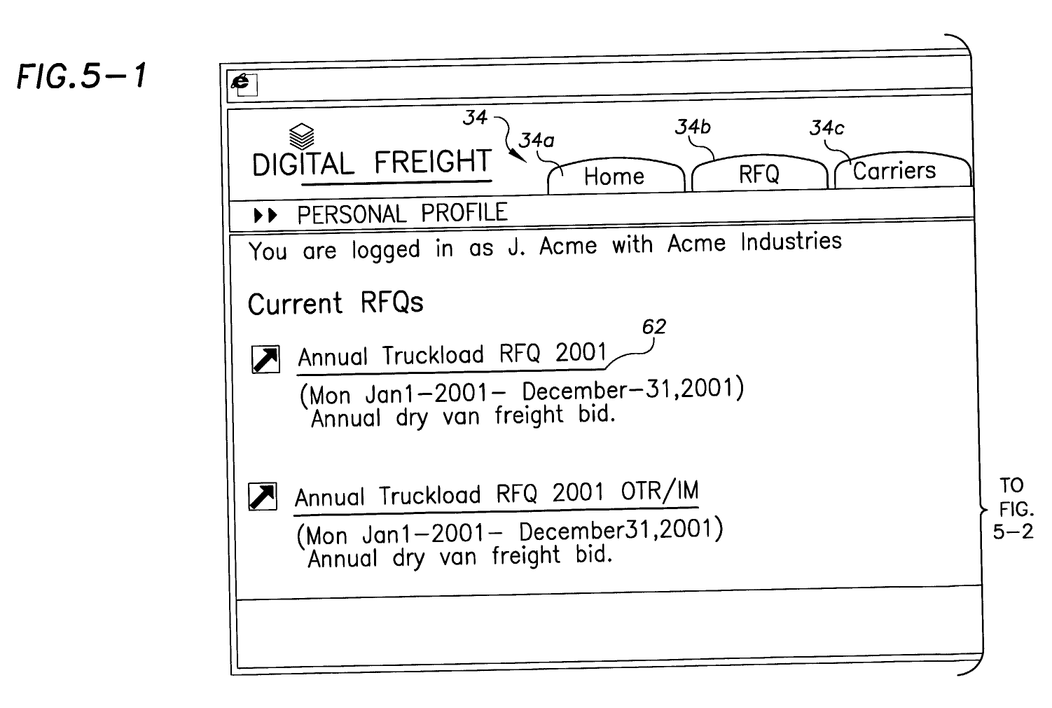

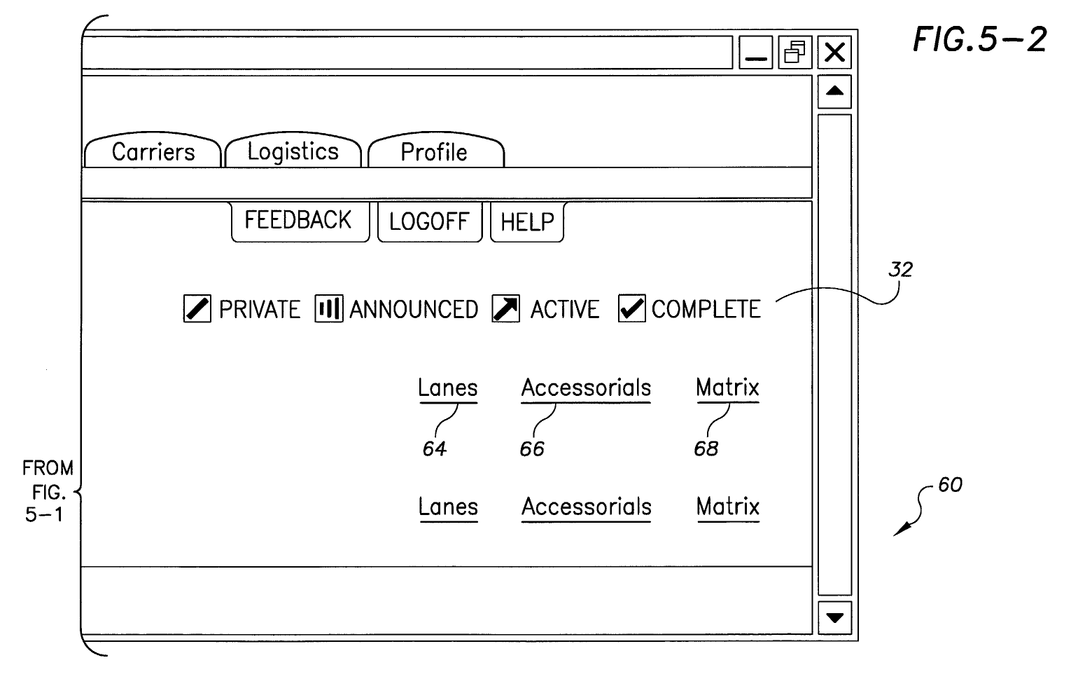

Considering first the viewing and acceptance of bids, FIG. 5 depicts a preferred RFQ SCREEN 60 in accordance with the method and system of the present invention, a screen that is accessed through the selection of the RFQ tab 34b of a shipper screen. Displayed in the central display window 32 of the RFQ SCREEN 60 is a listing of the current (and/or previous) RFQs for which bids are being sought and submitted (or were previously sought and submitted). With respect to each RFQ, the shipper has a variety of options.

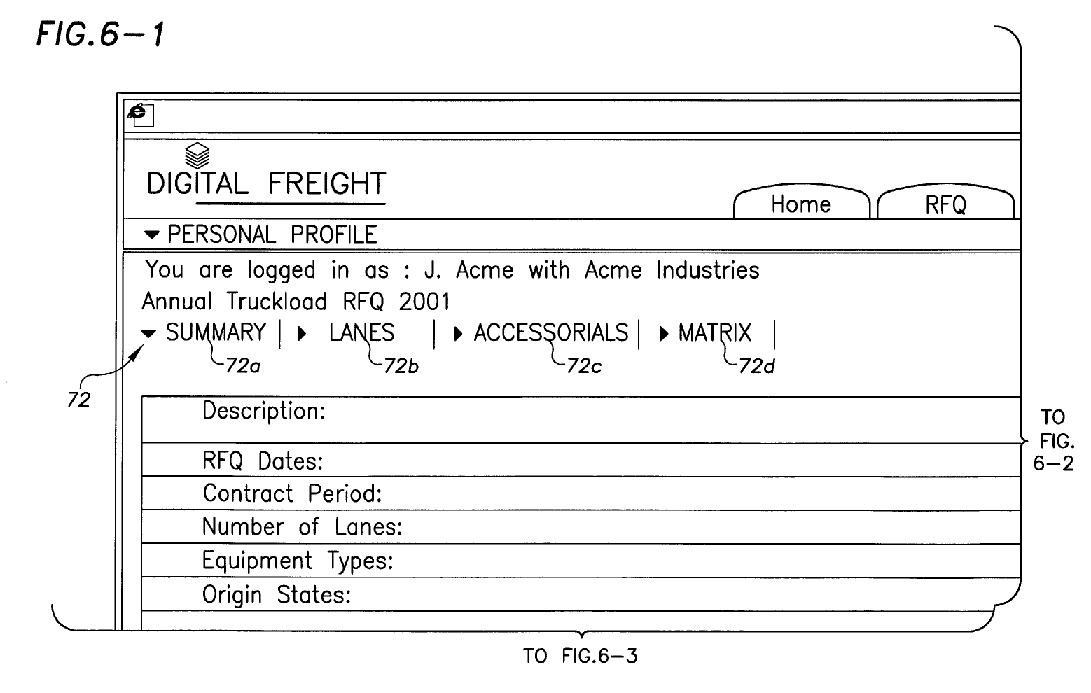

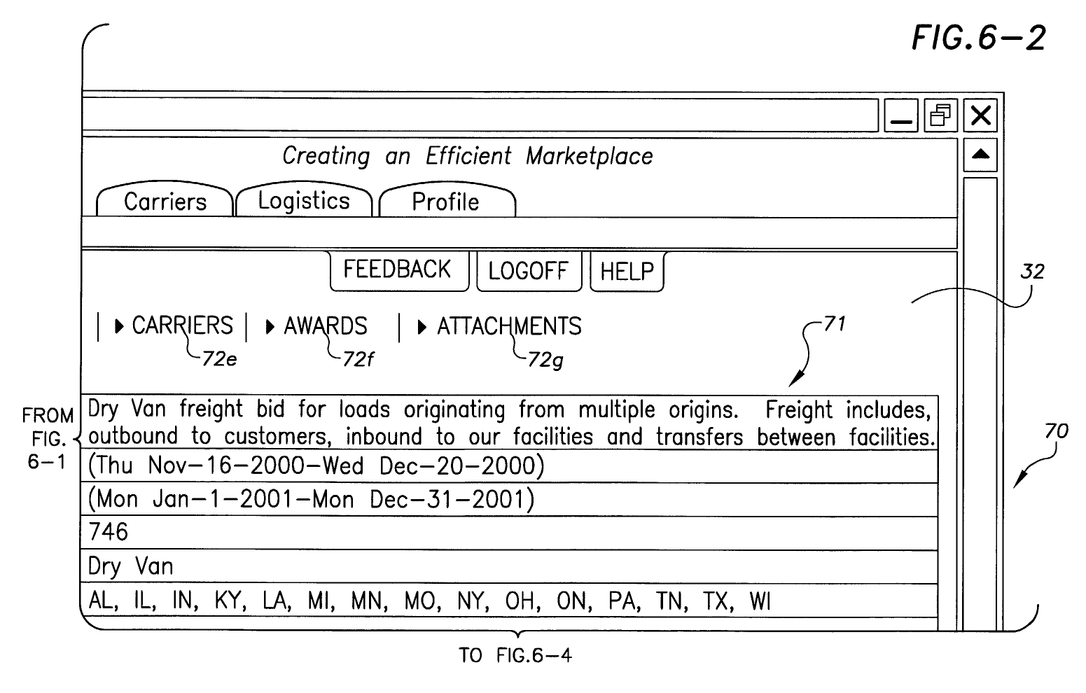

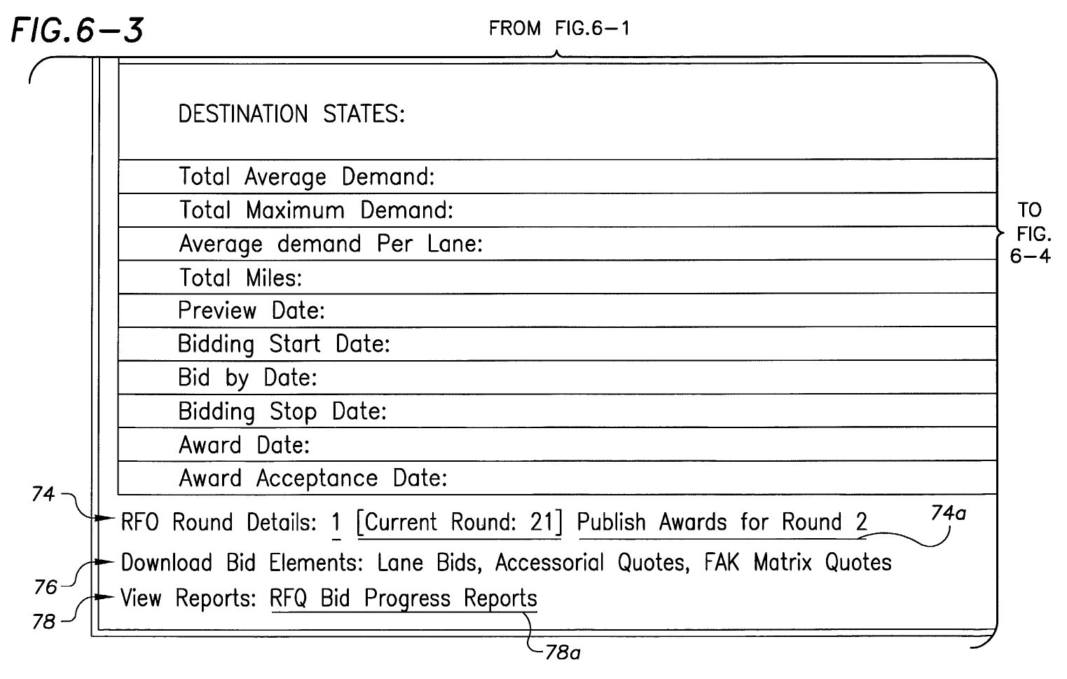

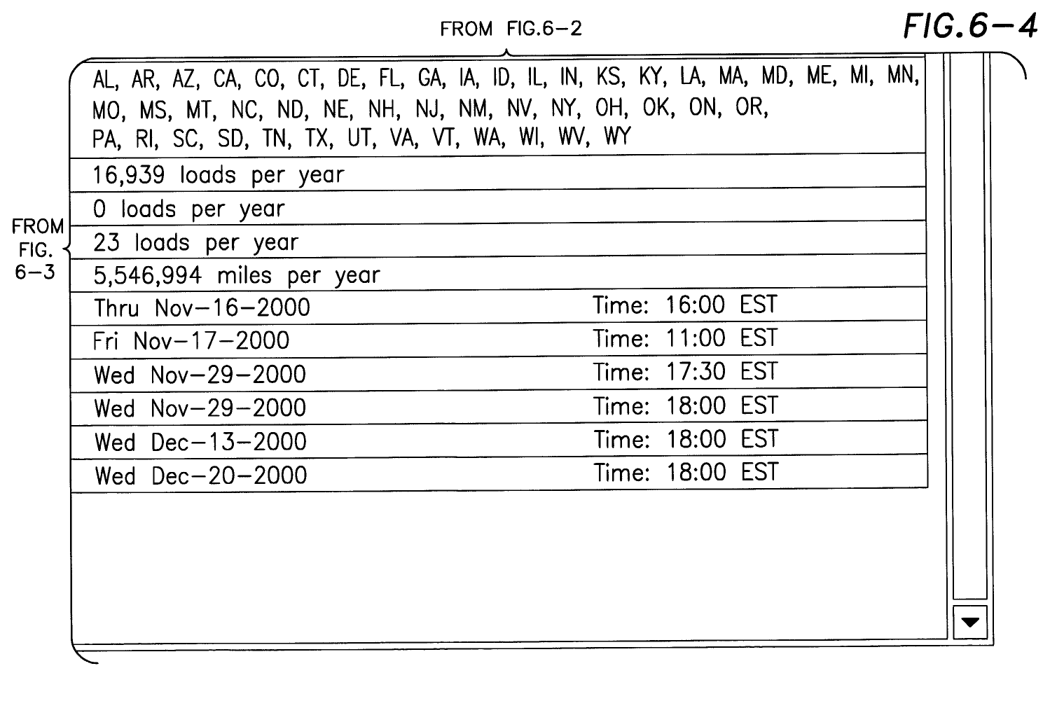

For example, by selecting the “Annual Truckload RFQ 2001” hyperlink 42 in the central display window 32 of the RFQ SCREEN 60, the shipper is re-directed to a RFQ SUMMARY SCREEN 70, an example of which is depicted in FIG. 6.

Alternatively, the shipper can effectively bypass the RFQ SUMMARY SCREEN 70 and move directly to detailed information associated with a particular RFQ. In this regard, associated with each of the RFQs that are displayed in the right pane 32b of the central display window 32 of the RFQ SCREEN of FIG. 5 are three hyperlinks labeled (1) “Lanes” (generally indicated by reference numeral 64); (2) “Accessorials” (generally indicated by reference numeral 66); and (3) “Matrix” (generally indicated by reference numeral 68).

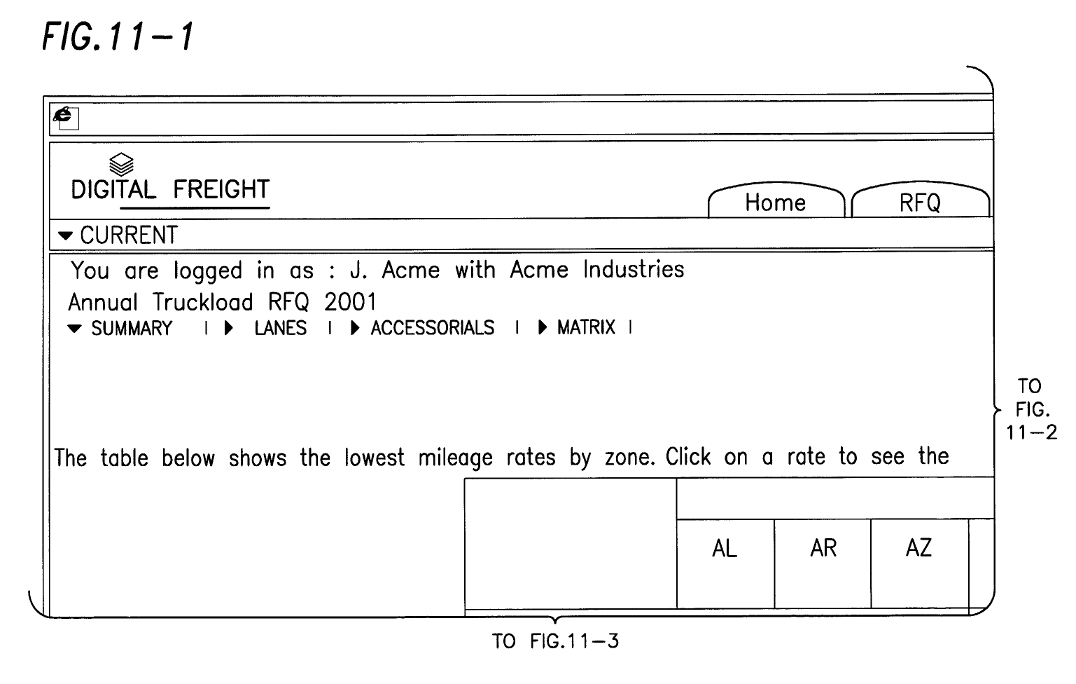

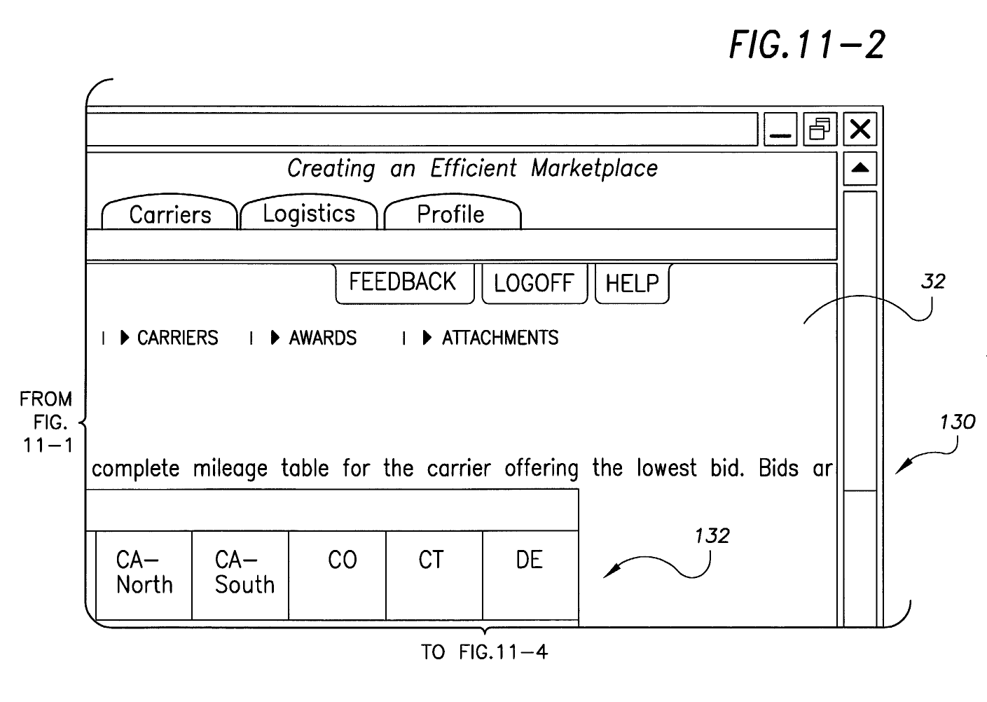

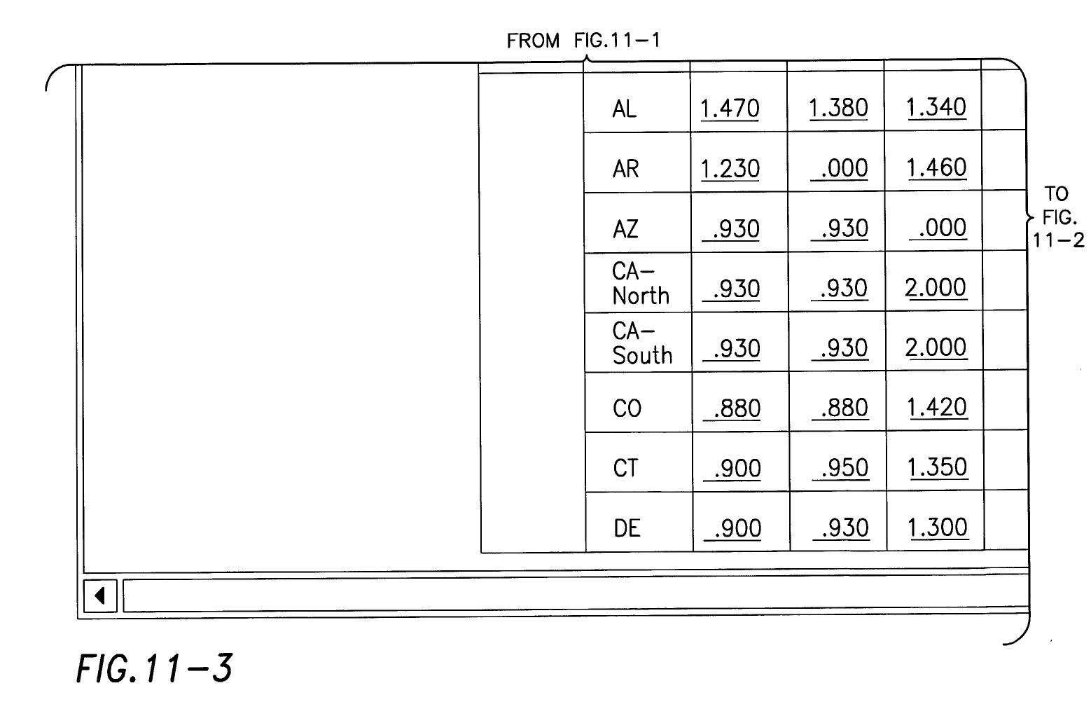

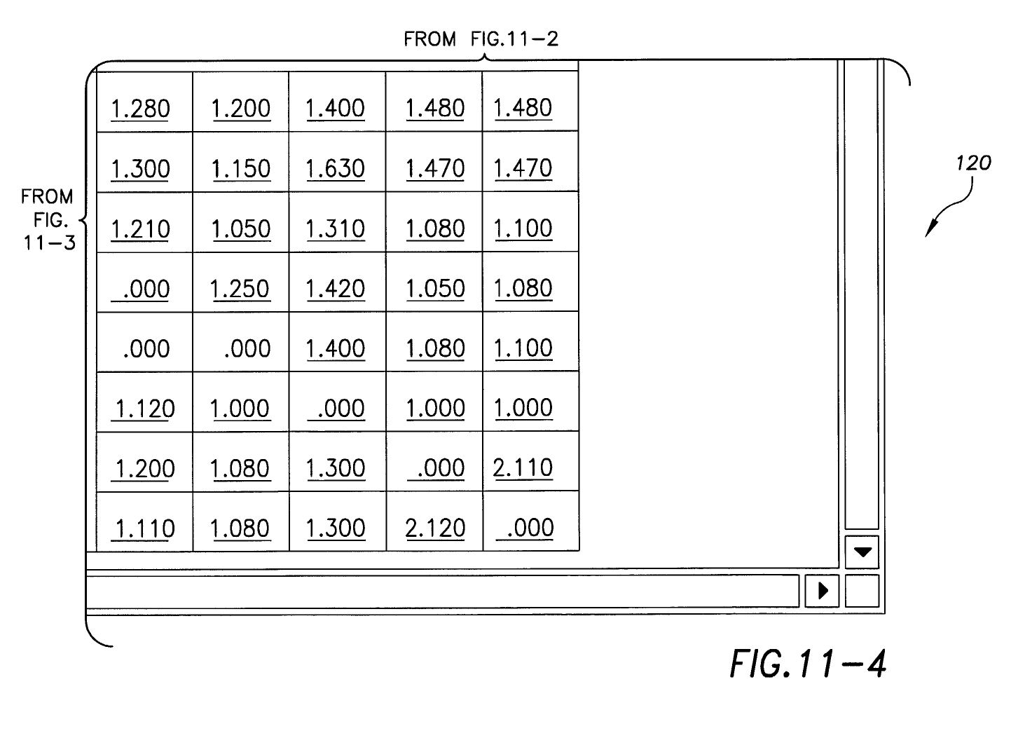

Selection of the “Lanes” hyperlink 64 re-directs the shipper to a RFQ LANES SCREEN 80 associated with the RFQ, an example of which is depicted in FIG. 7 and described below. Selection of the “Accessorials” hyperlink 66 re-directs the shipper to an RFQ ACCESSORIALS SCREEN 120 associated with the RFQ, an example of which is depicted in FIG. 10 and described below. Lastly, selection of the “Matrix” hyperlink 68 re-directs the shipper to a RFQ MATRIX SCREEN 130 associated with the RFQ, an example of which is depicted in FIG. 11 and described below.

Referring now to the aforementioned RFQ SUMMARY SCREEN 70 of FIG. 6, displayed in the central display window 32 is a table 71 providing a detailed summary of the selected RFQ. In the particular embodiment shown in FIG. 6, the following information is displayed in the table 71:

TABLE B

Description
RFQ Dates
Contract Period
Number of Lanes
Equipment Types
Origin States
Destination States
Total Average Demand
Total Maximum Demand
Average Demand Per Lane
Total Miles
Preview Date
Preview Time
Bidding Start Date
Bidding Start Time
Bid by Date
Bid by Time
Bidding Stop Date
Bidding Stop Time
Award Date
Award Time
Award Acceptance Date
Award Acceptance Time

The above terminology and import of the associated data is intuitively obvious and should be well known to one of ordinary skill in the art in the shipping and transportation industry, and thus, no further description is merited here. Moreover, the displayed data is but a preferred selection and layout of data which could be modified, added to, or rearranged without departing from the spirit and scope of the present invention.

Referring still to the RFQ SUMMARY SCREEN 70 of FIG. 6, the shipper can select various options to view details related to the selected “Annual Truckload RFQ 2001.” In this regard, as depicted in FIG. 6, it is preferred that there be a series of hyperlink selections 72 in the upper portion of the central display window 32, this series of hyperlinks 72 appearing in the central display window 32 of each screen related to a particular RFQ. Each of these hyperlinks is described in detail below.

Lastly, with respect to the RFQ SUMMARY SCREEN 70 of FIG. 6, there are various hyperlinks located in the lower portion of the central display window 32 below the table 71. The first grouping of hyperlinks (generally indicated by reference numeral 74) is labeled “RFQ Round Details.” Selection of an appropriate hyperlink re-directs the shipper to the summary information associated with another round of bidding. In this regard, it is a common practice in the shipping and transportation industry to conduct bidding in multiple rounds. Of these hyperlinks, perhaps the most important one is the “Publish Awards” hyperlink 74a. Until the shipper selects or clicks on this hyperlink 74a, carriers participating in the RFQ will be unable to review or accept their awards. Therefore, after a shipper has made its awards, as is described in more detail below, selection of the “Publish Awards” hyperlink 74a releases the award information to participating carriers receiving awards.

The second grouping of hyperlinks (generally indicated by reference numeral 76) is labeled “Download Bid Elements” and includes such hyperlinks as “Lane Bids,” “Accessorial Quotes,” and “FAK Matrix Quotes.” In this regard, it is contemplated and preferred that the various lane, accessorial, and matrix data could be downloaded for further review and analysis through commercial spreadsheet software, such as Microsoft Excel®. Although not shown, it is also contemplated and preferred that carriers could create bid packages using commercial spreadsheet software and then upload this data to the integral database through the web site interface.

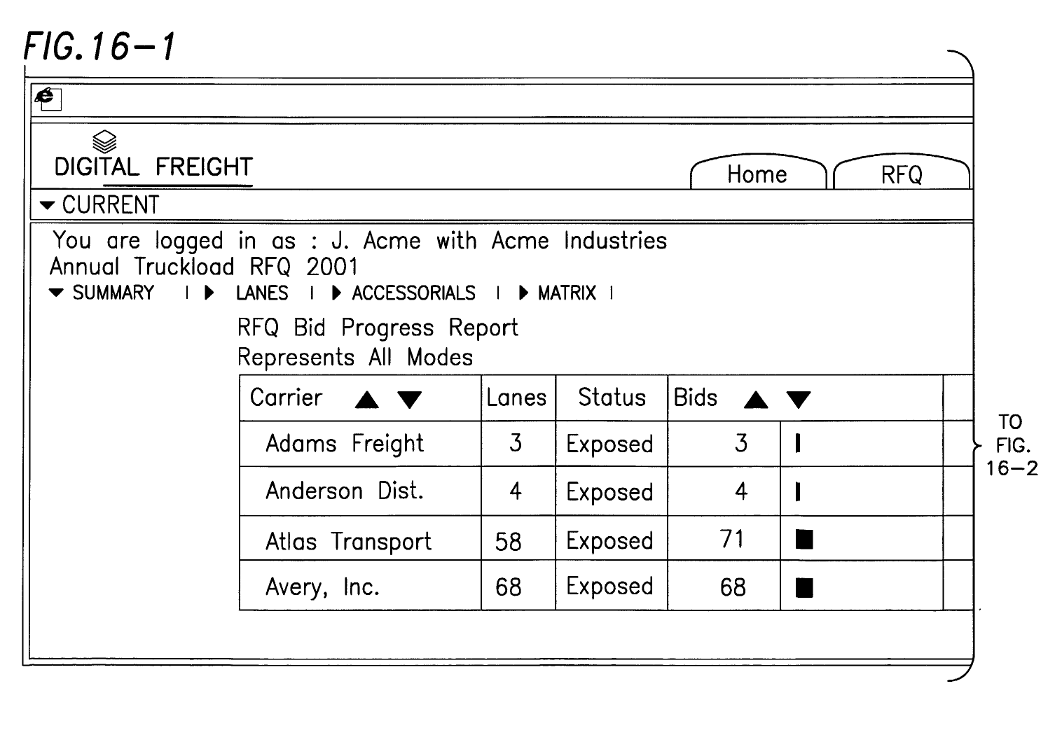

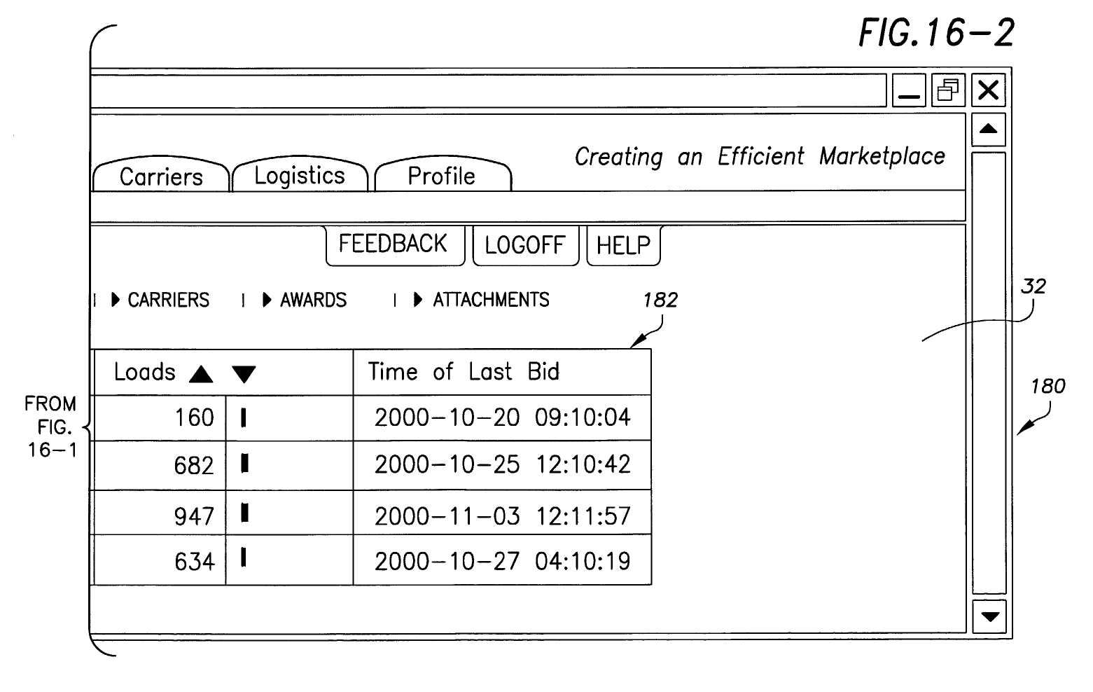

Finally, the third grouping of hyperlinks (generally indicated by reference numeral 78) is labeled “View Reports,” and, in this example, there is a single hyperlink labeled “RFQ Bid Progress Reports” 78a. An example of such a “RFQ Bid Progress Report” is depicted in FIG. 16 and will be described below.

Returning to the series of hyperlink selections 72 in the upper portion of the central display window 32 of the RFQ SUMMARY SCREEN 70, by selecting the “Lanes” hyperlink 72b, the user is re-directed to the RFQ LANES SCREEN 80, an example of which is depicted in FIG. 7. In the central display window 32 of the RFQ LANES SCREEN 80 is a table 82 of detailed information about each lane included in the RFQ.

In this description of a preferred embodiment of the method and system of the present invention, the focus is on ground transportation. However, the present invention is certainly not limited to ground transportation and could be implemented with respect to air transportation, maritime transportation, other modes of transportation, or any combinations thereof without departing from the spirit and scope of the present invention. In this regard, a “lane” is simply a route between an origin and destination.

Returning to the particular embodiment shown in FIG. 7, for purposes of simplicity and clarity, there are only two lanes displayed for the RFQ, and the following information is displayed with respect to each lane:

TABLE C
Lane Information

| | | | | |
|---|---|---|---|---|
| Lane | Origin | Destination | Miles | Type |
| Id; Equip | City, State, Zip | City, State, Zip | | |

Lane Information

| | | | | |
|---|---|---|---|---|
| Market OTR RPM | Market OTR TOTAL | Market IM RPM | Market IM TOTAL | Demand |
| | | | | Average; Max |

OTR

| | | | |
|---|---|---|---|
| Bids | Capacity | Lane Price | |
| | Average; Max | $Low Carrier | $Average; $Max |

IM

| | | | |
|---|---|---|---|
| Bids | Capacity | Lane Price | |
| | Average; Max | $Low Carrier | $Average; $Max |

| | | |
|---|---|---|
| Awarded Loads | Awarded | Award Status |

The first five data columns categorized under the “Lane Information” umbrella are largely self-explanatory, i.e. Lane, Origin, Destination, Miles, and Type. Such terminology is well-known to one of ordinary skill in the art. The next data columns under the “Lane Information” umbrella are custom, shipper-defined data columns that, in this preferred embodiment, display: (1) “Market OTR RPM,” the market rate-per-mile (RPM) for over-the-road (OTR) transportation, a benchmark rate that may influence carrier bidding; (2) “Market OTR TOTAL,” the total charge of the load which is generally the RPM multiplied by the number of miles unless substituted with a minimum charge; (3) “Market IM RPM,” the market rate-per-mile (RPM) for intermodal (IM) or “equipment on trains” transportation, another benchmark rate that may influence carrier bidding; and (4) “Market IM TOTAL,” the total charge of the load which is again generally the RPM for IM multiplied by the number of miles unless substituted with a minimum charge. Lastly, with respect to the data columns categorized under the “Lane Information” umbrella, the “Demand” column displays the shipper's forecast as to the “Average” and “Max” number of loads that is expected to be hauled on that particular lane for a given time period, in this example, one month—as is preferably specified and displayed in the central message window 32. Average demand can also be referred to as “nominal” demand. The maximum demand (or “surge demand”) is an estimate of the amount of loads that might be transported during peak or seasonal periods.

The next category of data columns relates to OTR transportation bids. Specifically, “Bids” refers to the number of bids that have been submitted by carriers with respect to a particular lane. The “Average Capacity” is the total of the average (or nominal) capacities of the carriers who have submitted bids for a particular lane. The “Max Capacity” is the total of the maximum (or surge) capacities of the carriers who have submitted bids for a particular lane. The “$Low Carrier Lane Price” is the lowest total charge among carriers bidding on a particular lane. Similarly, the “$Average Lane Price” is the average total charge among carriers bidding on a particular lane, and the “$Max Lane Price” is the maximum total charge among carriers bidding on a particular lane.

The next category of data columns relates to IM transportation bids. The same data is displayed with respect to IM transportation as is displayed with respect to OTR transportation, specifically: “Bids,” “Average Capacity,” “Max Capacity,” “$Low Carrier Lane Price,” “$Average Lane Price,” and “$Max Lane Price.”

Following the data columns related to IM transportation, with respect to the table 82 displayed in the central display window 32 of the RFQ LANES SCREEN 80, there are three data columns labeled “Awarded Loads,” Awarded,” and “Award Status.” The data in the “Awarded Loads” column indicates how many of the available loads in that particular lane have been awarded to bidding carriers. Similarly, in the “Awarded” column, the number of loads that have been awarded with respect to a the average capacity in a particular lane is represented in percentage form. Third, displayed in the “Award Status” data column is an icon that reflects whether bidding on a particular lane has (1) not started, (2) is in progress, or (3) is complete.

Lastly, at the rightmost end of the table 82 displayed in the central display window 32 of the RFQ LANES SCREEN 80 is a column containing an “Award This Lane” hyperlink 83, the function of which will be described below.

Again, for purposes of simplicity and clarity, only two lanes are displayed in the table 82 of the RFQ LANES SCREEN 80; however, it is contemplated that a virtually limitless number of lanes could be involved in any particular RFQ. Indeed, one of the primary advantages of the method and system of the present invention is that it allows for efficient management of RFQs comprising large numbers of lanes. Indeed, in the event that an RFQ is comprised of an extraordinarily large number of lanes, the lane data displayed in the RFQ LANES SCREEN 80 can be subdivided into viewable sets of lane data with repeating headers visible as the user scrolls through the data. Also, the data may be spread across multiple screens or web pages to facilitate navigation and viewing.

Moreover, the table 82 of the RFQ LANES SCREEN 80 is but one example of a preferred selection and layout of data columns. It is contemplated and preferred that the user can customize the selection and layout of the data columns to meets its individual needs and to facilitate review of the status of the RFQ. In this regard, one preferred option, as shown in FIG. 7, is to represent the labels for the data columns in hyperlink form such that selecting a hyperlink would result in a sorting of the data in the table 82 based on that particular data column. It is important to note that, although not particularly pointed out with reference to each of the tables associated with the preferred method and system of the present invention, almost any table can be provided with data labels represented in hyperlink form to facilitate sorting.

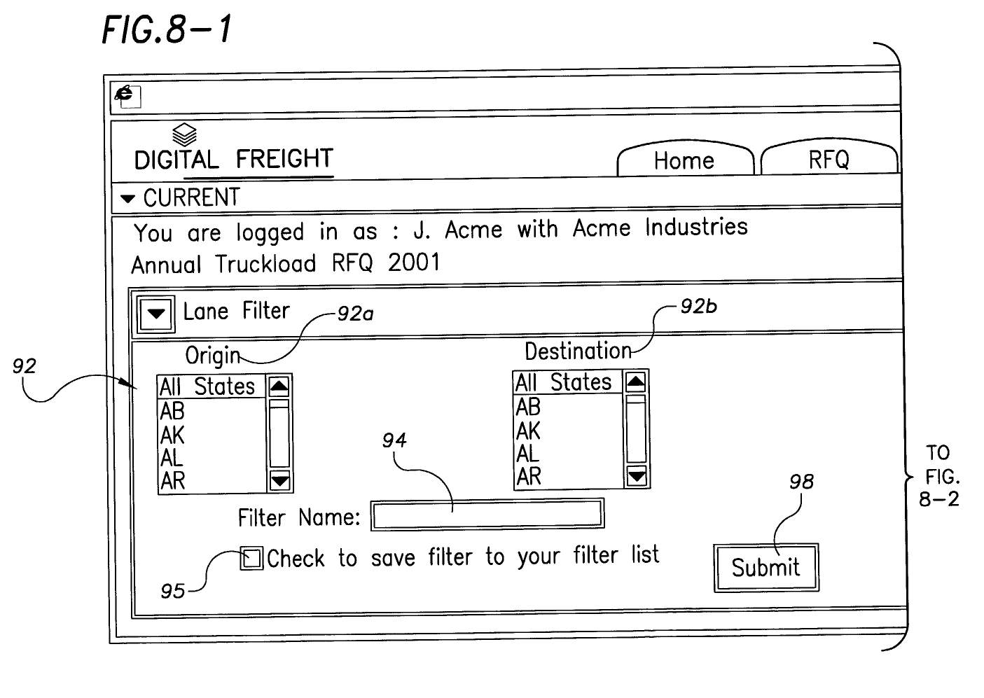

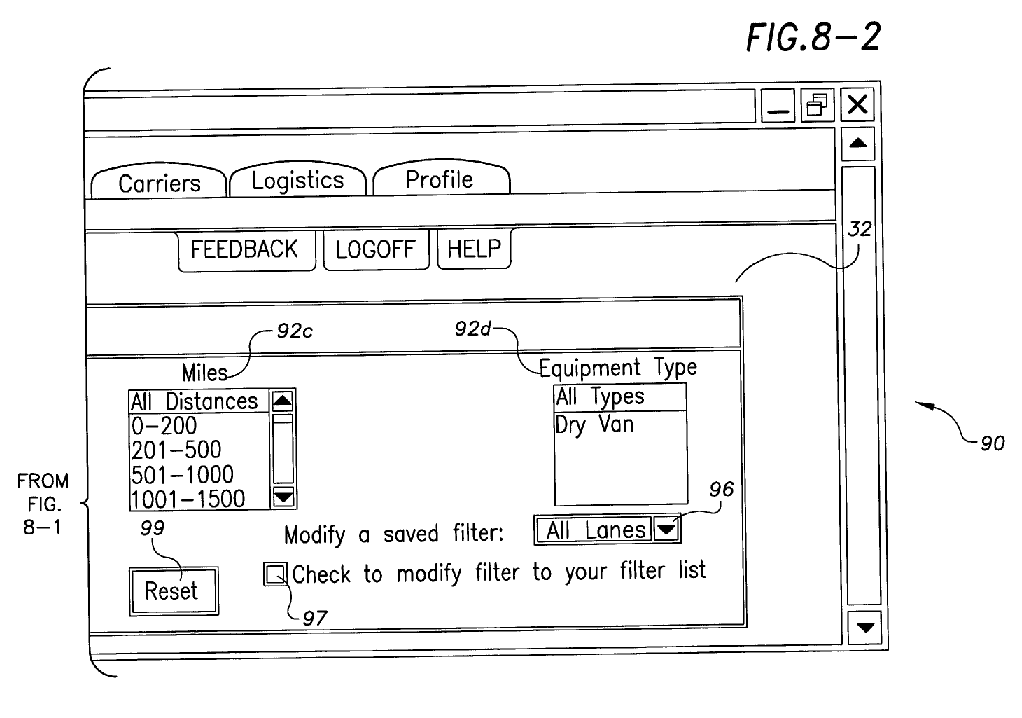

With respect to the RFQ LANES SCREEN 80 of FIG. 7, if there are a great number of lanes included in an RFQ displayed in the table 82, it would be useful to also provide a filtering mechanism to view particular lanes. In this regard, selection of the “New Filter” hyperlink 84 displayed in the central display window 32 of the RFQ LANES SCREEN 80 re-directs the shipper to a RFQ FILTERS SCREEN 90, an example of which is depicted in FIG. 8.

As shown in FIG. 8, displayed in the central display window 32 of the RFQ FILTERS SCREEN 90 is a series of pull-down menus 92. In this particular embodiment, there are four pull-down menus that allow a user to create a filter by selecting one or more of the following criteria: origin 92a, destination 92b, range of miles 92c, and equipment type 92d. After selecting an appropriate combination of data from the pull-down menus 92, the shipper can enter an appropriate filter name in the data entry filed labeled “Filter Name” 94. By selecting the “Check to save filter to your filter list” box 95, the shipper can also choose to have the filter saved to a custom list, as will be described in further detail below. Finally, the shipper selects the “Submit” button 98, and the lane filter information is stored in the integral database. The shipper is then re-directed to the RFQ LANES SCREEN 80 of FIG. 7, which will display refreshed lane data in accordance with the filtered parameters.

Rather than creating a new filter, the RFQ FILTERS SCREEN 90 of FIG. 8 also allows the shipper to modify a previously saved filter by first selecting it from the “Modify a save filter” pull-down menu 96. The appropriate changes can be made using the various pull-down menus 92 as described above. Then, by selecting the “Check to modify filter to your filter list” box 97, the shipper can also choose to have the filter re-saved to its custom list. Finally, the shipper selects the “Submit” button 98, and the lane filter information is stored in the integral database. The shipper is then re-directed to the RFQ LANES SCREEN 80 of FIG. 7.

For the convenience of the shipper, the FILTER SCREEN 80 also includes a “Reset” button 99 which allows a shipper to clear the selected filter data from the pull-down menus 92.

Returning now to the RFQ LANES SCREEN 80 of FIG. 7, included in the central display window 32 is a pull-down menu 86 that allows a user to select from its custom list of saved filters. Upon selection of the appropriate filter, the table 82 is refreshed and re-displayed in the central display window 32 in accordance with the filter parameters.

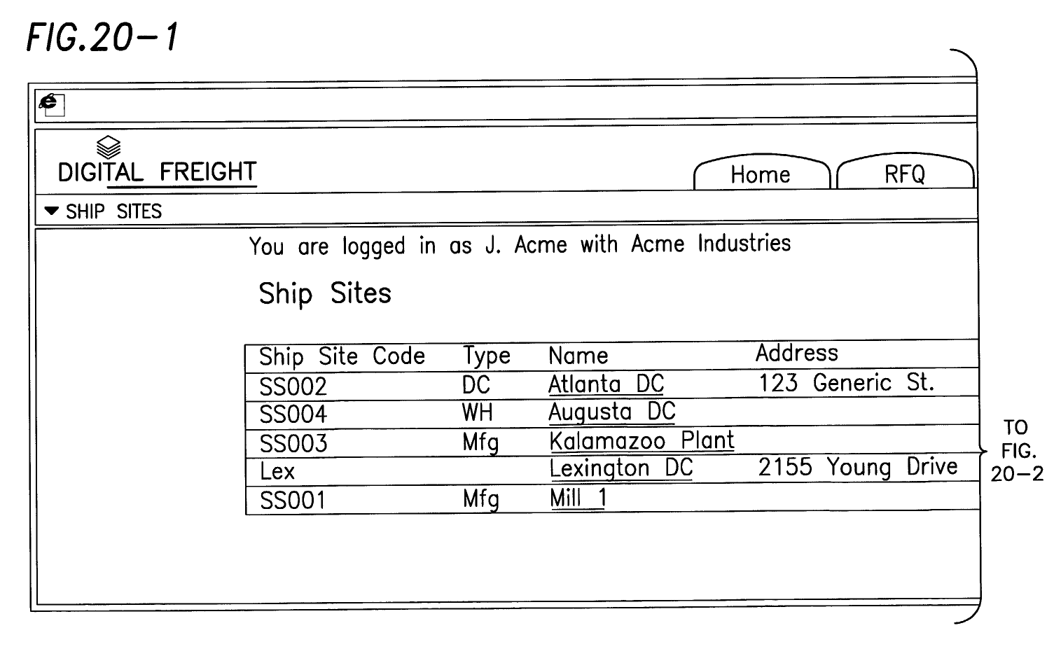

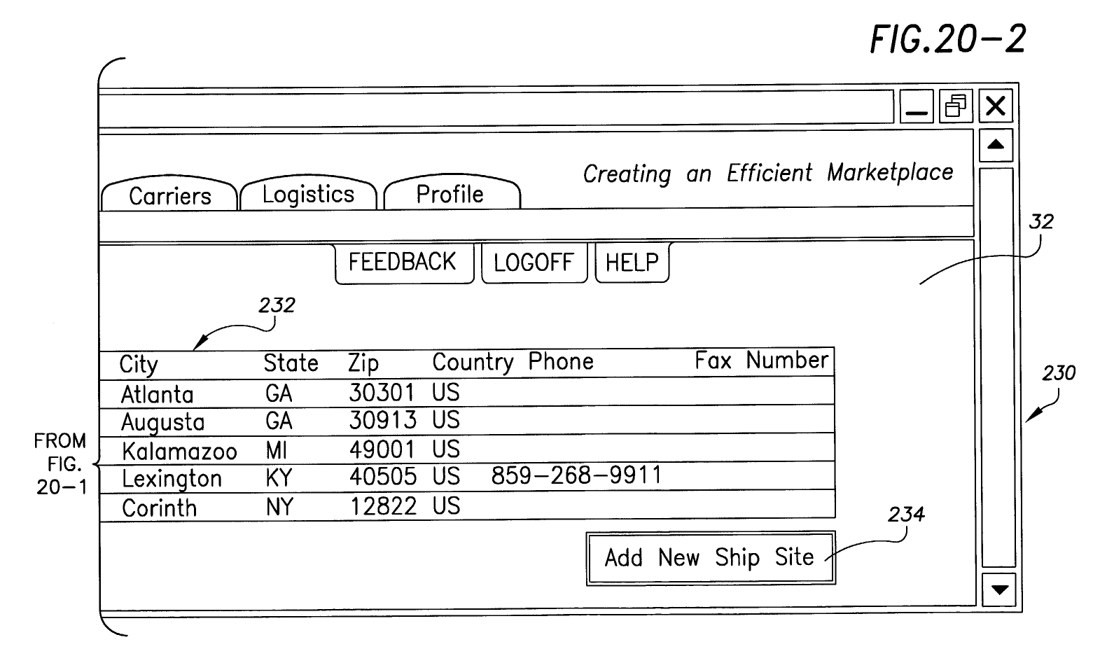

In addition, with respect to the RFQ LANES SCREEN 80 of FIG. 7, either the origin or destination location associated with each particular lane is preferably represented in hyperlink form so that the shipper can select the hyperlink to be directed to further information about that particular lane. For example, by selecting the “Michigan Products” hyperlink 88 associated with lane 5356, the shipper is re-directed to a SHIP SITES SCREEN 230, an example of which is shown in FIG. 20 and described below.

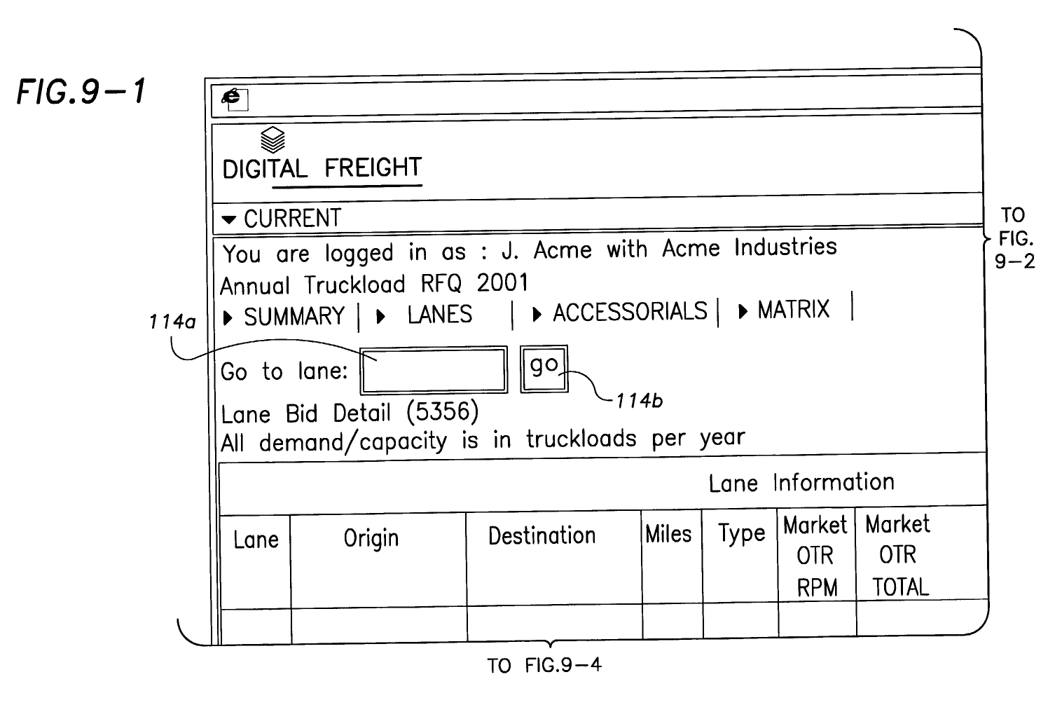

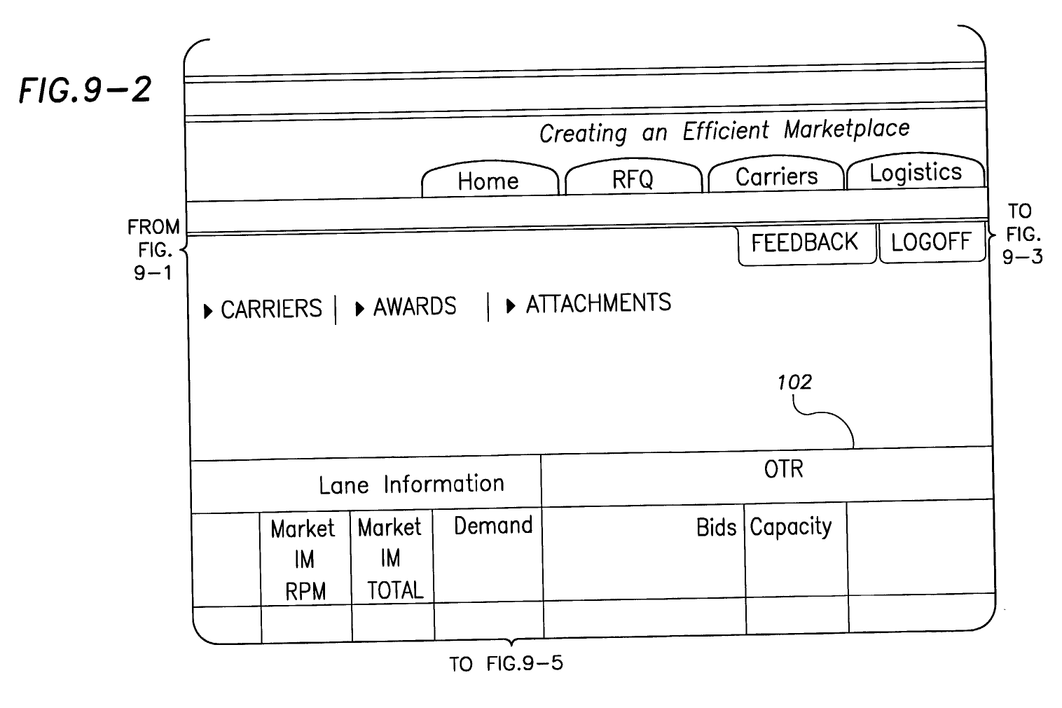

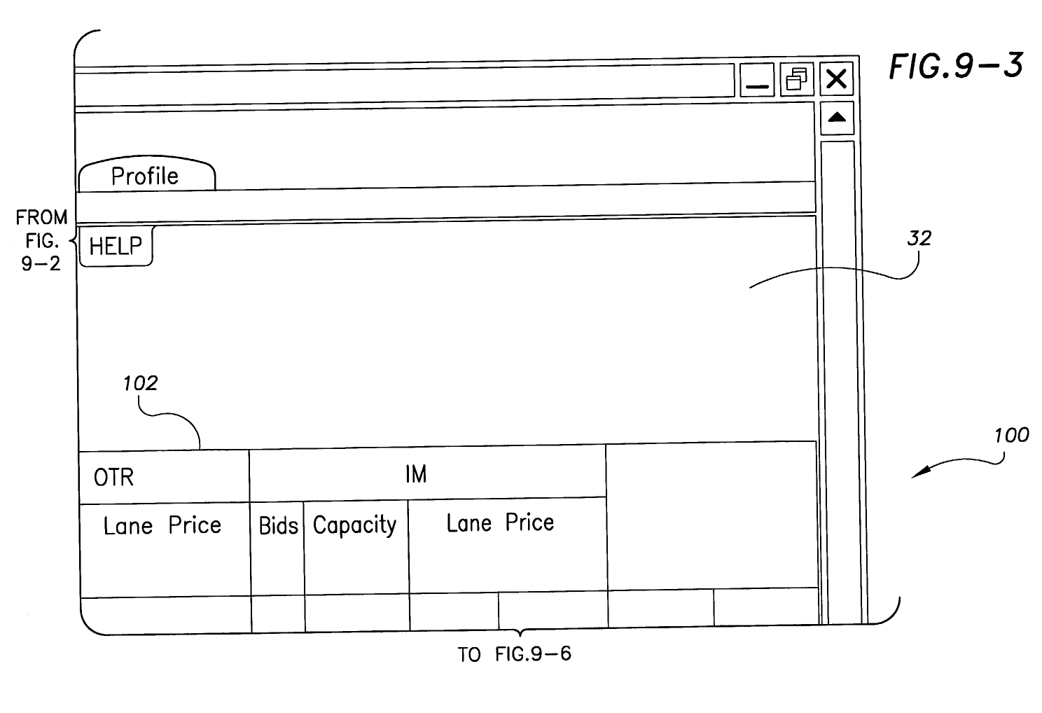

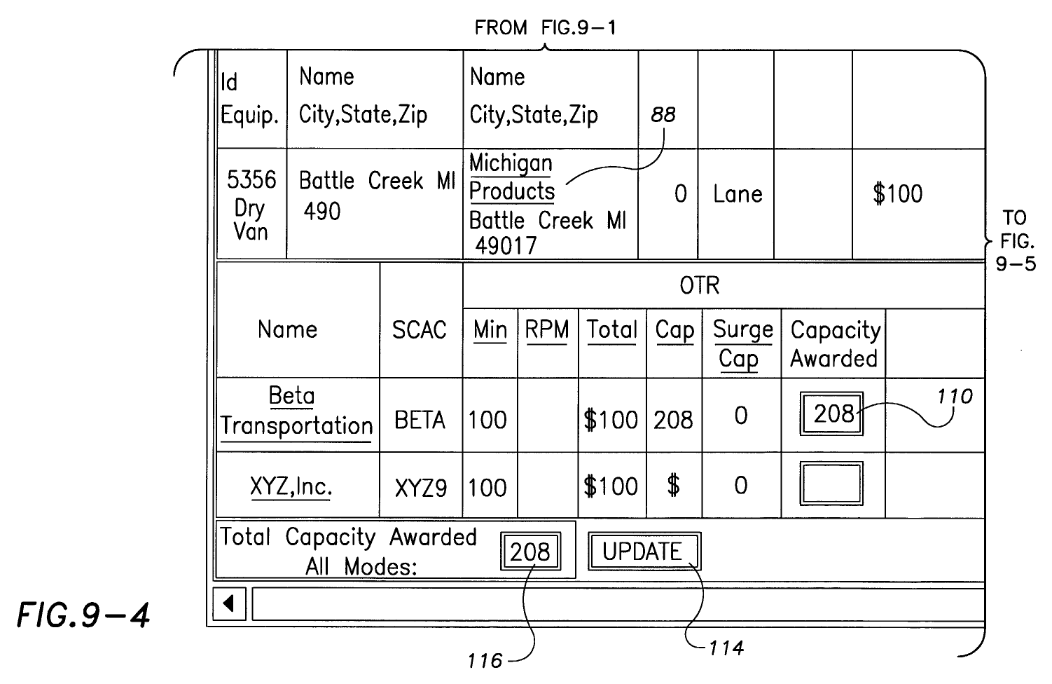

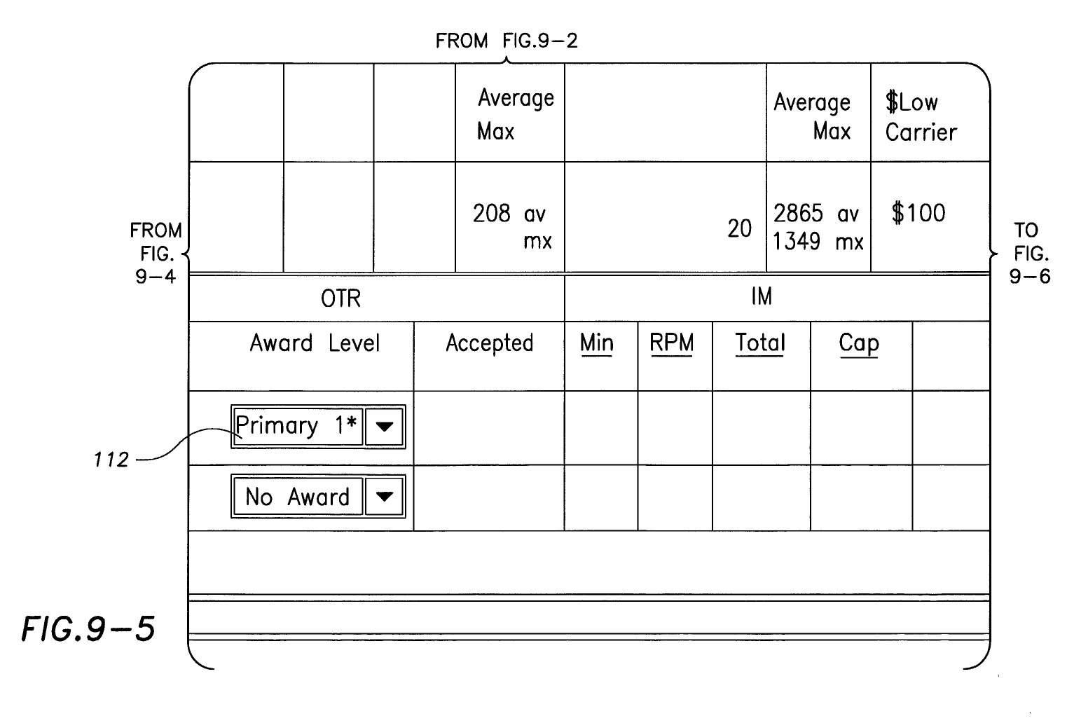

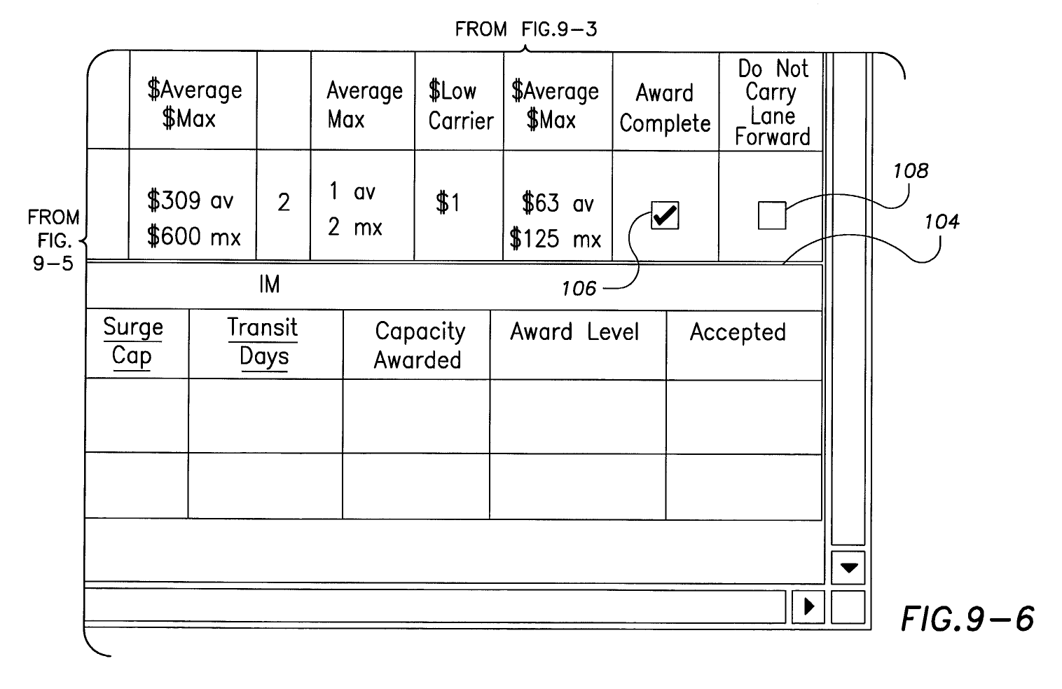

Lastly, with respect to the RFQ LANES SCREEN 80 of FIG. 7, by selecting the “Award this Lane” hyperlink 83 in the rightmost data column of the table 82 (as described above), the shipper is re-directed to the RFQ LANES DETAIL SCREEN 100, an example of which is depicted in FIG. 9.

As shown in FIG. 9, in the central display window 32 of the LANES DETAIL SCREEN 100 are two tables (generally indicated by reference numerals 102 and 104). The first table 102 contains much of the same detailed information that is included in the table 82 of the RFQ LANES SCREEN 80, as depicted in FIG. 7. However, the data columns labeled “Awarded Loads,” Awarded,” and “Award Status” are omitted as is the rightmost column containing “Award This Lane” hyperlinks. Alternatively, the last two data columns contain check boxes labeled “Award Complete” 106 and “Do Not Carry Lane Forward” 108.

By selecting carriers and awarding capacity as described further below, then checking the check box in the “Award Complete” data column 106, and finally selecting the “Update” button 114, the status of the RFQ is updated, and the updated status is reflected in the three data columns labeled “Awarded Loads,” Awarded,” and “Award Status” in the table 82 displayed in the central display window 32 of the RFQ LANES SCREEN 80, as depicted in FIG. 7.

By checking the check box in the “Do Not Carry Forward” data column 108 and then selecting the “Update” button 114, the lane is not carried over into subsequent rounds of the RFQ for further bidding by carriers.

The second table 104 contains data related to individual carriers who have placed bids on a particular lane. According to the data contained in the table 82 of the RFQ LANES SCREEN 80, as depicted in FIG. 7, twenty bids have been entered with respect to lane 5356. For purposes of clarity, however, the bids for only two carriers are displayed in the second table 104 of the LANES DETAIL SCREEN 100 of FIG. 9. The following information is displayed:

TABLE D

| | |
|---|---|
| Name | SCAC |

OTR

| Min | RPM | Total | Cap | |
|---|---|---|---|---|
| OTR | | | | |
| Surge Cap | Capacity Awarded | Award Level | Accepted | |
| IM | | | | |
| Min | RPM | Total | Cap | Surge Cap |
| IM | | | | |
| Transit Days | Capacity Awarded | Award Level | Accepted | |

Quite obviously, the “Name” data column identifies the name of the carrier who has placed a bid, and the “SCAC” data column identifies the carrier using the Standard Carrier Alpha Code (SCAC) as assigned by the National Motor Freight Traffic Association.

The next category of data columns relates to OTR transportation bids. Specifically, “Min” refers to the minimum charge a carrier will accept to transport freight over the lane. This minimum charge supersedes the rate-per-mile bid if the rate-per-mile bid is less than the stated minimum charge. As discussed above, “RPM” refers to the rate-per-mile bid. “Total” refers to the total bid, which is the greater of (1) the product of the rate-per-mile bid multiplied by the number of miles, and (2) the minimum charge. The minimum charge can be entered by the carrier to apply to the RFQ as a whole or the minimum charge entered on a specific lane; the lane-specific minimum charge, if any, takes precedence over the RFQ minimum charge, if any. “Cap” refers to the capacity of the carrier, i.e., the volume of truckloads the carrier can accommodate for the specified lane during a designated period of time. “Surge Cap” refers to the surge capacity, i.e., the additional capacity that a carrier can accommodate for the specified lane during a designated period of time in excess of its contractual capacity.

The next two data columns categorized under the “OTR” umbrella allow the shipper to award lanes to participating carriers. In this regard, after reviewing the various bids that have been submitted with respect to a lane, the shipper can choose which carriers to award the lane to. To accomplish this, the shipper enters the capacity it wishes to award to a particular carrier in the “Capacity Awarded” data column 110. For example, as shown in the LANES DETAIL SCREEN 100 of FIG. 9, Beta Transportation has submitted a bid with a capacity (“Cap”) of 208. The shipper has chosen to award the carrier its entire capacity and has thus entered 208 in the “Capacity Awarded” data column 110. The shipper then proceeds to the “Award Level” data column which allows the shipper to assign an appropriate award status by using a pull-down menu 112. For example, the award could be designated “primary” which would give the carrier a preferred status in being offered specific loads by the shipper. Alternatively, the award could be designated “secondary” which would give the carrier a lesser status, for example, with the carrier being offered the load only if carriers with “primary” award status decline specific loads. After appropriate awards have been entered, the shipper selects the “Update” button 114, and the information is updated in the integral database.

Finally, the last data column categorized under the “OTR” umbrella is labeled “Accepted” and provides an indication of whether the carrier has accepted or rejected the award, a process which will be described in further detail below.

Referring still to the second table 104 displayed in the LANES DETAIL SCREEN 100 of FIG. 9, the next category of data columns relates to IM transportation bids. The same data is displayed with respect to IM transportation as is displayed with respect to OTR transportation with one exception. Under the “IM” umbrella, there is one additional data column labeled “Transit Days” which refers to number of days projected for transporting freight over the specified lane.

The process of awarding capacity to carriers is identical with respect to IM transportation as it is with respect to OTR transportation.

Lastly, with respect to the sample DATA SCREEN 100 of FIG. 9, to assist the user in navigation through the this preferred embodiment, it is contemplated and preferred that a shipper can enter a specific lane number in the data entry filed 114a labeled “Go to lane:” and then by selecting the “go” button 114b, the user is re-directed to the DATA SCREEN for that particular lane. Also, for further convenience of the shipper, at the bottom of the central display window 32, there is a data field 116 labeled “Total Capacity Awarded All Modes” which provides a total calculation of the capacity that has been awarded for that particular lane of the RFQ.

As with each of the various screens described herein, the LANES DETAIL SCREEN 100 of FIG. 9 provides but one example of a preferred selection and layout of data columns. It is contemplated and preferred that the shipper can customize the selection and layout of the data columns to meets its individual needs and to facilitate review of the status of the RFQ. In this regard, it should be noted that the shipper may optionally designate other fields of information to be associated with each lane and displayed as additional columns of data. These “meta-data” driven fields may be arbitrarily populated by the shipper on an RFQ-by-RFQ basis.

FIGS. 5-9 thus demonstrate the general navigation through the preferred method and system from the perspective of a shipper seeking to view and award lanes for a particular RFQ. FIGS. 10-16 are also associated with shipper navigation and the viewing and awarding of bids, but are supplemental in nature and thus are not shown in FIG. 1.

Returning to the RFQ SUMMARY SCREEN 70 of FIG. 6, by selecting the “Accessorials” hyperlink 72c in the central display window 32, the shipper is re-directed to an RFQ ACCESSORIALS SCREEN 120, an example of which is depicted in FIG. 10. In the shipping and transportation industry, an “accessorial” is typically a charge by a carrier for an additional service or fee in connection with the transportation of goods for a specified lane, e.g., refrigeration, stopoffs in transit, and detention. “Accessorial” may also refer to a standard contractual term, other that a monetary charge, associated with the transportation of goods.

In the method and system of the present invention, a shipper preferably defines the accessorials when establishing an RFQ. The shipper either opens bidding with respect to these accessorials or sets a fixed price that it is willing to pay for the additional fee or service. In this regard, in the central display window 32 of the RFQ ACCESSORIALS SCREEN 120 of FIG. 10, there is a table 122 that provides the following information about bidding on the accessorials involved in the RFQ:

TABLE E

| | | | | | |
|---|---|---|---|---|---|
| Code | Name | Description | Amount | Bid Rule | Units |

| Bids | | | | Details |
|---|---|---|---|---|
| # | Min | Avg | Max | |

The “Code” and “Name” data columns provide a short-form means for identifying a particular accessorial. The “Description” data column provides more detailed information about the nature of the accessorial. If the shipper assigns a fixed charge for the accessorial, that charge appears in the “Amount” data column, and the designation “Fixed” appears in the “Bid Rule” data column. If the shipper allows open bidding on the accessorial, the designation “Open” appears in the “Bid Rule” data column. Lastly, if the shipper provides a default value for the accessorial that may be overridden by the carrier, the designation “Defaulted” appears in the “Bid Rule” data column. The next data column is labeled “Units” and indicates the units in which the accessorial is measured, e.g., hours, loads, or events.

The next four data columns provide specific information about the bids that have been submitted with respect to the various accessorials listed in the table 122. Specifically, “Bids” refers to the number of bids that have been submitted by carriers with respect to a particular accessorial. The “Min” is the minimum bid, the “Avg” is the average bid, and the “Max” is the maximum bid with respect to a particular accessorial.

Finally, the last data column of the table 122 displayed in the central display window 32 of the RFQ ACCESSORIALS SCREEN 120 is labeled “Details.” In this data column, there is a hyperlink 124 labeled “View Details” that re-directs the shipper to more detailed information about the bidding for a particular accessorial. An exemplary screen view showing such detailed information is not included in the present description.

Although the term “bid” or “bidding” is used with respect to the accessorials as depicted in the table 122 of the RFQ ACCESSORIALS SCREEN 120 of FIG. 10, these terms do not have the same meaning as with the bidding on lanes described above. Specifically, when defining the accessorials with respect to a particular RFQ, the shipper is simply seeking quotations. Since the accessorials are inextricably linked to one or more lanes of the RFQ, there is no separate negotiation process with respect to accessorials. Rather, the charges a carrier levies for accessorials constitutes another consideration which the shipper must take into account when awarding bids, a concept which will become clearer after a review of accessorials from a carrier's viewpoint, as is described below.

Returning to the RFQ SUMMARY SCREEN 70 of FIG. 6, by selecting the “Matrix” hyperlink 72d in the central display window 32, the shipper is re-directed to a RFQ MATRIX SCREEN 130, an example of which is depicted in FIG. 11. Matrix bidding does not directly affect lane bidding but is an important feature of the present invention. Specifically, FAK (“Freight All Kinds”) Matrix bidding allows carriers participating in an RFQ to submit rate-per-mile bids for particular transportation zones, from one geographic area to another. In this manner, as a shipper awards lanes to selected carriers, the shipper can also contract with these carrier to provide additional transportation services as needed pursuant to the rate-per-mile bids submitted though the FAK Matrix. Indeed, the shipper can mandate that carriers submitting lane bids also submit a specified number of matrix bids as a condition of their participation in the lanes bidding.

Returning to FIG. 11, in the central display window 32 of the RFQ MATRIX SCREEN 130, there are one or more matrices which display the lowest rate-per-mile bids submitted by zone. For purposes of example, a single matrix (generally indicated by reference numeral 132) is displayed in the central display window 32 of the sample RFQ MATRIX SCREEN 130 of FIG. 11. Of course, multiple matrices would be needed to appropriately display the data for an RFQ with nationwide scope.

Examining the single matrix 132 in the central display window 32 of the RFQ MATRIX SCREEN 130 of FIG. 11, it can be seen that state or regional codes are used to identify both the rows (origin) and the columns (destination) that comprise the matrix 132. By referring to the appropriate cell in the matrix 132, a shipper can view the lowest mileage rate for a particular transportation zone as determined through bidding by participating carriers. Furthermore, each rate displayed in the matrix 132 is represented in hyperlink form so that the user can select the hyperlink to be directed to a complete matrix table for the carrier offering the selected rate. An exemplary screen showing such a complete matrix table is not included in the present description, but the use of and bidding with matrices will become clearer after a review of matrices from a carrier's viewpoint, as is described below.

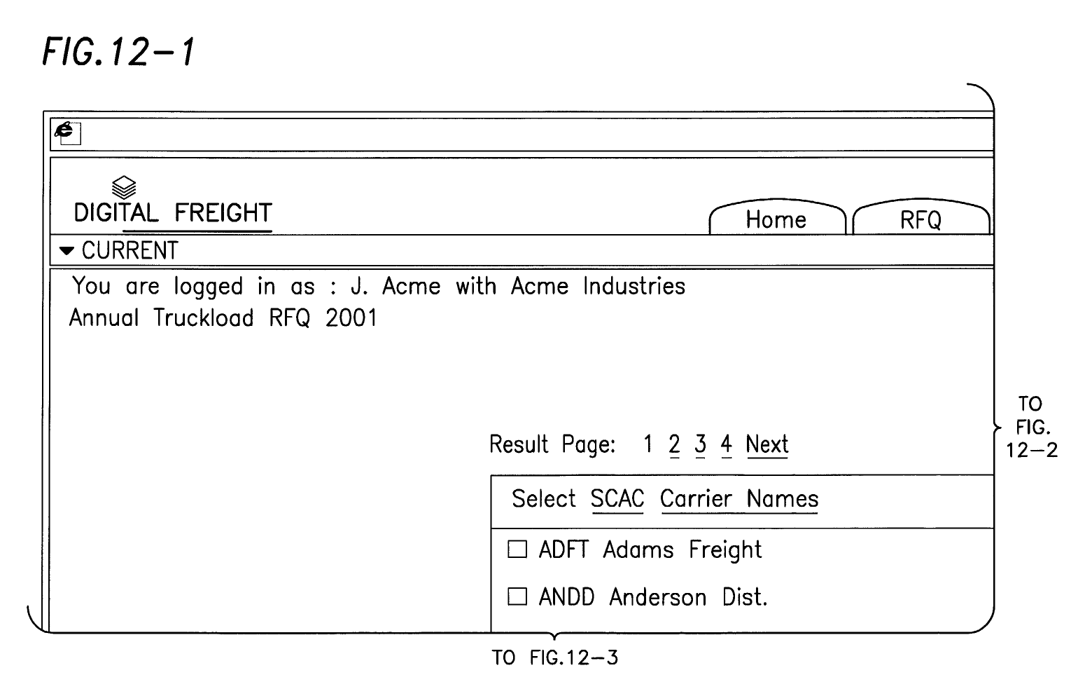

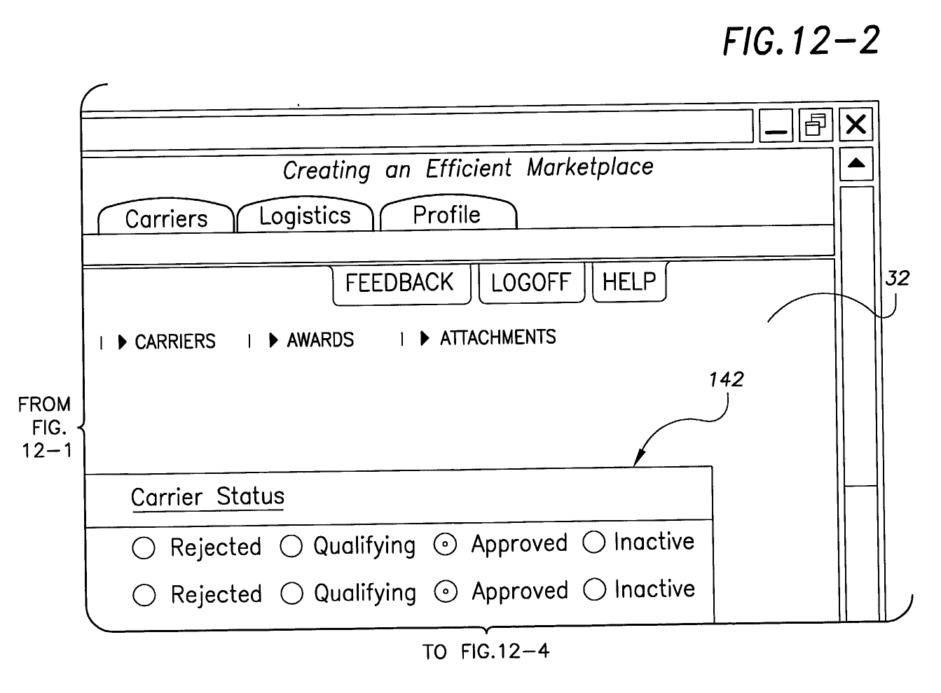

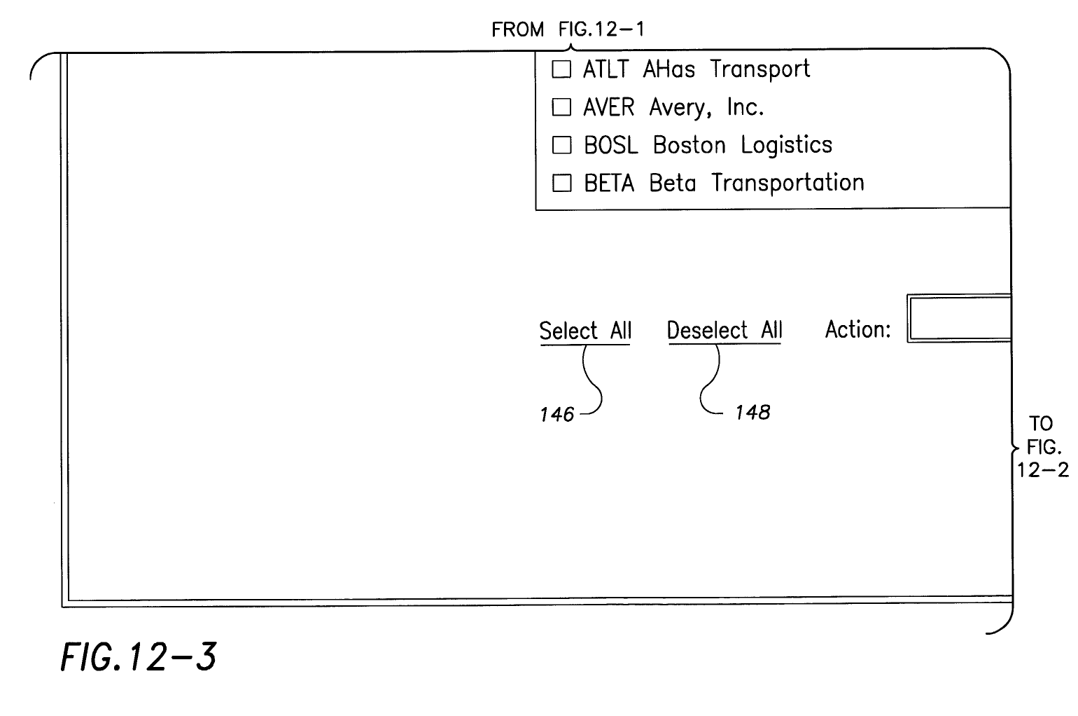

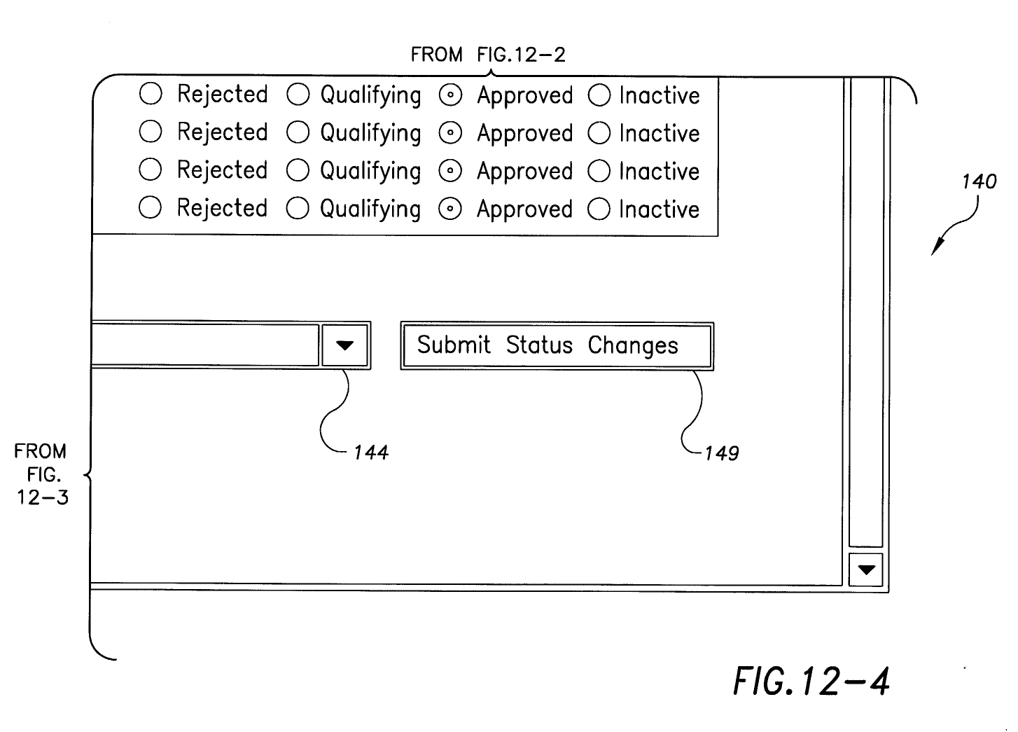

Returning to the RFQ SUMMARY SCREEN 70 of FIG. 6, by selecting the “Carriers” hyperlink 72e in the central display window 32, the user is re-directed to the CARRIERS STATUS SCREEN 140, an example of which is depicted in FIG. 12. In the central display window 32 of the CARRIERS STATUS SCREEN 140 is a table 142 that displays information related to participating carriers. Specifically, the table includes four data columns respectively labeled “Select,” “SCAC,” “Carriers Names” and “Carrier Status.” Quite clearly, the “SCAC” and “Carriers Names” data columns provide identifying information about the carriers participating in the RFQ. The rightmost data column—“Carrier Status”—identifies a particular carrier as being: (1) rejected, (2) qualifying, (3) approved, or (4) inactive. The shipper has the option of changing the status of each carrier by marking the new status in the appropriate check box or bubble. Once the appropriate marks have been made, selection of the “Submit Status Changes” button 149 updates the status of each carrier with respect to the particular RFQ in the integral database.

The status of each carrier is an indication of its approved level of participation with respect to a particular RFQ. A “rejected” carrier is not eligible for participation in the RFQ. A “qualifying” carrier meets the prerequisites for participation in the RFQ but has not been given final approval by the shipper. An “approved” carrier can fully participate in the RFQ. Lastly, as the label suggests, an “inactive” carrier has neither been rejected nor approved but has simply been removed from a particular RFQ by the shipper

As mentioned above with reference to the flow chart of FIG. 1, aside from administrative features such the modification of the personal profile as described above, a shipper primarily has two courses of action through the preferred system. The shipper can (1) view and award lanes for a particular RFQ, or (2) approve carriers for participation with respect to a particular RFQ. The ability to change the status of individual carriers is shown in FIG. 12 as a bridge between the two courses of action that can be pursued by the shipper. Other options with respect to the approval of carriers for participation in RFQs will be discussed in more detail below.

Referring again to the CARRIERS STATUS SCREEN 140 of FIG. 12, in the “Select” data column, there is a check box associated with each listed carrier. By clicking individual check boxes, a shipper can select one or more carriers and then take a specific action with respect to that group of carriers. For example, the shipper might want to send a message to a select group of carriers. In this regard, located in the lower portion of the central display window 32, below the table 142, is a pull-down menu 144 that allows the shipper to choose what action to take with respect to the selected group of carriers. For convenience and ease of use, there are also two hyperlinks in lower portion of the central display window 32 adjacent the pull-down menu 144 labeled “Select All” 146 and “Deselect All” 148. As indicated by their respective labels, the “Select All” hyperlink 146 causes all check boxes to be selected, and the “Deselect All” hyperlink 148 causes all check boxes to be deselected.

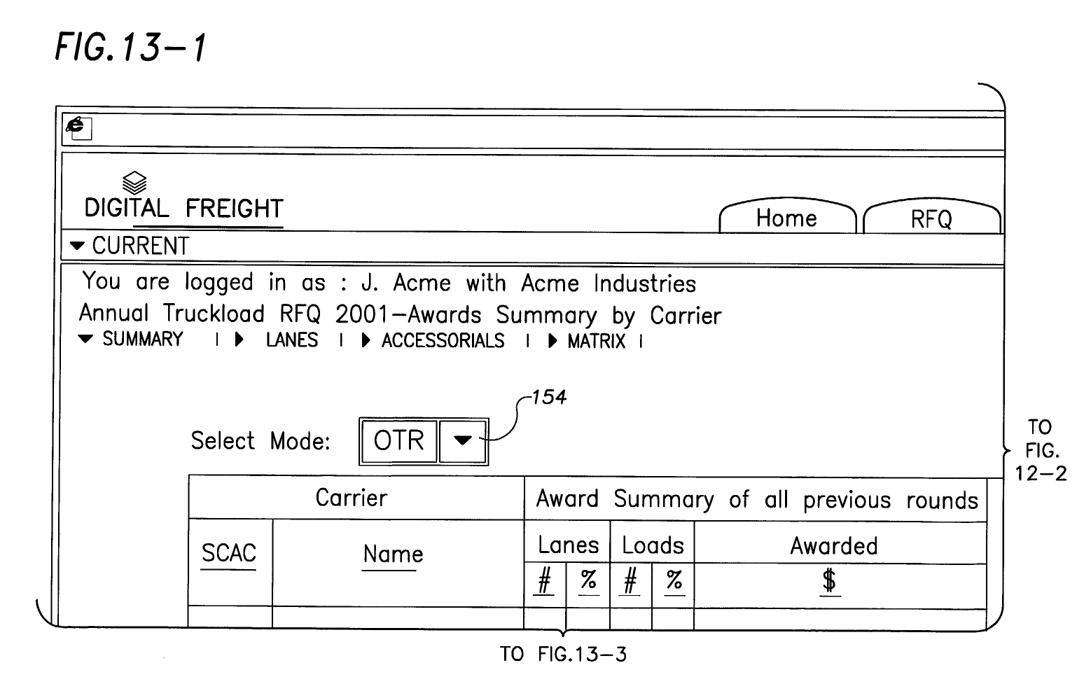

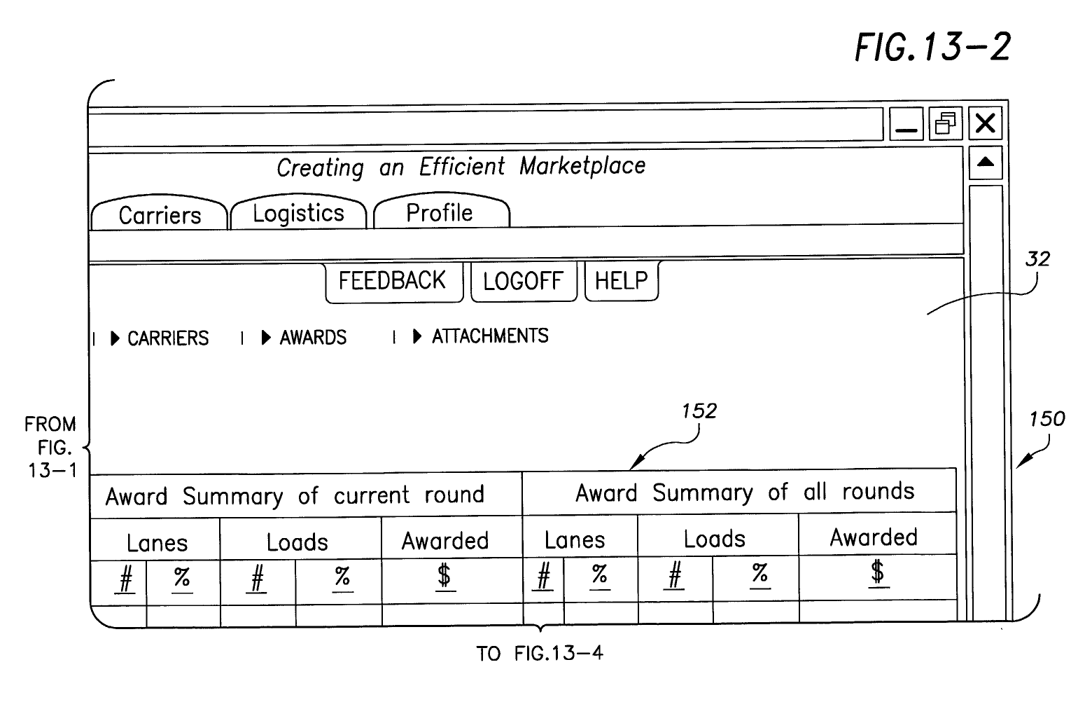

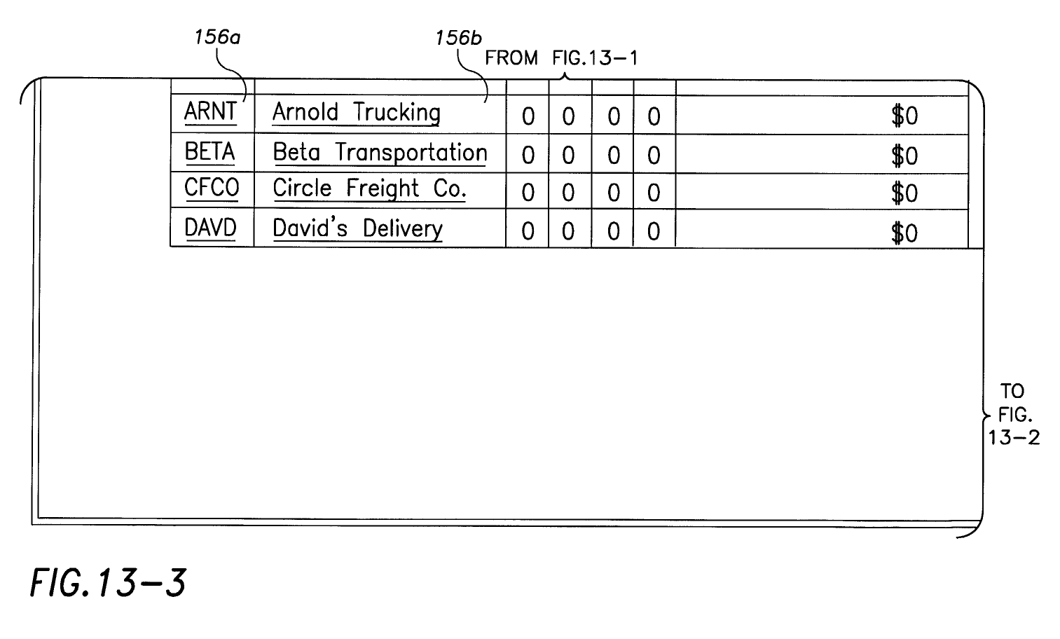

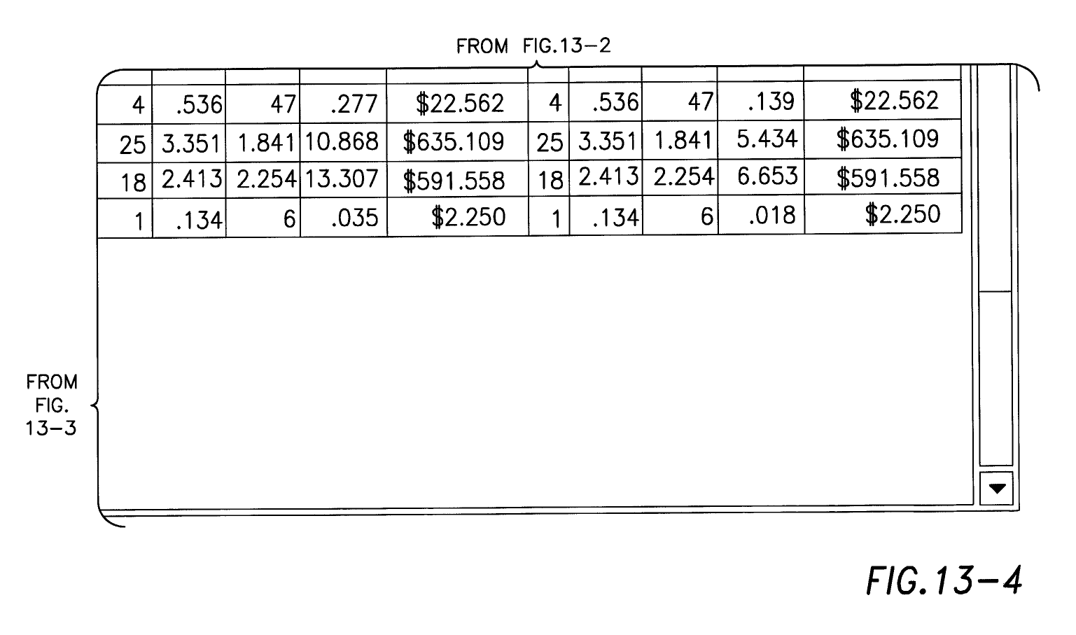

Returning now to the RFQ SUMMARY SCREEN 70 of FIG. 6, by selecting the “Awards” hyperlink 72f in the central display window 32, the user is re-directed to the RFQ AWARDS SUMMARY SCREEN 150, an example of which is depicted in FIG. 13. In the central display window 32 of the RFQ AWARDS SUMMARY SCREEN 150 is a table 152 that provides detailed information related to awards that have been made. In the particular embodiment shown in FIG. 13, for purposes of simplicity and clarity, there are only four carriers included in the table 152, and the following information is displayed:

TABLE F

| | |
|---|---|
| Carrier | |
| SCAC | Name |

| Award Summary of all previous rounds | | | | |
|---|---|---|---|---|
| Lanes | | Loads | | Awarded |
| # | % | # | % | $ |
| Award Summary of current round | | | | |
| Lanes | | Loads | | Awarded |
| # | % | # | % | $ |
| Award Summary of all rounds | | | | |
| Lanes | | Loads | | Awarded |
| # | % | # | % | $ |

Obviously, the first data columns labeled “SCAC” and “Name,” and categorized under the “Carrier” umbrella, provide identifying information. The next group of columns is under the “Award summary of all previous rounds” umbrella, and, as the label suggests, provides information about awards to each carrier for previous rounds of bidding. Specifically, the first two data columns labeled “Lanes #” and “Lanes %” indicate the number of lanes a carrier was awarded in previous rounds of bidding, and the percentage that that number of lanes represents based on the total number of lanes in the RFQ. Similarly, the second two data columns labeled “Loads #” and “Loads %” indicate the number of loads a carrier was awarded in previous rounds of bidding, and the percentage that that number of loads represents based on the total number of loads in the RFQ. Finally, the last data column under the “Award Summary of all previous rounds” umbrella is labeled “Awarded $” and indicates the total dollar value of the loads awarded.

The next category of data columns relates to the current round of bidding and is labeled “Award Summary of current round.” The same data is displayed with respect to the current round as is displayed with respect to previous rounds, specifically: “Lanes #”, “Lanes %” “Loads #,” “Loads %,” and “Awarded $.”

The final category of data columns relates to the total bidding and is labeled “Award Summary of all rounds.” The same data is displayed with respect to all rounds as is displayed with respect to previous rounds and the current round, specifically: “Lanes #,” Lanes % “Loads #,” “Loads %,” and “Awarded $.”

Lastly, with respect to the RFQ AWARDS SUMMARY SCREEN 150 of FIG. 13, located in the upper portion of the central display window 32, above the table 152, is a pull-down menu 154 that allows the shipper to choose the mode for which awards are displayed. In this regard, the RFQ AWARDS SUMMARY SCREEN 150 depicted in FIG. 13 displays award information pertaining to OTR transportation. Alternatively, the shipper could select IM transportation or another mode to view award information pertaining to the selected mode.

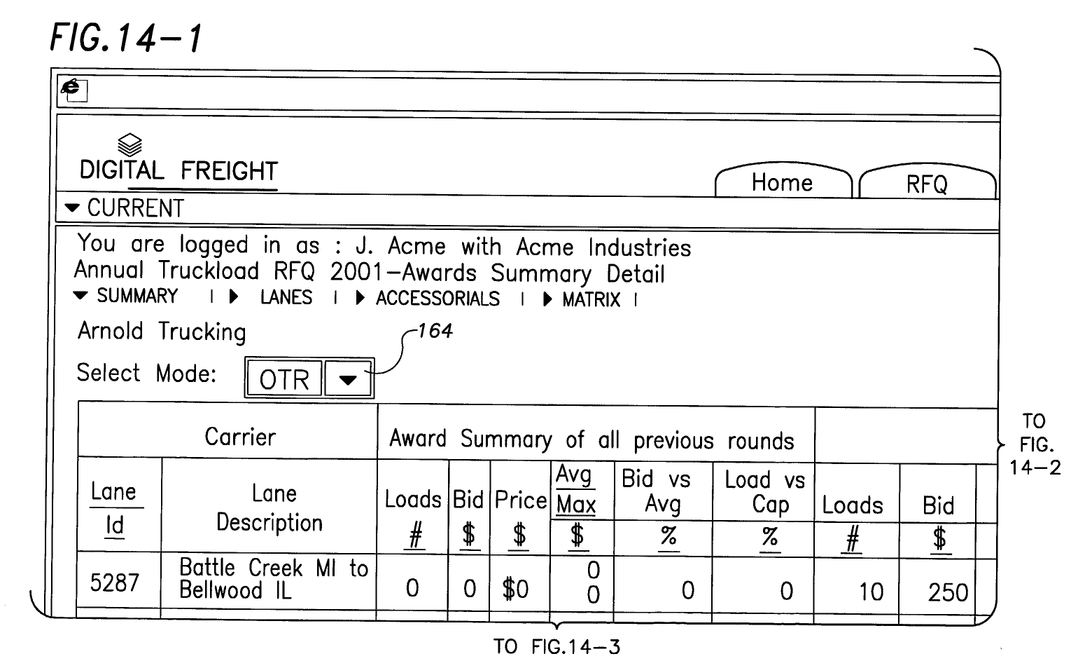

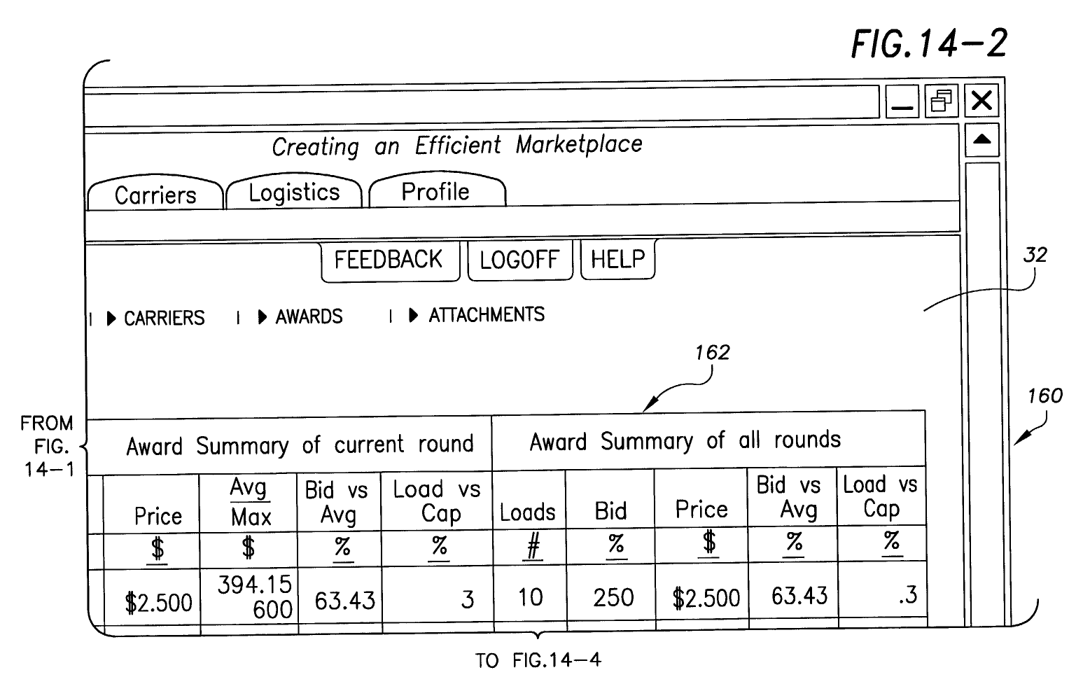

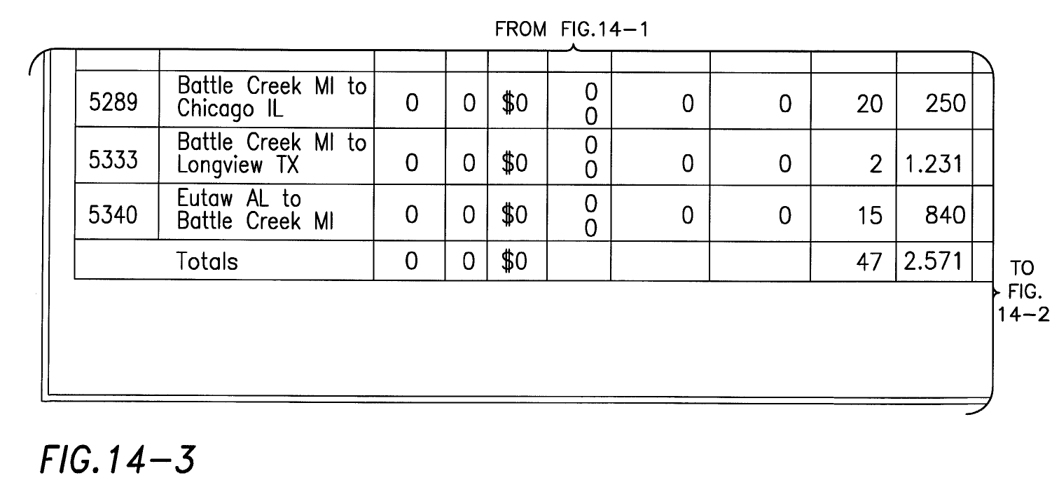

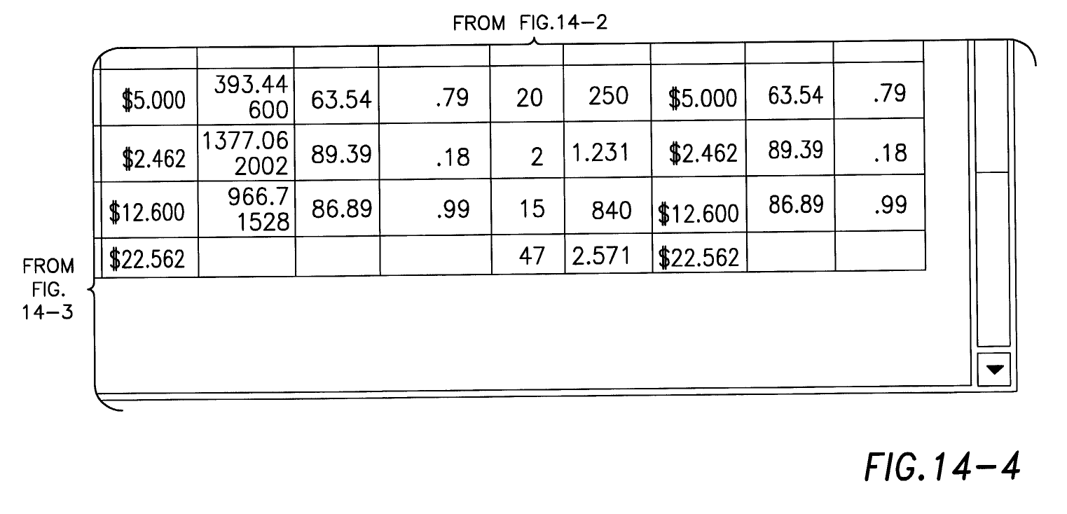

As a further refinement, it is contemplated and preferred that the “SCAC” and “Name” data associated with each carrier be represented in hyperlink form so that the shipper can select the hyperlink to be directed to further details about awards to the specified carrier. In this regard, FIG. 14 depicts an example of a RFQ AWARD DETAILS SCREEN 160 which the shipper is re-directed to in response to selecting of the “ARNT” hyperlink 156a or the “Arnold Trucking” hyperlink 156b in the table 152 of the RFQ AWARDS SUMMARY SCREEN 150 of FIG. 13.

As shown in FIG. 14, in the display window 32 of the RFQ AWARD DETAILS SCREEN 160, there is a table 162 that provides the following detailed information about awards to the carrier:

TABLE G
Lane Id
Lane Description
Award Summary of all previous rounds

| | | | | | |
|---|---|---|---|---|---|
| Loads | Bid | Price | Avg; Max | Bid vs Avg | Load vs Cap |
| # | $ | $ | $ | % | % |

Award Summary of current round

| | | | | | |
|---|---|---|---|---|---|
| Loads | Bid | Price | Avg; Max | Bid vs Avg | Load vs Cap |
| # | $ | $ | $ | % | % |

Award Summary of all rounds

| | | | | | |
|---|---|---|---|---|---|
| Loads | Bid | Price | Avg; Max | Bid vs Avg | Load vs Cap |
| # | $ | $ | $ | % | % |

The first two data columns labeled “Lane Id” and “Name” contain information to identify the particular lane for which an award has been made by the shipper.

The next group of columns is under the “Award summary of all previous rounds” umbrella, and, as the label suggests, provides information about awards for all previous rounds of bidding. Specifically, the first data column labeled “Loads #” indicates the number of loads a carrier was awarded for a particular lane. The second data column labeled “Bid $” indicates the dollar amount of the bid for the award. The third data column labeled “Price” indicates the total price—the product of the number of loads awarded and the bid (total charge per load), as shown in the first two data columns under the “Award summary of all previous rounds” umbrella. The fourth data column labeled “Avg; Max $” indicates the average and maximum bids for all carriers submitting bids with respect to a load in a particular lane. The fifth data column labeled “Bid vs Avg” provides a ratio, in percentage form, between the carrier's bid which led to the award of loads in the lane and the average bid as displayed per load in the “Avg; Max $” data column. Finally, the final data column under the “Award summary of all previous rounds” umbrella is labeled “Load vs Cap” and provides a ratio, in percentage form, between the number of loads awarded and the carrier's submitted capacity for the particular lane.

The next category of data columns relates to the current round of bidding and is labeled “Award Summary of current round.” The same data is displayed with respect to the current round as is displayed with respect to all previous rounds, specifically: “Loads #,” “Bid $,” “Price $,” “Avg; Max,” “Bid vs Avg,” and “Load vs Cap.”

The final category of data columns relates to the total bidding and is labeled “Award Summary of all rounds.” The same data is displayed with respect to all rounds as is displayed with respect to all previous rounds and the current round, specifically: “Loads #,” “Bid $,” “Price $,” “Avg; Max,” “Bid vs Avg,” and “Load vs Cap.”

Lastly, with respect to the RFQ AWARD DETAILS SCREEN 160 of FIG. 14, located in the upper portion of the central display window 32, above the table 162, is a pull-down menu 164 that allows the shipper to choose the mode for which awards are displayed. In this regard, the RFQ AWARD DETAILS SCREEN 160 depicted in FIG. 14 displays award information pertaining to OTR transportation. Alternatively, the shipper could select IM transportation or another mode to view award information pertaining to the selected mode.

As with the other shipper screens discussed in the present application, it is contemplated and preferred that the shipper can customize the selection and layout of the data columns of the RFQ AWARD DETAILS SCREEN 160 of FIG. 14 to meets its individual needs and to facilitate review of the status of the RFQ.

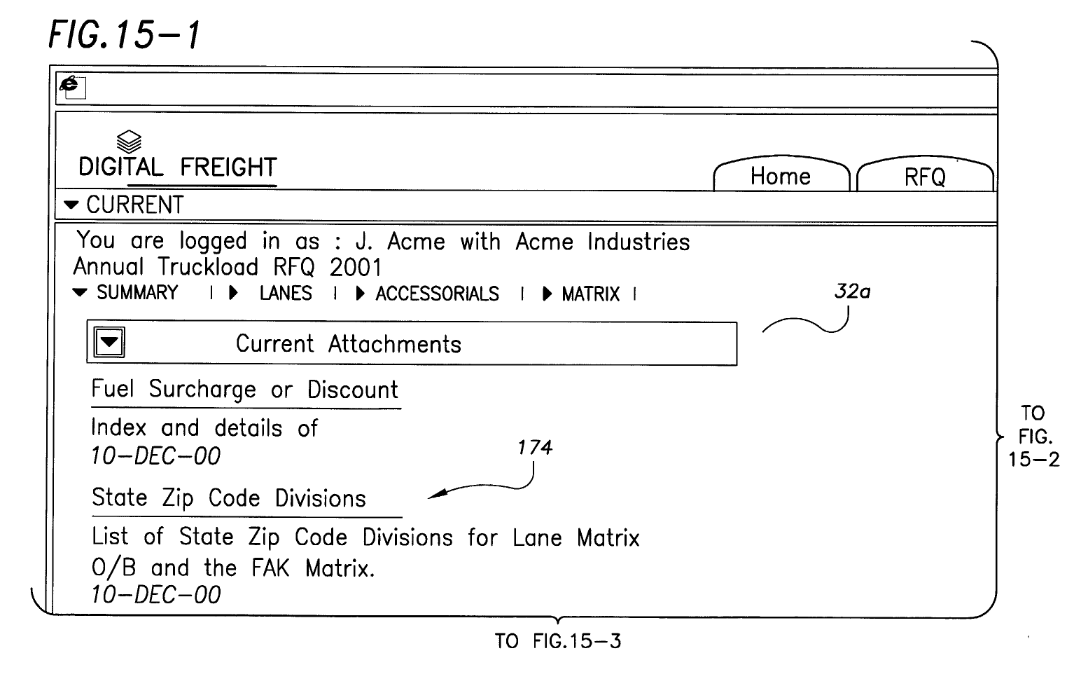

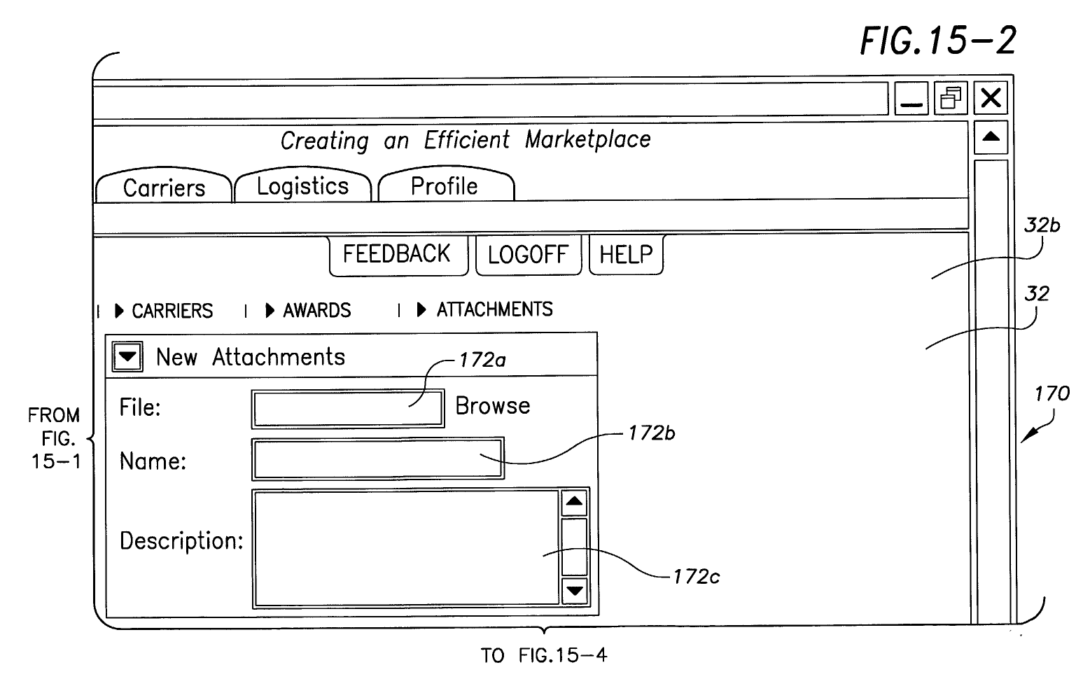

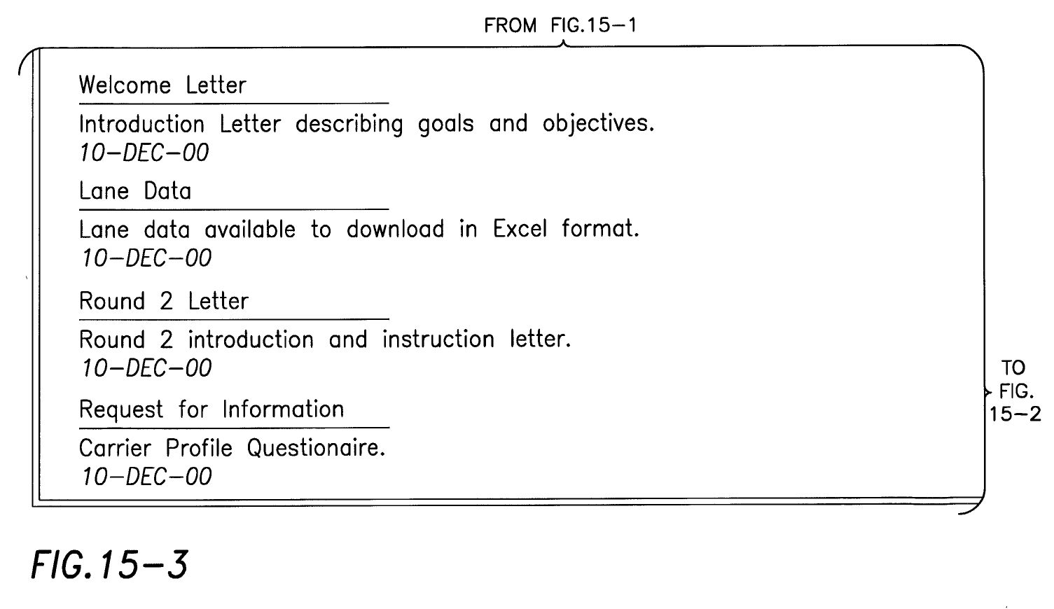

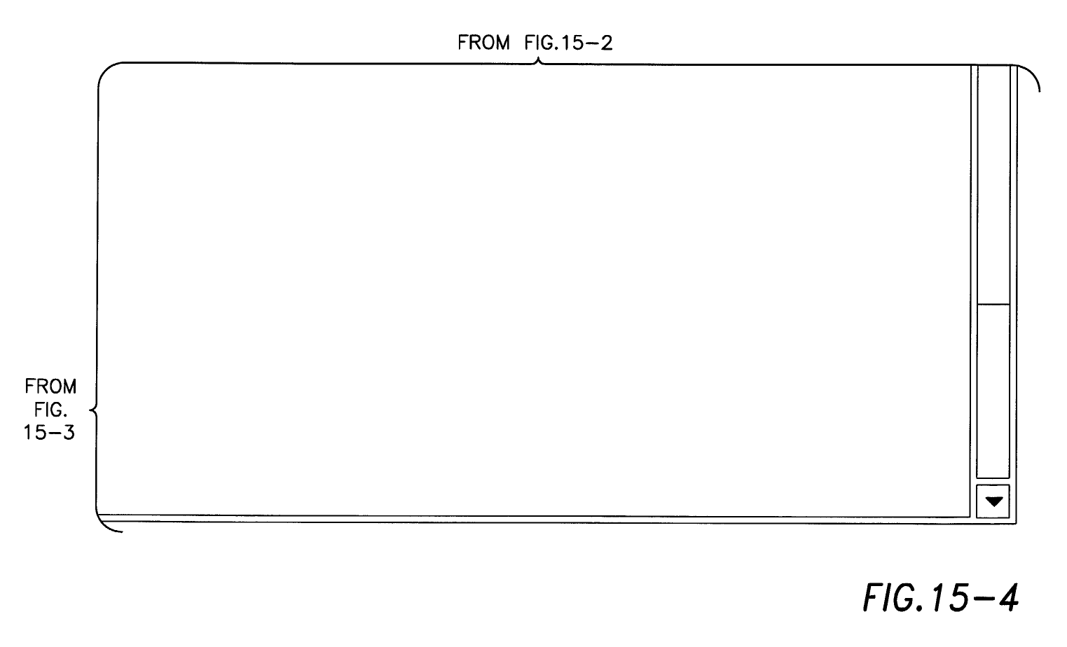

Returning to the RFQ SUMMARY SCREEN 70 of FIG. 6, by selecting the “Attachments” hyperlink 72c in the central display window 32, the user is re-directed to the RFQ ATTACHMENTS SCREEN 170, an example of which is depicted in FIG. 15. For purposes of this description, an “attachment” is a letter, table, spreadsheet, or other electronic document associated with a particular RFQ.

The RFQ ATTACHMENTS SCREEN 170 is comprised primarily of a central display window 32 having a left pane 32a and a right pane 32b.Displayed in the left pane 32a are text hyperlinks (generally indicated by reference numeral 174) to attachments associated with the particular RFQ. Such attachments may provide background information on the RFQ, downloadable data pertinent to the RFQ, or other relevant information. Displayed in the right pane 32b of the central display window 32 of the RFQ ATTACHMENTS SCREEN 170 is a form allowing the shipper to create a new attachment by entering (1) the path for accessing the file from a hard drive or other storage medium in the data entry field 172a labeled “File”; (2) the name of the attachment in the data entry field 172b labeled “Name”; and (3) the description of the attachment in the data entry field 172c labeled “Description.” Once the new attachment is submitted, the “Name” and “Description” of the attachment will be included in the left pane 32a of the central display window 32, the “Name” being represented in hyperlink form such that selection of the hyperlink will access the attachment.

FIG. 16 depicts a sample RFQ BID PROGRESS SCREEN 180 for the preferred embodiment described herein. As discussed above, by selecting the hyperlink labeled “RFQ Bid Progress Reports” 78a in the lower portion of the central display window 32 of the RFQ SUMMARY SCREEN 70 of FIG. 6, the shipper is re-directed to such a RFQ BID PROGRESS SCREEN 180. The RFQ BID PROGRESS SCREEN 180 includes a table 182 in the central display window 32 that provides detailed information about the progress and status of a specific round of the RFQ. Specifically, the table 182 provides the following summary information:

TABLE H

| Carrier | Lanes | Status | | |
|---|---|---|---|---|
| Bids (Number) | Bids (Chart) | Loads (Number) | Loads (Chart) | Time of Last Bid |

Quite obviously, the first data column labeled “Carrier” identifies the carriers submitting bids. In this regard, as with prior shipper screens described above, for purposes of clarity, only four carriers are displayed in the table 182 of the RFQ BID PROGRESS SCREEN 180 of FIG. 16, although it is contemplated that a much greater number of carriers would participate and submit bids in response to a particular RFQ.

The first data column of the table 182 labeled “Carrier” identifies the carriers participating in the RFQ. The second data column is labeled “Lanes” and identifies the number of lanes bid on by that particular carrier. The third data column is labeled “Status.” If the “Status” for a particular carrier is “Exposed,” the carrier has submitted its bids for review and award consideration by the shipper; otherwise, the carrier has not published the bids for award consideration.

The fourth and fifth data columns of the table 182 of the RFQ BID PROGRESS SCREEN 180 of FIG. 16 are collectively labeled “Bids.” The data in these columns reflects the number of lane bids that a carrier has placed in the particular RFQ, as a number and as a graphical representation (e.g., bar chart) of that number. It is important to note that the number of “Lanes” and “Bids” are not necessarily equal as a carrier could have submitted bids on the same lane in more than one mode, causing there to be more bids than lanes.

Similarly, the sixth and seventh data columns of the table 182 are collectively labeled “Loads,” and the data in these columns reflects the number of loads a carrier has placed in the particular RFQ, as a number and as a graphical representation (e.g., bar chart) of that number. Finally, the rightmost and last data column of the table 182 is labeled as “Time of Last Bid,” and, as the label suggests, provides the date and time of a carrier's last submitted bid.

As stated above, with reference to the flow chart of FIG. 1, aside from administrative features and other subordinate features, a shipper primarily has two courses of action through the preferred system. The shipper can (1) view and award lanes for a particular RFQ, or (2) approve carriers for participation with respect to a particular RFQ.

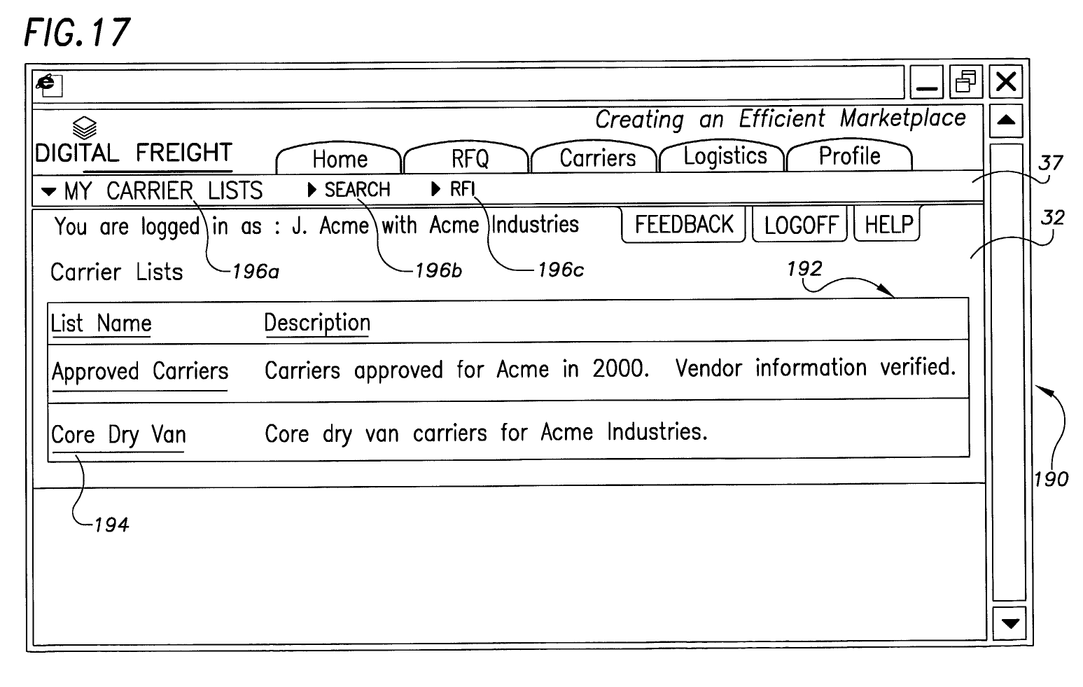

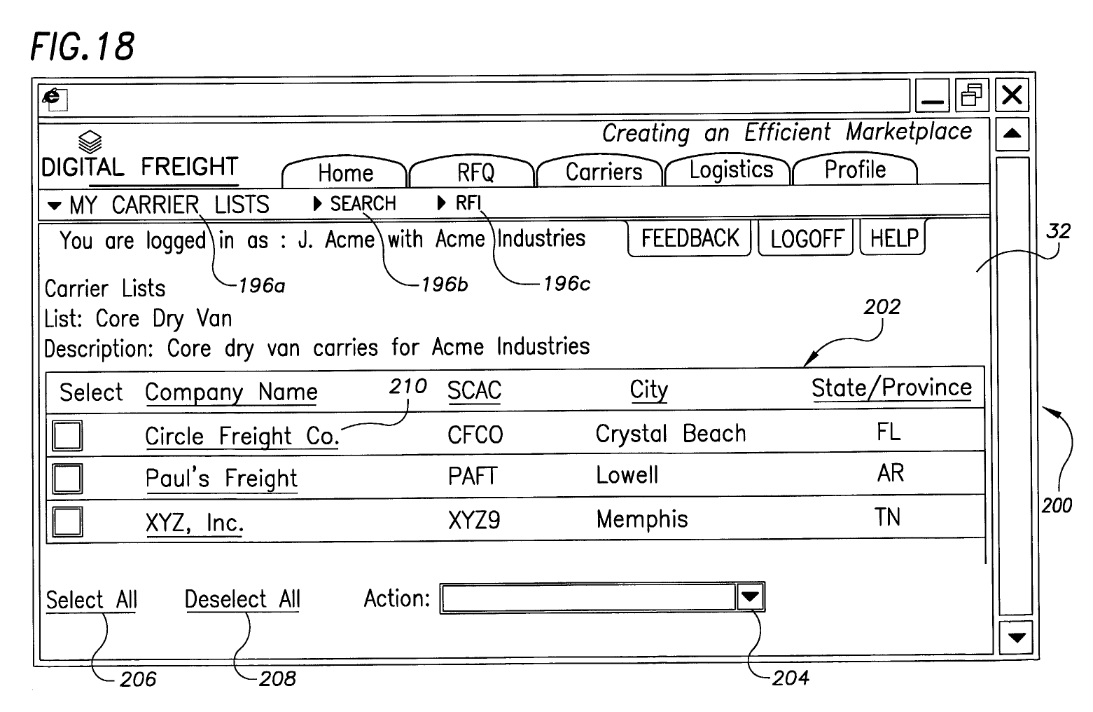

Considering now the second course of action—approval of carriers for participation with respect to a particular RFQ—FIG. 17 is a sample CARRIER LIST SCREEN 190, which is accessed through the selection of the CARRIERS tab 34c from a shipper screen. In the central display window 32 of the CARRIER LIST SCREEN 190 is a table 192 that provides the name and description of various carrier lists that have been created by the shipper and may be associated with a particular RFQ. Each list name, e.g. “Core Dry Van,” is represented in hyperlink form such that selection of the hyperlink re-directs the shipper to a screen providing more detailed information about the selected list. For example, by selecting the aforementioned “Core Dry Van” hyperlink 194, the shipper is re-directed to a CARRIER LIST DETAIL SCREEN 200, an example of which is depicted in FIG. 18.

Referring now to FIG. 18, in the central display window 32 of the CARRIER LIST DETAIL SCREEN 200 is a table 202 that provides identifying information about the selected carrier in data columns labeled “Company Name,” “SCAC,” “City,” and “State/Province.” The leftmost column of the table 202 is labeled “Select,” and, in this data column, there is a check box associated with each listed company name (or carrier). By selecting or clicking individual check boxes, a shipper can select one or more carriers and then take a specific action with respect to that group of carriers. For example, it is contemplated and preferred that the shipper have options that include: (1) modify list name and description; (2) delete selected carriers; (3) invite carrier to RFQ; (4) send a request for information (“RFI”) to selected carriers; (5) send a message to selected carriers; and (6) delete entire list. In this regard, located in the lower portion of the central display window 32, below the table 202, is a pull-down menu 204 that allows the shipper to choose what action to take with respect to the selected group of carriers. For convenience and ease of use, there are also two hyperlinks in lower portion of the central display window 32 adjacent the pull-down menu 204 labeled “Select All” 206 and “Deselect All” 208. As indicated by their respective labels, the “Select All” hyperlink 206 causes all check boxes to be selected, and the “Deselect All” hyperlink 208 causes all check boxes to be deselected.

Perhaps most important of the options described above is the shipper's ability to “invite carrier to RFQ.” As mentioned above, in this preferred embodiment, selected carriers (e.g., carriers with whom the shipper has a continuing business relationship) can be pre-approved for participation with respect to the particular RFQ when the RFQ is initially established and posted. However, the shipper can also approve additional carriers at any time during an RFQ. Thus, by selecting the option of inviting carriers to an RFQ, the shipper can approve carriers for participation in one or more RFQs. In this regard, although not shown in the attached Figures, selecting this option re-directs the shipper to a pull-down menu where the shipper can select the RFQ(s) to which the selected carriers are invited to participate, i.e. designated as “approved.” This is a second preferred manner in which carriers can be approved for participation in a particular RFQ, as shown in the flow chart of FIG. 1.

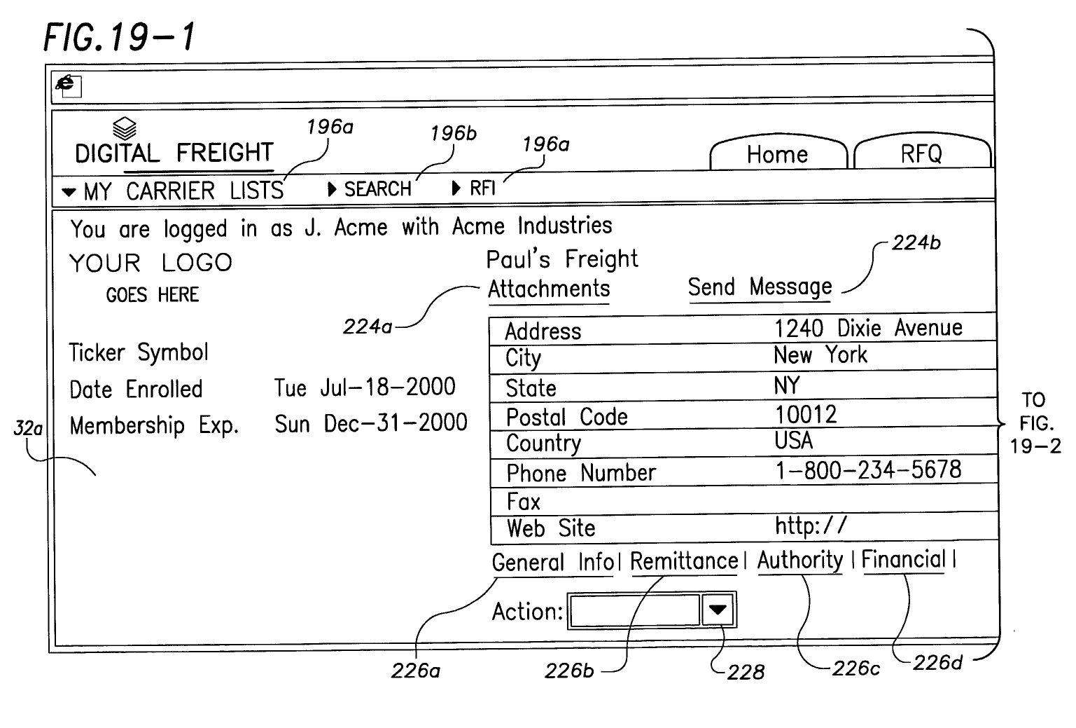

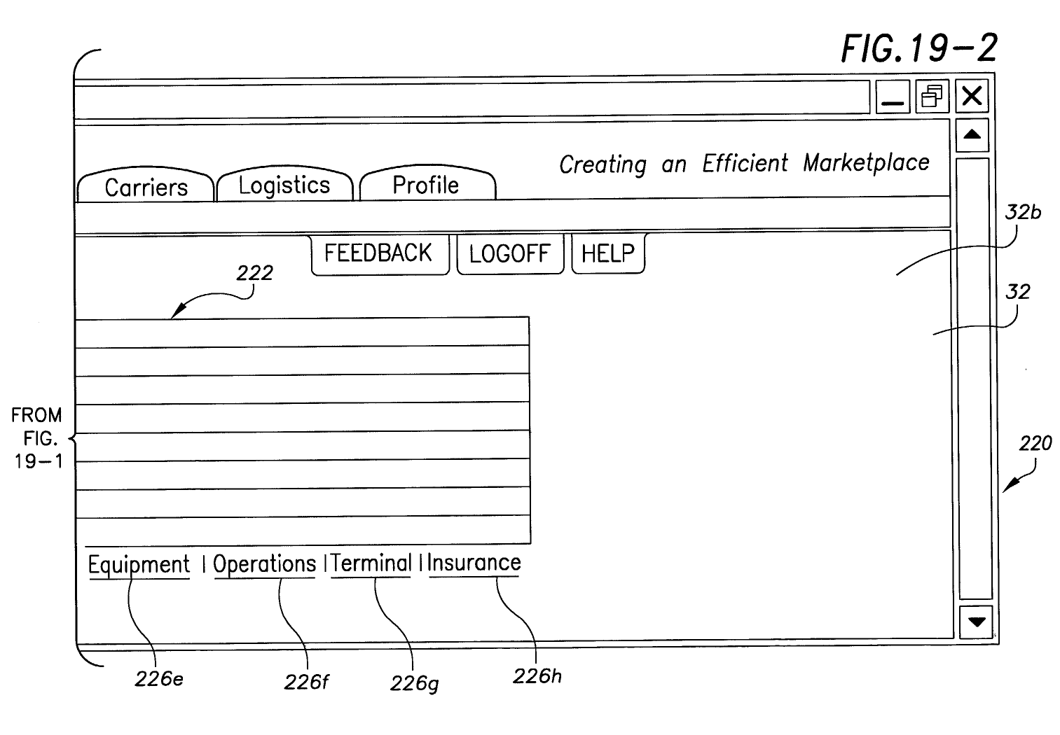

Referring still to FIG. 18, the identifying information appearing in the “Company Name” data column is represented in hyperlink form such that selection of the appropriate hyperlink re-directs the shipper to further information about a particular carrier. For example, by selecting the “Paul's Freight” hyperlink 210, the shipper is re-directed to a CARRIER STOREFRONT SCREEN 220, an example of which is depicted in FIG. 19.

Referring now to the CARRIER STOREFRONT SCREEN 220 of FIG. 19, various information and hyperlinks can be displayed in the central display window 32. In this particular example, in a left pane 32a of the central display window 32, there is an image field for the inclusion of a company logo, and information about the “Date Enrolled” with the system and associated “Membership Exp[iration]” date. Secondly, and most prominently, in the right pane 32b of the central display window 32, there is a table 222 providing identifying information about the selected carrier, including address, city, state, postal code, country, phone number, fax, and web site address.

Also, appearing in the upper portion of the central display window 32, just above the table 222, there is a hyperlink labeled “Attachments” 224a that re-directs the shipper to a screen that displays attachments associated with and posted by the carrier, and there is a hyperlink labeled “Send Message” 224b which re-directs the shipper to a form (not shown) that can be used to send electronic messages to the carrier securely within the system.

Appearing in the lower portion of the central display window 32, just below the table 222, there are also hyperlinks labeled: (1) “General Info” 226a; (2) “Remittance” 226b; (3) “Authority” 226c; (4) “Financial” 226d; (5) “Equipment” 226e; (6) “Operations” 226f; (7) “Terminal” 226g; and (7) “Insurance” 226h.

By selecting the “General Info” hyperlink 226a, the shipper is re-directed to a screen (not shown) displaying detailed identifying and contact information for the carrier.

By selecting the “Remittance” hyperlink 226b, the shipper is re-directed to a screen (not shown) displaying remittance contact information for the carrier.

By selecting the “Authority” hyperlink 226c, the shipper is re-directed to a screen (not shown) displaying detailed information about the carrier's authority to operate in various jurisdictions and under various licenses.

By selecting the “Financial” hyperlink 226d, the shipper is re-directed to a screen (not shown) displaying detailed information about the carrier's financial status, including, but not limited to, gross revenues, operating ratio, and debt/equity ratio.

By selecting the “Equipment” 226e hyperlink, the shipper is re-directed to a screen (not shown) displaying detailed information about the carrier's equipment, including, but not limited to, number of tractors owned, leased trailers, total trailers, number of driving teams, etc.

By selecting the “Operations” 226f hyperlink, the shipper is re-directed to a screen (not shown) displaying detailed information about the carrier's operations, including, but not limited to, mileage standard, most desirable origins and destinations, least desirable origins and destinations, and Department of Transportation (“DOT”) safety rating data.

By selecting the “Terminal” 226g hyperlink, the shipper is re-directed to a screen (not shown) displaying detailed information about the carrier's terminal locations.

By selecting the “Insurance” 226h hyperlink, the shipper is re-directed to a screen (not shown) displaying detailed information about the carrier's insurance coverage.

Collectively, the various information stored and maintained in the integral database defines a “carrier profile.” Indeed, it is contemplated that a great breadth of information could be maintained in the integral database associated with the method and system of the present invention creating a valuable document repository for the shipping and transportation industry. In addition, in some embodiments, there may also be a hyperlink in the central display window 32 CARRIER STOREFRONT SCREEN 220 that directs the shipper to a “printable” version of this carrier profile.

Lastly, below the above-discussed hyperlinks 226 of the CARRIER STOREFRONT SCREEN 220 of FIG. 19, there is a pull-down menu 228 that allows the shipper to take various other actions with respect to the carrier. For example, it is contemplated and preferred that the shipper have options that include: (1) add carrier to a new list; (2) add carrier to an existing list; (3) invite carrier to RFQ; (4) send a request for information (“RFI”) to carrier; and (5) send a message to carrier. Perhaps the most important of the options described above is the shipper's ability to “invite carrier to RFQ.” By selecting this option, the shipper can approve the carrier for participation in a particular RFQ in much the same manner as a group of carriers can be invited to participate in an RFQ through the pull-down menu 204 of the CARRIER LIST DETAIL SCREEN 200 of FIG. 18. This is a third preferred manner in which carriers can be approved for participation in a particular RFQ, as shown in the flow chart of FIG. 1.

Referring again to FIGS. 17-19, as a further refinement, there is a series hyperlinks 196 on the menu bar 37 that is positioned between the tabs 34 and buttons 36. The first hyperlink 196a is labeled “MY CARRIER LISTS” and its function is described below.

The second hyperlink 196b is labeled “SEARCH.” By selecting the SEARCH hyperlink 196b on the menu bar 37, the shipper is re-directed to a screen (not shown) that allows for searching based on various criteria, including, but not limited to, SCAC number, carrier name, DOT safety rating, or any other identifying information associated with the carriers maintained in the integral database.

The third hyperlink 196c is labeled “RFI.” By selecting the RFI hyperlink 196c on the menu bar 37, the shipper is re-directed to a screen (not shown) that allows for the shipper to create or review Requests for Information (“RFI”). Such RFIs are important in that they allow a shipper to request specific information from carrier which the shipper may need in order to approve a carrier for participation in an RFQ or to make award decisions.

Returning now to the “MY CARRIER LISTS” hyperlink 196a, when the shipper is on a screen related to the SEARCH or RFI functions, selection of this hyperlink 196a returns the shipper to the CARRIER LIST SCREEN 190 of FIG. 17.

As has been emphasized throughout this description, it is contemplated and preferred that the user can customize the selection and layout of the data displayed in the various shipper screens, including selection and layout of the data displayed in FIGS. 17-19.

FIG. 20 depicts a preferred SHIP SITES SCREEN 230 in the preferred embodiment described herein, a screen that is accessed through the selection of the LOGISTICS tab 34d of a shipper screen. As shown, the SHIP SITES SCREEN 230 includes a table 232 in the central display window 32 that provides identifying information concerning the various ship sites for the shipper. In the example of FIG. 20, each shipper site is identified by: ship site code, type, name, address, city, state, zip, country, phone, and fax number. Of course, other identifying information could also be included in the table 232 without departing from the spirit and scope of the present invention.

Also, there is a button 234 in the lower portion of the central display window 32, just below the table 232, that is labeled “Add New Ship Site.” Selection of the “Add New Ship Site” button 234 re-directs the shipper to a screen (not shown) were the shipper can enter the requisite identifying information associated with the new ship site, and then store such information in the integral database.

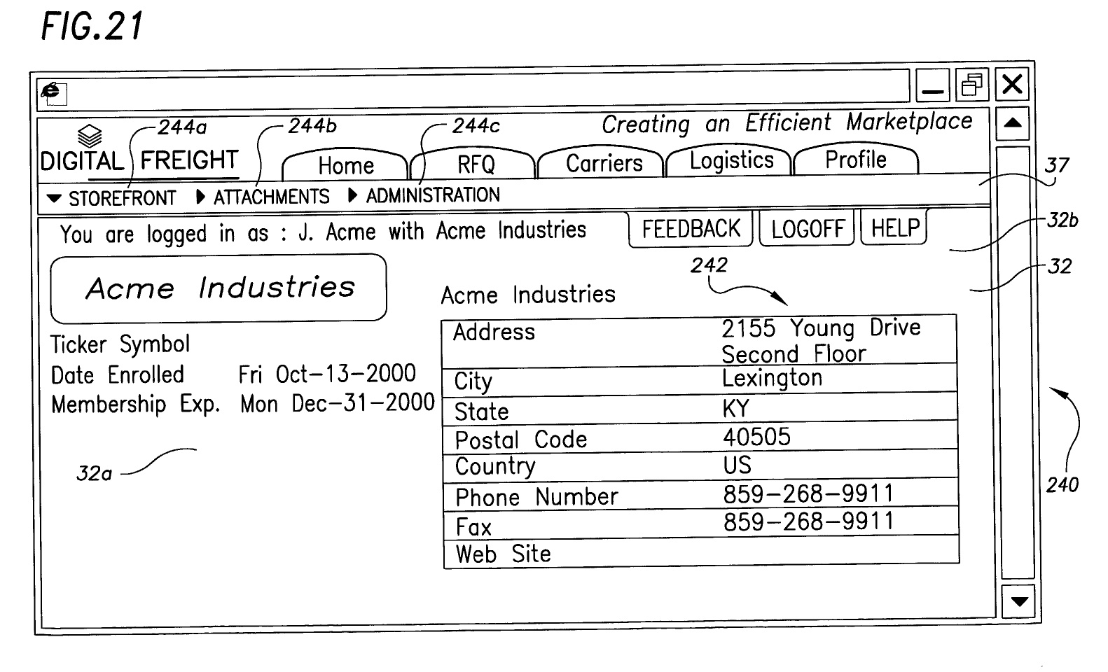

FIG. 21 depicts a preferred SHIPPER PROFILE SCREEN 240 in accordance with the method and system of the present invention, a screen that is accessed through the selection of the PROFILE tab 34e of a shipper screen. The SHIPPER PROFILE SCREEN 240 is very similar to the CARRIER STOREFRONT SCREEN 220, an example of which is depicted in FIG. 19. Specifically, various information and hyperlinks can be displayed in the central display window 32 of the SHIPPER PROFILE SCREEN 240. In this particular example, in a left pane 32a of the central display window, there is information about the “Date Enrolled” with the system and associated “Membership Exp[iration]” date. Secondly, and most prominently, in the right pane 32b of the central display window 32, there is a table 242 providing identifying information about the selected carrier, including address, city, state, postal code, country, phone number, fax, and web site address.

As a further refinement, as shown in FIG. 21, there is a series hyperlinks 244 on the menu bar 37 that is positioned between the tabs 34 and buttons 36 of the PROFILE SCREEN 240. The first hyperlink 244a is labeled “STOREFRONT” and its function is described below.

The second hyperlink 244b is labeled “ATTACHMENTS.” By selecting the ATTACHMENTS hyperlink 244b on the menu bar 37, the shipper is re-directed to a screen (not shown) that allows the shipper to review, delete, or add attachments. As defined above, an “attachment” may be a letter, table, spreadsheet or other electronic document associated with the shipper or a particular RFQ.

The third hyperlink 244c is labeled “ADMINISTRATION.” By selecting the ADMINISTRATION hyperlink 244c on the menu bar 37, the shipper is re-directed to a screen (not shown) that displays a list of the individual authorized users (and their respective permission levels) associated with the shipper and registered with the system.

Returning now to the “STOREFRONT” hyperlink 244a, when the shipper is on a screen related to the ATTACHMENTS or ADMINISTRATION functions, selection of this hyperlink 244a returns the shipper to the SHIPPER PROFILE SCREEN 240 of FIG. 21.

Finally, as mentioned above, FIG. 22 depicts a pop-up window 250 displayed in the Internet browser, a window that is open through the selection of the HELP button 36c of a shipper screen. Displayed in this pop-window is various information about this preferred embodiment of the present invention, along with hyperlinks directing the shipper to other useful information about this preferred embodiment of the present invention.

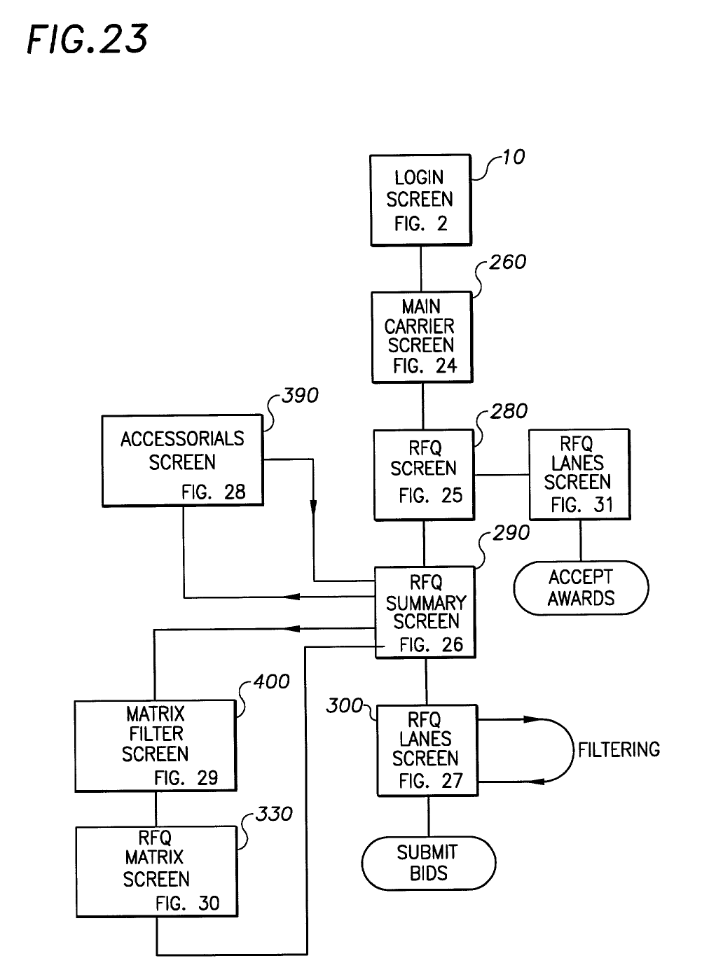

Having described the essential navigation through the method and system of the present invention as implemented through an Internet web site from the perspective of a shipper, FIGS. 23-35 supplement the description of navigation through the method and system of the present invention from the perspective of a carrier.

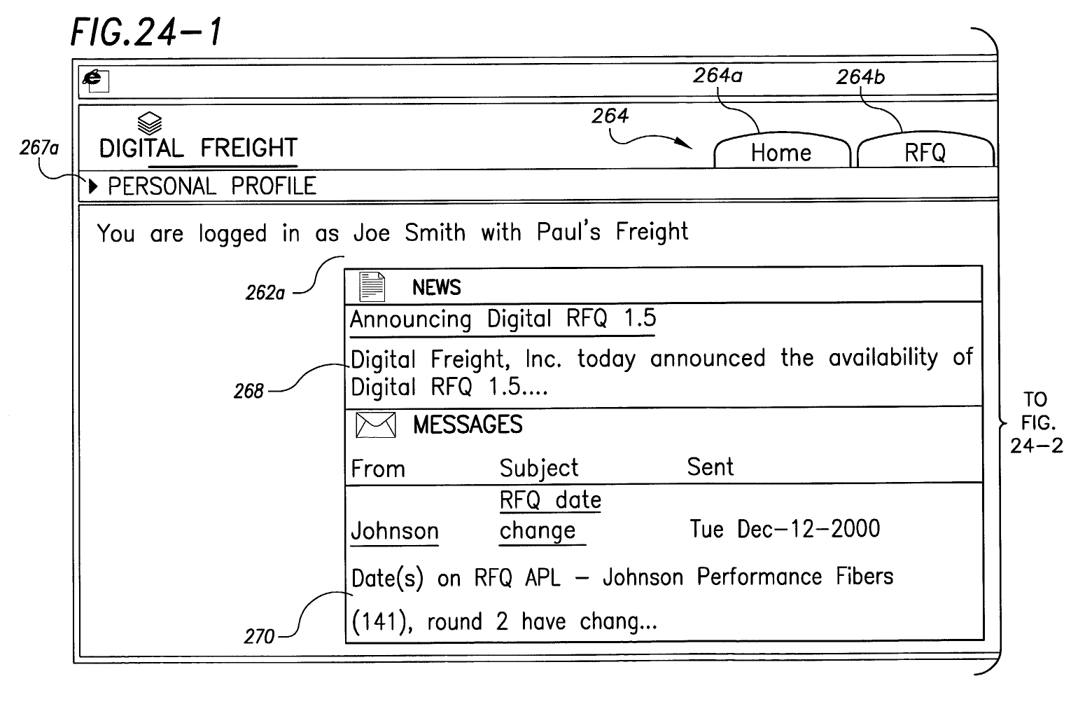

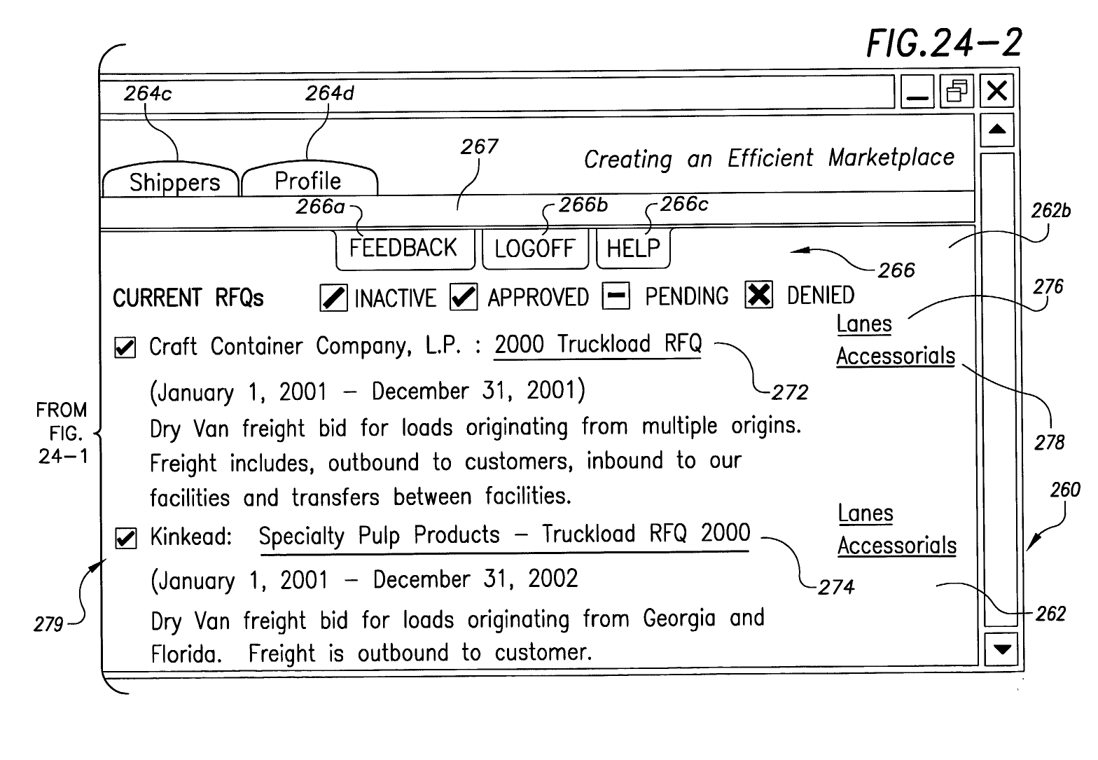

FIG. 23 is a flow chart depicting general operation of and movement through the preferred embodiment from the perspective of a carrier. As shown in FIG. 23, assuming a verification of a valid usemame and password, a registered carrier entering the system is directed from the LOGIN SCREEN 10 (which is the same LOGIN SCREEN 10 described with respect to shippers and depicted in FIG. 2) to a MAIN CARRIER SCREEN 260, an example of which is shown in FIG. 24.

The MAIN CARRIER SCREEN 260 is almost identical to the MAIN SHIPPER SCREEN 30 depicted in FIG. 3, and is comprised of a central display window 262 having a left pane 262a and a right pane 262b.Such a central display window 262 is a common feature of all the “carrier” screens in this preferred embodiment. Various text messages, images, and/or hyperlinks can be displayed in these panes 262a, 262b. Along the top of this central display window 262 are a series of tabs 264 and a series of buttons 266.

In this preferred embodiment, there are four tabs arrayed along the top of the central display window 262: a HOME tab 264a, an RFQ tab 264b,a SHIPPERS tab 264c, and a PROFILE tab 264d. It is important to note that, although these tabs 264 are not particularly pointed out with reference to all of the screens described in this specification, these four tabs do appear on each and every “carrier” screen in the preferred method and system. The function of each of these tabs 264 will be explained in more detail below.

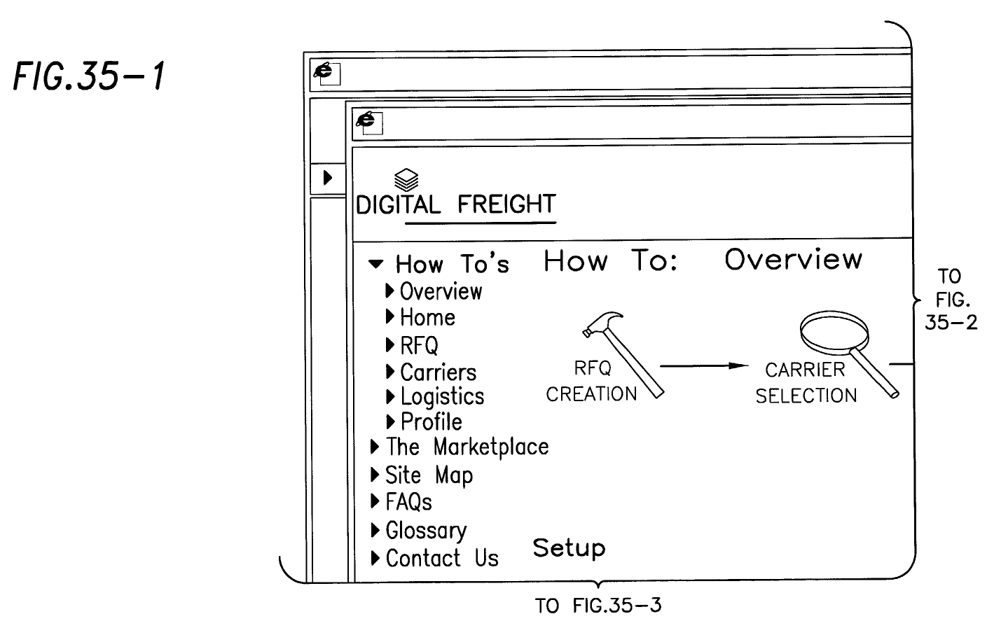

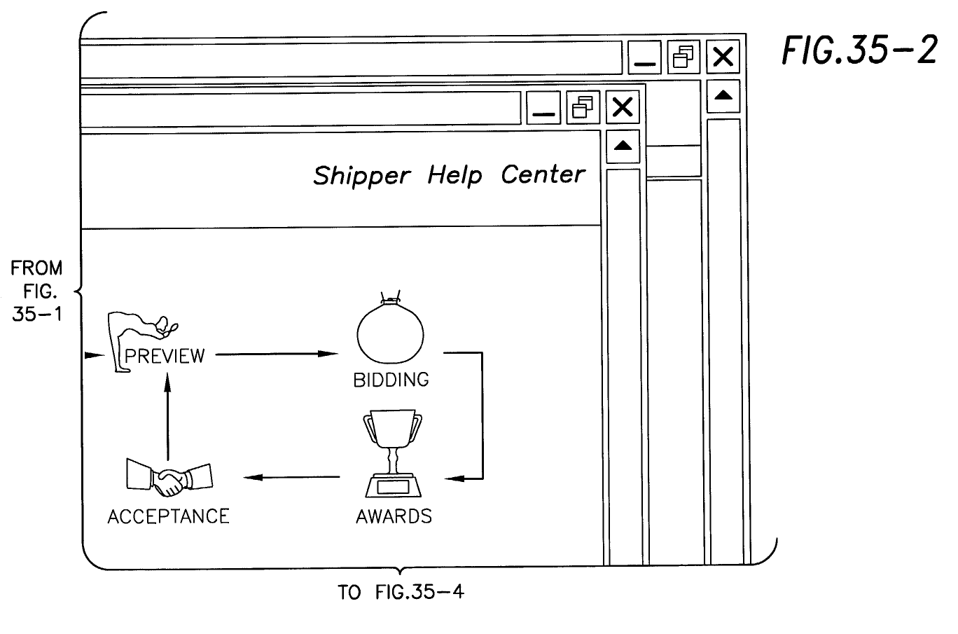

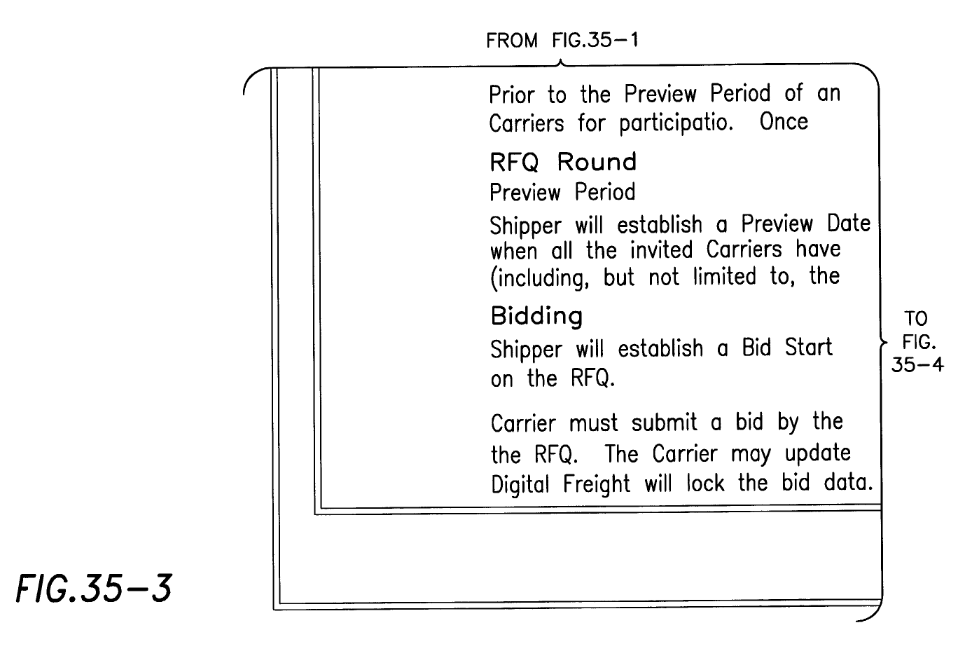

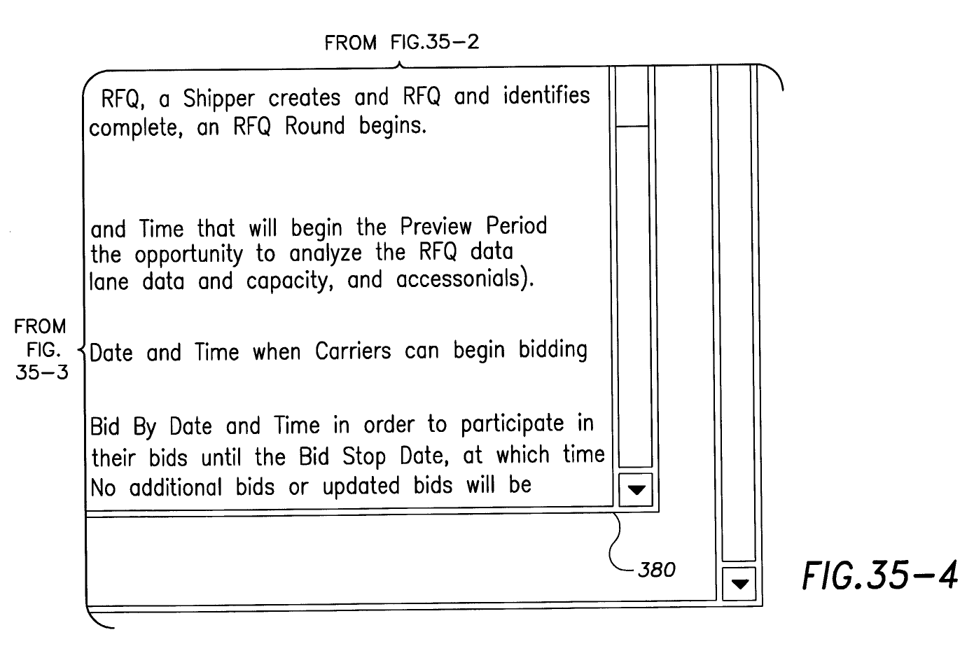

In this preferred embodiment, positioned just below the tabs 264 are a series of buttons 266: a FEEDBACK button 266a, a LOGOFF button 266b, and a HELP button 266c. Selection of the FEEDBACK button 266a re-directs the user to Internet-based mailing form (not shown) that can be used to send electronic mail concerning comments or concerns to system administrators. Selection of the LOGOFF button 266b effectively disconnects the user from the system, re-directing the user the LOGIN SCREEN 10, as depicted in FIG. 2, or another Internet web page. Finally, selection of the HELP button 266c causes a pop-up window 380 to be displayed in the Internet browser, an example of which is depicted in FIG. 35.

Similar to the tabs described above, it is important to note that, although these buttons 266 are not particularly pointed out with reference to all of the screens described in this specification, these three buttons 266 do appear on each and every “carrier” screen in this preferred embodiment. These buttons 266 each perform the identical function when selected regardless of which screen is being displayed at the time the button is selected.

In this preferred method and system, on the MAIN CARRIER SCREEN 260 of FIG. 24, there is also a menu bar 267 positioned between the tabs 264 and buttons 266 described above which allows for yet another option. By selecting the PERSONAL PROFILE hyperlink 267a on the menu bar 267, the carrier is re-directed to a screen (not shown) which is identical to the PROFILE SCREEN 50 discussed with reference to shipper navigation and depicted in FIG. 4. As discussed with reference to FIG. 4, such a personal profile screen allows the user to revise profile data, including name, address, phone number, fax number, email address, and secret question and answer.

Returning to the central display window 262 of the MAIN CARRIER SCREEN 260 of FIG. 24, it is contemplated and preferred that the left pane 32a display (1) summaries of and/or hyperlinks 268 to news stories of interest to the registered carrier; (2) summaries of and/or hyperlinks 270 to messages directed to the registered carrier; and, although not shown in FIG. 24, summaries of and/or hyperlinks to requests for information (“RFIs”) directed to the registered carrier. It is contemplated and preferred that the right pane 262b display pending (and previous) requests for quotation (“RFQ”) posted by shippers. In the example of FIG. 24, two RFQs 272, 274 are displayed in the right pane 262b of the central display window 262 of the MAIN CARRIER SCREEN 260.

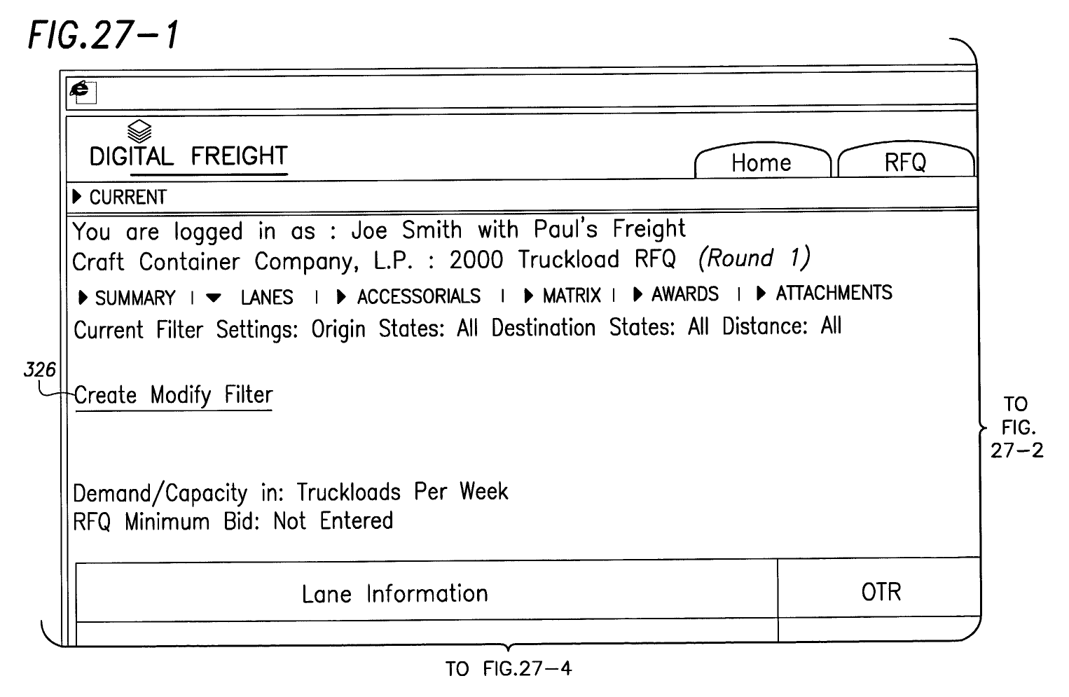

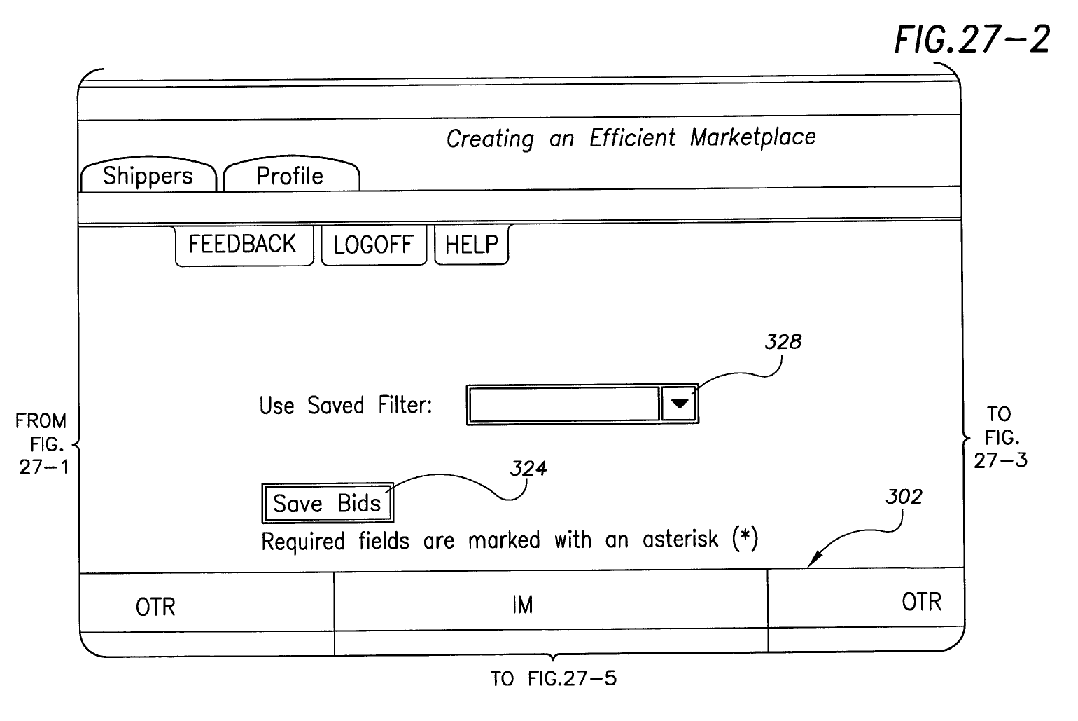

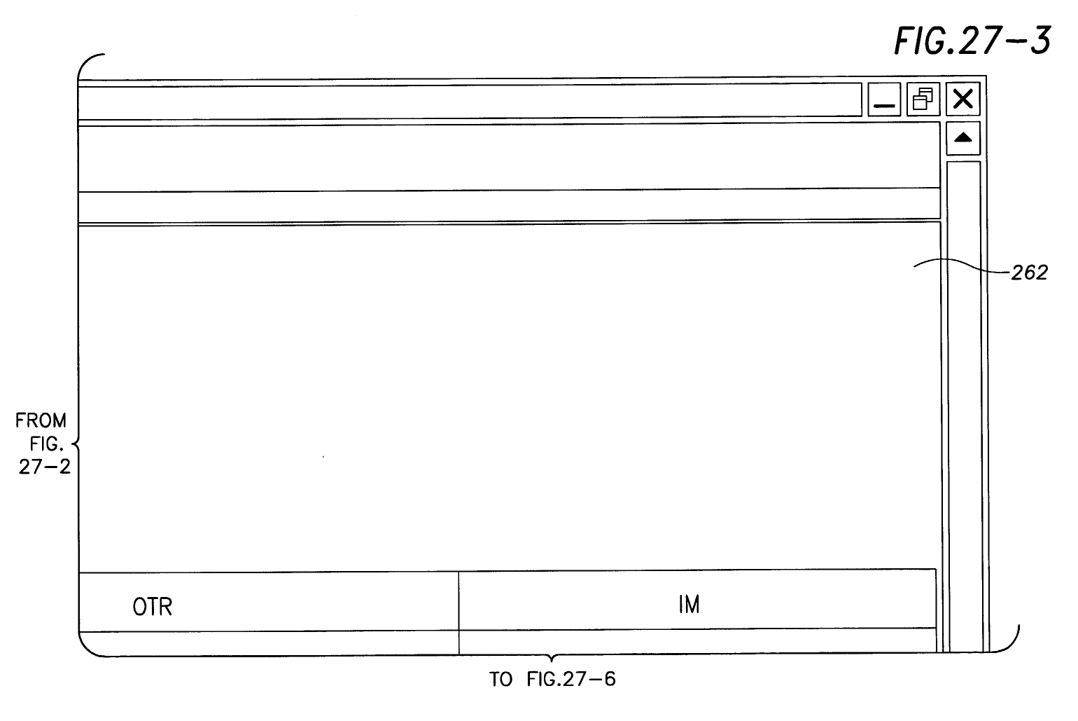

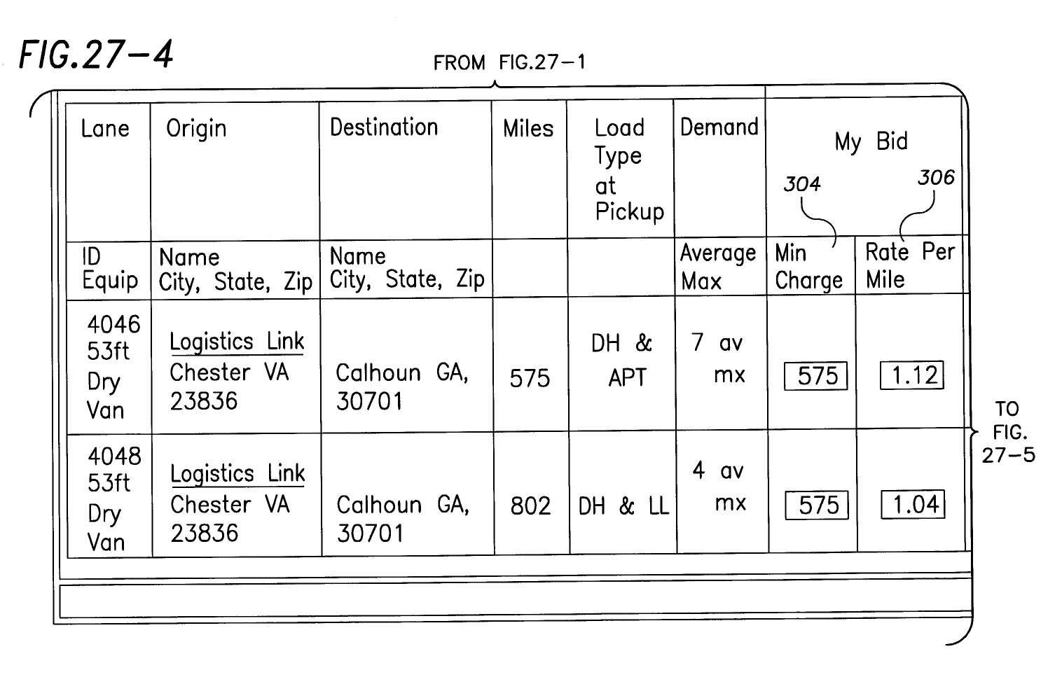

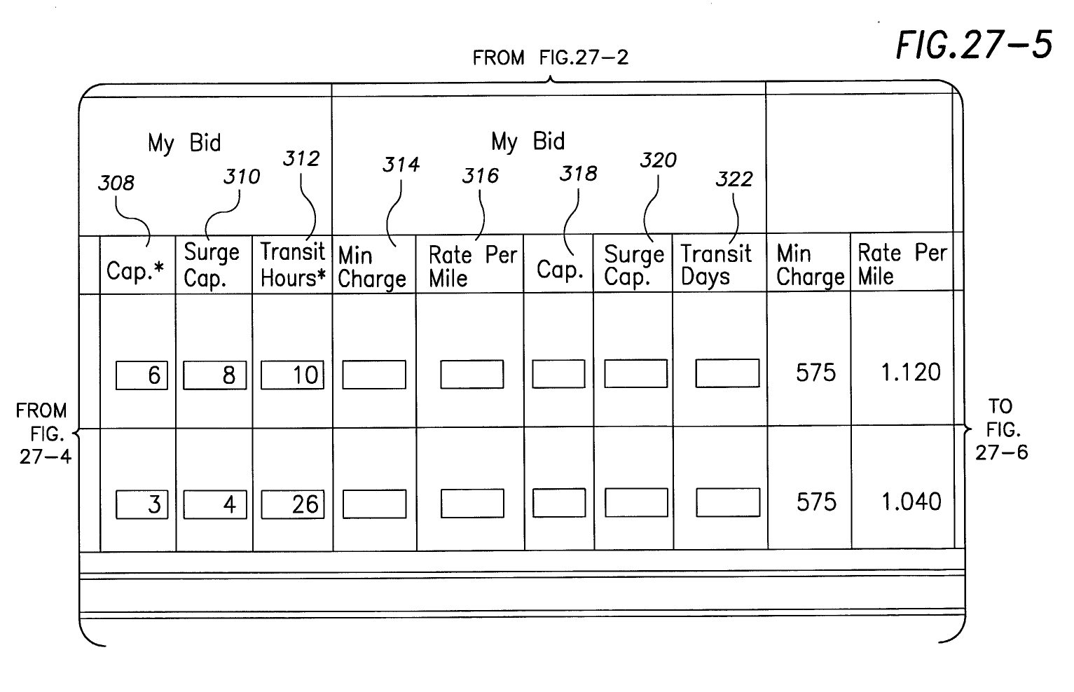

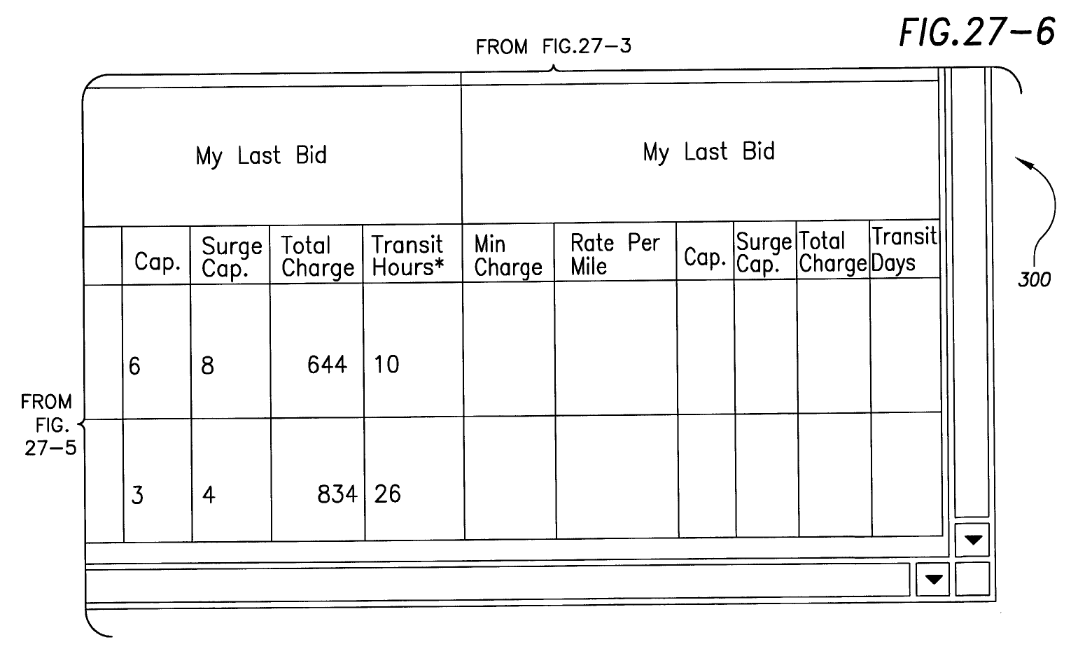

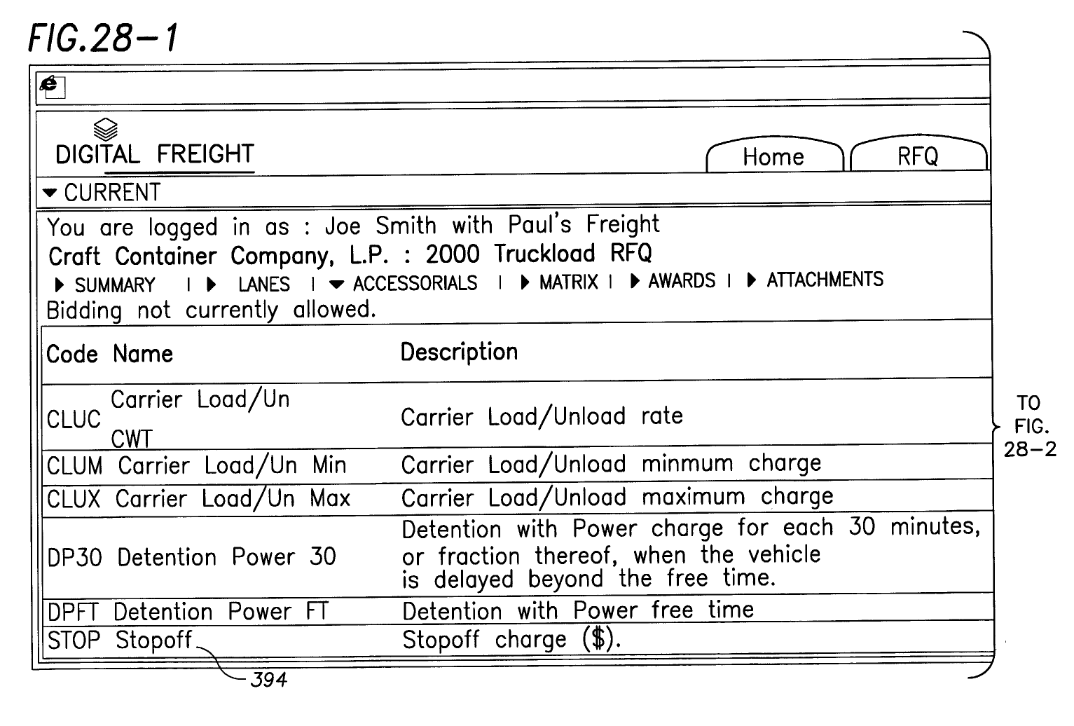

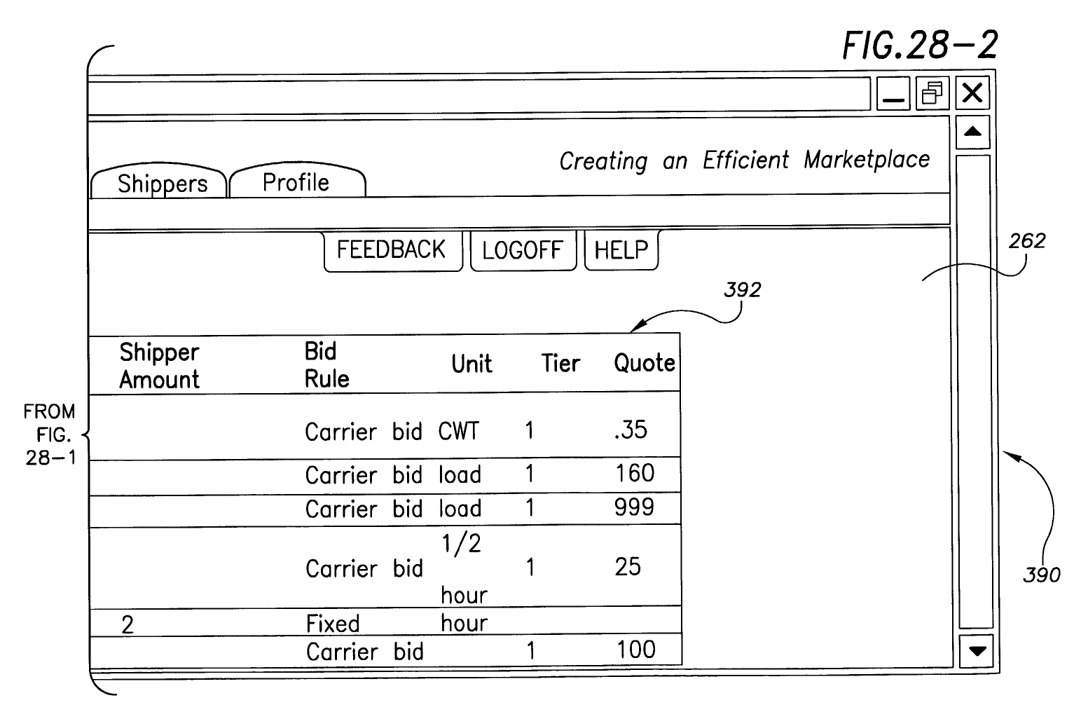

Associated with each of the RFQs that are displayed in the right pane 262b of the central display window 262 is a pair of hyperlinks labeled “Lanes” (generally indicated by reference numeral 276) and “Accessorials” (generally indicated by reference numeral 278). Selection of the “Lanes” hyperlink 276 re-directs the carrier to a RFQ LANES SCREEN 300 associated with the RFQ, an example of which is depicted in FIG. 27 and described below. Selection of the “Accessorials” hyperlink re-directs the carrier to an RFQ ACCESSORIALS SCREEN 390 associated with the RFQ, an example of which is depicted in FIG. 28 and described below.

Also, as a further refinement, icons (generally indicated by reference number 279) appearing to the left of each RFQ displayed in the right pane 262b of the central display window 262 in FIG. 24 provide an immediate indication of the status of the carrier with respect to a particular RFQ, i.e., whether (1) the carrier is inactive; (2) the carrier has been approved for participation in the RFQ, (3) approval is pending for participation in the RFQ, or (4) the carrier has been denied participation in the RFQ.

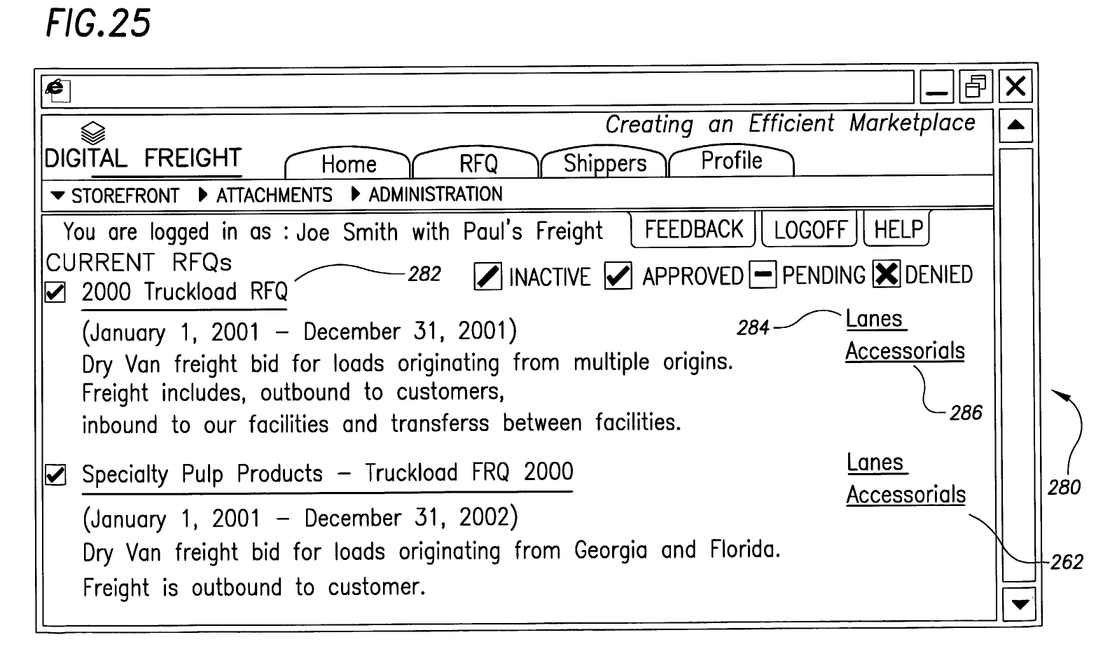

FIG. 25 depicts a preferred RFQ SCREEN 280 in the preferred embodiment described herein, a screen that is accessed through the selection of the RFQ tab 264b of a carrier screen. Displayed in the central display window 262 of the RFQ SCREEN 280 is a listing of the current (and previous) RFQs for which bids are being sought and submitted (or have been sought and submitted). With respect to each RFQ, the carrier has a variety of options.

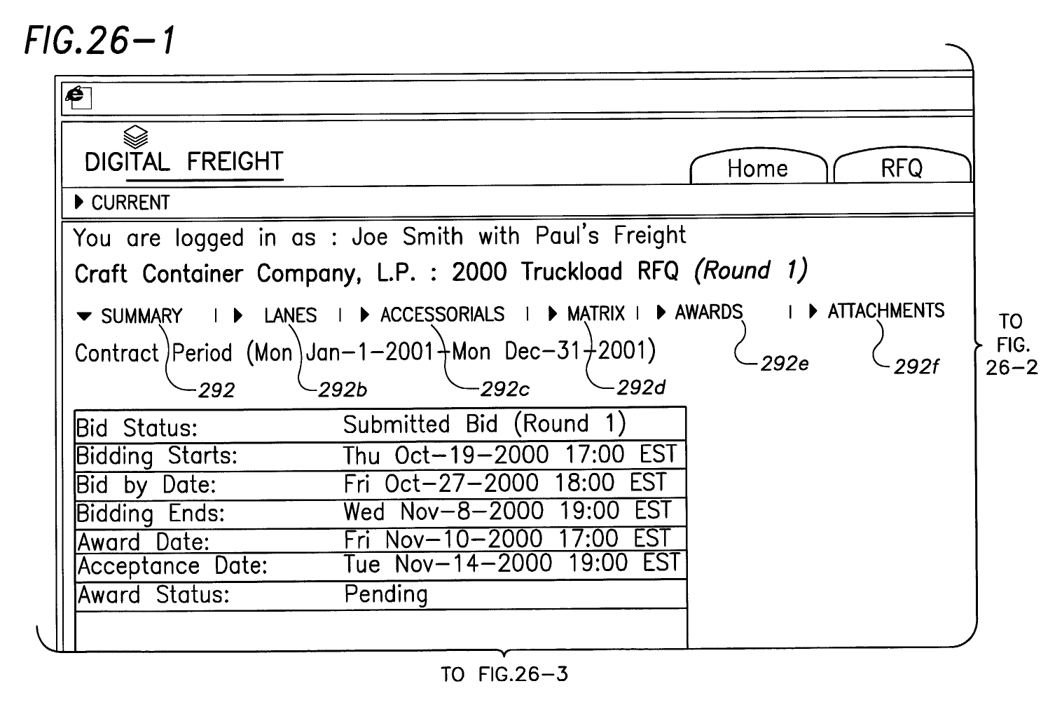

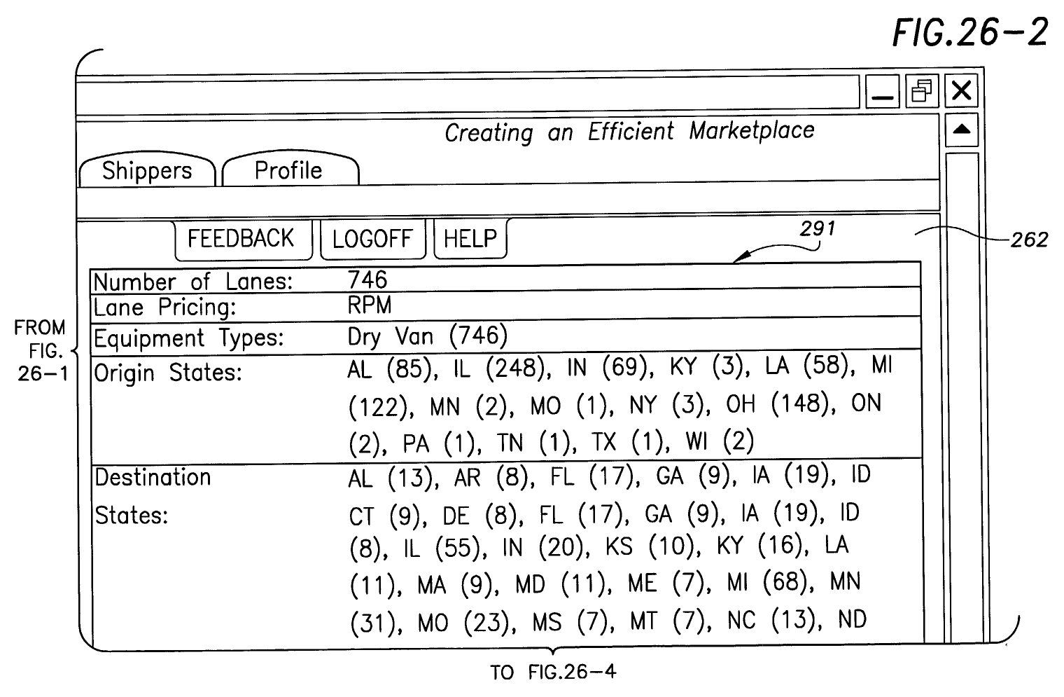

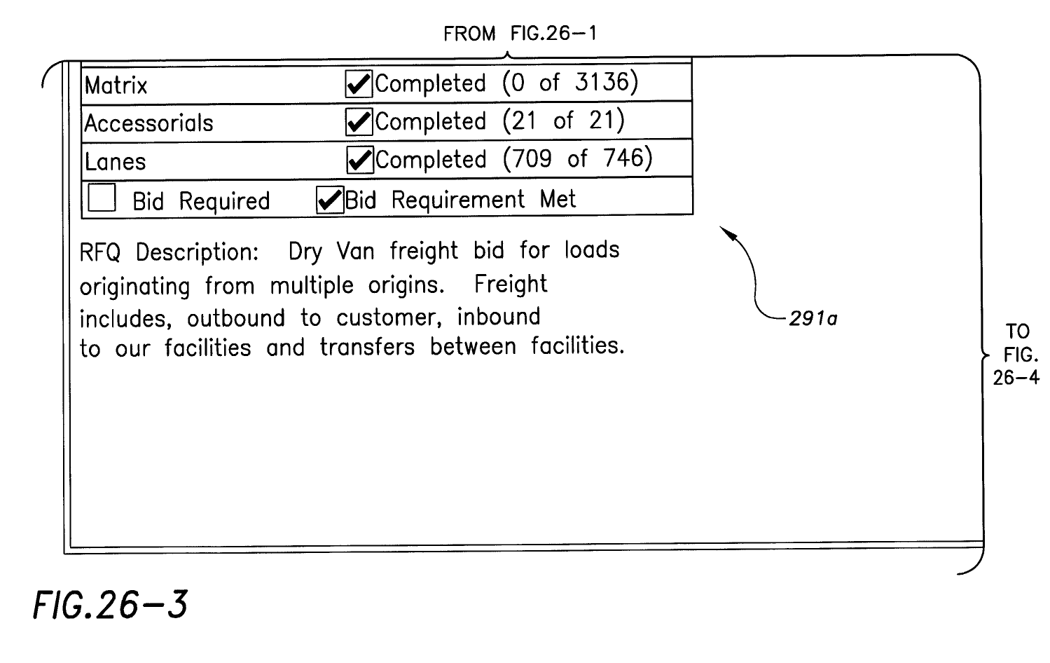

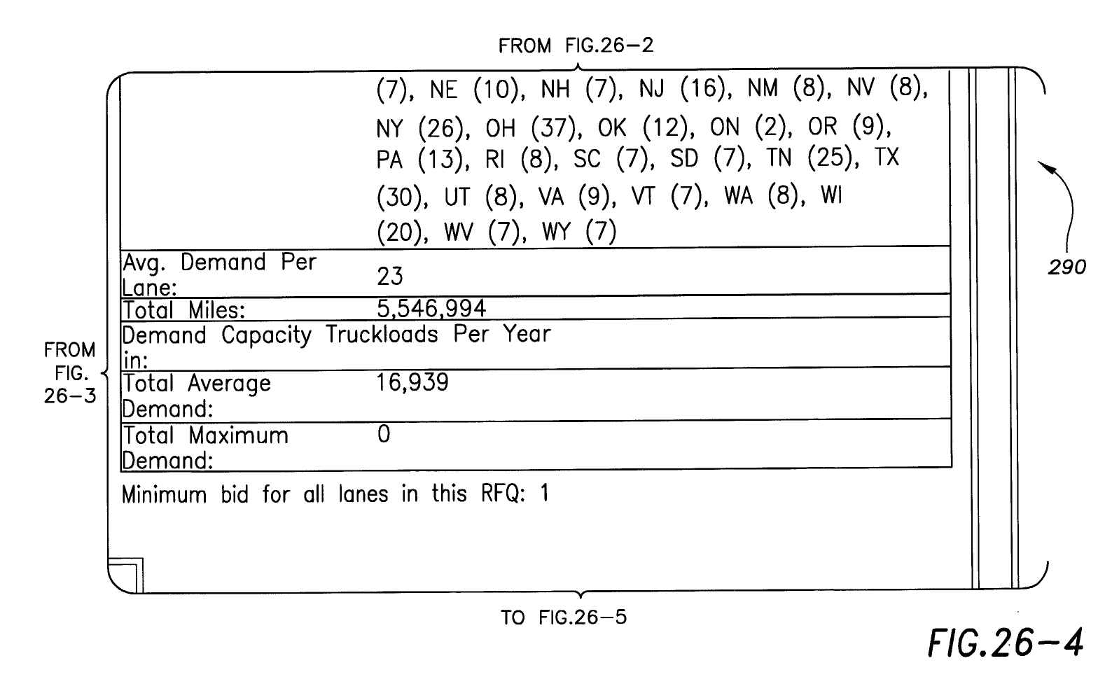

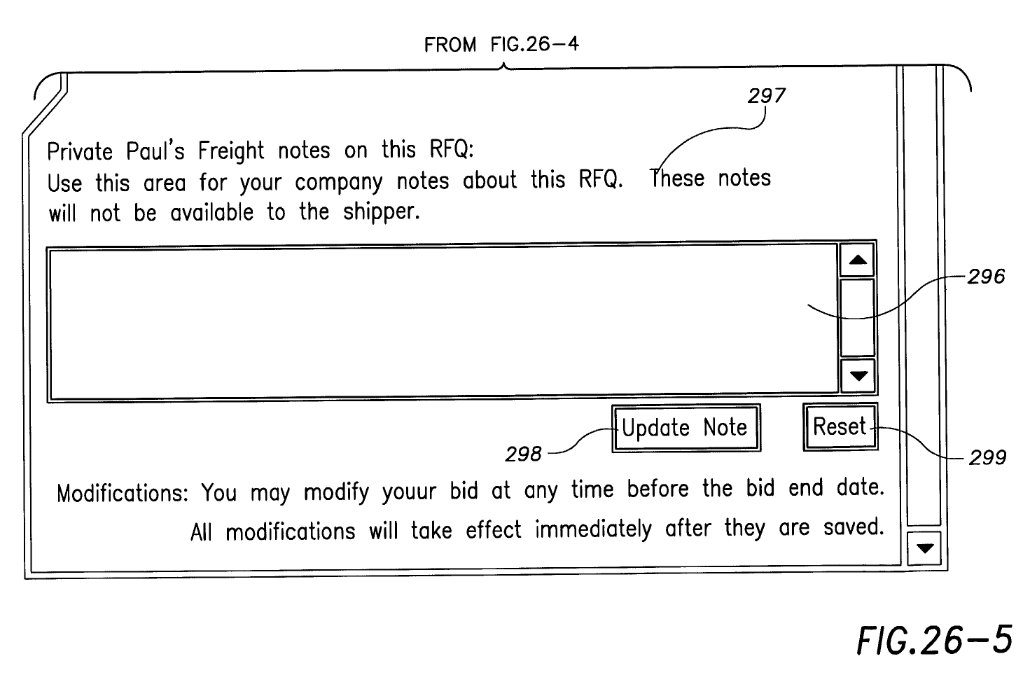

For example, by selecting the “2000 Truckload RFQ” hyperlink 282 in the central display window 262 of the RFQ SCREEN 280, the user is re-directed to a RFQ SUMMARY SCREEN 290, an example of which is depicted in FIG. 26.

Alternatively, as with the MAIN SHIPPER SCREEN 260 of FIG. 24, associated with each of the RFQs that are displayed in the right pane 262b of the central display window 262 of the RFQ SCREEN 280 of FIG. 25 is a pair of hyperlinks labeled “Lanes” (generally indicated by reference numeral 284) and “Accessorials” (generally indicated by reference numeral 286). Selection of the “Lanes” hyperlink 284 re-directs the shipper to a RFQ LANES SCREEN 300 associated with the RFQ, an example of which is depicted in FIG. 27 and described below. Selection of the “Accessorials” hyperlink 286 re-directs the shipper to an RFQ ACCESSORIALS SCREEN 390 associated with the RFQ, an example of which is depicted in FIG. 28 and described below.

Returning now to the RFQ SUMMARY SCREEN 290 of FIG. 26, displayed in the central display window 262 is a table 291 providing a detailed summary of the selected RFQ. In the particular embodiment shown in FIG. 26, the following information is displayed in the table 291:

TABLE I

Bid Status
Bidding Starts
Bid by Date
Bidding Ends
Award Date
Acceptance Date
Award Status
Matrix (Status)
Accessorials (Status)
Lanes (Status)
REQ Description
Number of Lanes
Lane Pricing
Equipment Types
Origin States
Destination States
Average Demand Per Lane
Demand/Capacity in
Total Average Demand
Total Maximum Demand

Most of the above terminology and import of the associated information should be well known to one of ordinary skill in the art in the shipping and transportation industry. Indeed, most of the information displayed in the table 291 simply informs the carrier of the details of the RFQ and the critical dates in the bidding and negotiation process. Of particular note, however, a portion of the table which is generally indicated by referenced numeral 291a provides “status” information. Specifically, this portion of the table 291a informs the carrier of its progress in submitting bids.

In the example of FIG. 26, the carrier has completed none of the 3136 cells of the FAK matrix. However, as indicated by icon, the carrier has met the requisite bid requirement with respect to the FAK matrix for participation in the RFQ. Similarly, the carrier has completed 21 of the 21 open accessorial bids, thus meeting the requisite bid requirement. In this regard, in most circumstances, the carrier would be required to complete all accessorial bids for lanes on which it is bidding so that the shipper can have a complete understanding of the charges levied by the carriers for its transportation services. Finally, the carrier has bid on 709 of the 746 open lanes bids, again meeting the requisite bid requirement.

It is important to note that the displayed data as described above is but a preferred selection and layout of data, which could be modified, added to, or rearranged without departing from the spirit and scope of the present invention.

As a further refinement, in the lower portion of the central display window 262 of the RFQ SUMMARY SCREEN 290 of FIG. 26, below the table 291, there is a notes field 297 which displays notes that the carrier has made with respect to the RFQ, notes that can only be viewed by users with appropriate permissions. Associated with this notes field 297 is a data entry box 296 in which additional notes may be entered. After entering appropriate notes in the data entry box 296, selection of the “Update Note” button 298 adds the note and stores it in the integral database for subsequent access and viewing by the carrier. Should the carrier wish to discard a note, selection of the “Reset” button 299 clears data entered into the data entry box 296.

Referring still to the RFQ SUMMARY SCREEN 290 of FIG. 26, the carrier can select various options to view details related to the selected “2000 Truckload RFQ.” In this regard, as shown in FIG. 26, it is preferred that there be a series of hyperlink selections 292 in the upper portion of the central display window 262, this series of hyperlinks 292 appearing in the central display window 262 of each screen related to a particular RFQ.

Lastly, in the example of FIG. 26, bidding has ended. If bidding were still open, in the central display window 262 of the RFQ SUMMARY SCREEN 290, there would be a button labeled “Send Bids to Shipper” which would release (or “submit”) all carrier bids, allowing the shipper to view and consider these bids. Additionally, these bids would then be considered in the aggregate bid computations on each lane, such as the number of bids; and lowest, average, and maximum price per load.

By selecting the “Lanes” hyperlink 292b,the carrier is re-directed to the RFQ LANES SCREEN 300, an example of which is depicted in FIG. 27. In the central display window 262 of the RFQ LANES SCREEN 300 is a table 302 of detailed information about each lane included in the RFQ. In the particular embodiment shown in FIG. 27, for purposes of simplicity and clarity, there are only two lanes displayed for the RFQ, and the associated data columns are labeled as follows:

TABLE J
Lane Information

| | | | | | |
|---|---|---|---|---|---|
| Lane | Origin | Destination | Miles | Load Type | Demand |
| Id; Equip | Name; City, State, Zip | Name; City, State, Zip | | | Average; Max |

| OTR | | | | |
|---|---|---|---|---|
| My Bid | | | | |
| Min Charge | Rate Per Mile | Cap. | Surge Cap. | Transit Hours |
| IM | | | | |
| My Bid | | | | |
| Min Charge | Rate Per Mile | Cap. | Surge Cap. | Transit Days |

| OTR | | | | | |
|---|---|---|---|---|---|
| My Last Bid | | | | | |
| Min Charge | Rate Per Mile | Cap. | Surge Cap. | Total Charge | Transit Hours |
| IM | | | | | |
| My Last Bid | | | | | |
| Min Charge | Rate Per Mile | Cap. | Surge Cap. | Total Charge | Transit Days |

The table 302 of the RFQ LANES SCREEN 300 not only displays information related to the selected RFQ, but allows for bidding on the lanes associated with the RFQ.

Similar to the RFQ LANES SCREEN 80, as described with respect to shipper navigation and depicted in FIG. 7, the six data columns which are categorized under the “Lane Information” umbrella in the RFQ LANES SCREEN 300 of FIG. 27 are largely self-explanatory, i.e. Lane, Origin, Destination, Miles, Load Type at Pickup, and Demand.

The next five data columns are categorized under the “OTR” and “My Bid” umbrella, and contained in the respective data columns are data entry fields that allow a carrier to submit a bid. Specifically, the first data entry field 304 is labeled “Min Charge.” In this data entry field 304, the carrier enters the minimum charge it is willing to accept for transportation over the particular lane. The second data entry field 306 is labeled “Rate Per Mile.” In this data entry field 306, the carrier enters the rate per mile it is willing to accept for transportation over the particular lane. The third data entry field 308 is labeled “Cap.” In this data entry field 308, the carrier enters its capacity, i.e., the volume of truckloads the carrier can accommodate for the specified lane during a designated period of time. In this regard, for purposes of this example, capacity and demand are represented in units of truckloads per week. The fourth data entry field 310 is labeled “Surge Cap.” In this data entry field 310, the carrier enters its surge capacity, i.e., the additional capacity that it can accommodate for the specified lane in excess of its contractual capacity during a specified period of time. Lastly, the fifth data entry field 312 is labeled “Transit Hours.” In this data entry field 312, the carrier enters the number of hours it estimates will be needed for transportation of a load in the particular lane.

It is important to note that, in this description of the preferred embodiment, all bidding has been conducted using rate-per-mile (“RPM”) as a bidding unit. Of course, other bidding units could be used without departing from the spirit and scope of the present invention. For example, bidding could be conducted on a per-weight basis or on a flat fee basis.

Returning to the table 302 of the LANES SCREEN 300, the next five data columns are categorized under the “IM” and “My Bid” umbrella, and again contained in the respective data columns are data entry fields that allow a carrier to submit a bid. The same data entry fields are displayed with respect to IM transportation as are displayed with respect to OTR transportation, specifically: “Min Charge” 314, “Rate Per Mile” 316, “Cap.” 318, “Surge Cap.” 320 and “Transit Days” 322.

It should be noted that the shipper may optionally designate other fields of information to be associated with each lane and displayed as additional columns of data. These “meta-data” driven fields may be arbitrarily populated by the shipper on an RFQ-by-RFQ basis.

After a carrier has entered the appropriate information in the data entry fields, submission of the bid requires the carrier to select the “Save Bids” button 324 which causes the bid data to be maintained and stored in the integral database.

As mentioned above with respect to the RFQ LANES SCREEN 80 of FIG. 7, in the event that an RFQ is comprised of an extraordinarily large number of lanes, the lane data displayed in the RFQ LANES SCREEN 300 of FIG. 27 can be subdivided into viewable sets of lane data with repeating headers visible as the user scrolls through the data. Also, the data may be spread across multiple screens or web pages to facilitate navigation and viewing.

As also mentioned above with respect to the RFQ LANES SCREEN 80 of FIG. 7, if there are a great number of lanes included in an RFQ displayed in the table, it would be useful to also provide a filtering mechanism to view particular lanes. In this regard, included in the central display window 262 of the RFQ LANES SCREEN 300 of FIG. 27 is a pull-down menu 328 that allows a user to select from its custom list of saved filters. Upon selection of the appropriate filter, the table 302 is refreshed and re-displayed in the central display window 262 in accordance with the filter parameters.

Furthermore, selection of the “Create/Modify Filter” hyperlink 326 displayed in the upper portion of the central display window 262 re-directs the shipper to a screen (not shown) where filters can be created and modified in the same manner as described with respect to shipper navigation and the RFQ FILTERS SCREEN 90 of FIG. 8.

As a further refinement, to assist the carrier in formulating and submitting its bids, the remaining data columns in the table 302 displayed in the central display window 262 provide information about the last bid the carrier submitted with respect to a particular lane. The information displayed in these data columns is the data that was previously submitted though the data entry fields described above with one exception—there is an additional data column labeled “Total Charge” which is the greater of (1) the product of the RPM multiplied by the number of miles and (2) the minimum charge. Again, a minimum charge be specified by a carrier for the entire RFQ or on a lane-by-lane basis.

Returning to the RFQ SUMMARY SCREEN 290 of FIG. 26, by selecting the “Accessorials” hyperlink 292c in the central display window 262, the carrier is re-directed to an RFQ ACCESSORIALS SCREEN 390, an example of which is depicted in FIG. 28.

As discussed above with reference to shipper navigation, an “accessorial” is typically a charge by a carrier for an additional service or fee in connection with the transportation of goods for a specified lane, e.g., refrigeration, stopoffs in transit, and detention. “Accessorial” may also refer to a standard contractual term, other that a monetary charge, associated with the transportation of goods. A shipper preferably defines the accessorials when establishing an RFQ, and then either opens bidding with respect to these accessorials or sets a fixed price that it is willing to pay for the additional fee or service.

In the example of FIG. 28, in the central display window 262 of the RFQ ACCESSORIALS SCREEN 390, there is a table 392 that provides the following information about bidding on the accessorials involved in the RFQ:

TABLE K

| | | | |
|---|---|---|---|
| Code | Name | Description | Shipper Amount |
| Bid Rule | Unit | Tier | Quote |

As with the ACCESSORIAL SCREEN 120 of FIG. 10, the “Code” and “Name” data columns provide a short-form means for identifying a particular accessorial. The “Description” data column provides more detailed information about the nature of the accessorial. If the shipper has assigned a fixed charge for the accessorial, that charge appears in the “Shipper Amount” data column, and the designation “Fixed” appears in the “Bid Rule” data column. If the shipper allows open bidding on the accessorial, the designation “Carrier bid” appears in the “Bid Rule” data column. The next data column is labeled “Units” and indicates the units in which the accessorial is measured, e.g., hours, loads, or events.

The final two data columns—labeled “Tier” and “Quote”—provide specific information about the carrier's bids or “quotes” that have been submitted with respect to the various accessorials listed in the table 392. For example, with respect to the last accessorial appearing in the table 394 of FIG. 28—“Stopoff”—the numeral “1” appears in the “Tier” data column and the numeral “100” appears in the “Quote” data column. Therefore, this carrier has submitted a quote indicating that the shipper will be charged $100 for a stopoff, at least at the tier “1” level. If a second tier level was involved—tier “2”—the shipper would be charged a different amount for the second stopoff, e.g. $50 or $150. In other words, in this preferred embodiment, it is contemplated that the carrier can submit tiered bids or quotes for all the various accessorials. As mentioned above, since the accessorials are inextricably linked to one or more lanes of the RFQ, there is no separate negotiation process with respect to accessorials. Rather, the charges a carrier levies for accessorials constitutes another consideration which the shipper must take into account when awarding bids. For instance, in some circumstances, although the charge reflected in the lanes bidding might be lower for Carrier A than Carrier B, when accessorials are taken into account, Carrier A might actually charge more than Carrier B.

Lastly, with respect to the exemplary RFQ ACCESSORIALS SCREEN 390 of FIG. 28, no new bids or quote are being accepted. If bidding was still open, data entry fields would appear in the appropriate data columns allowing the carrier to submit bids or quotes on each accessorial.

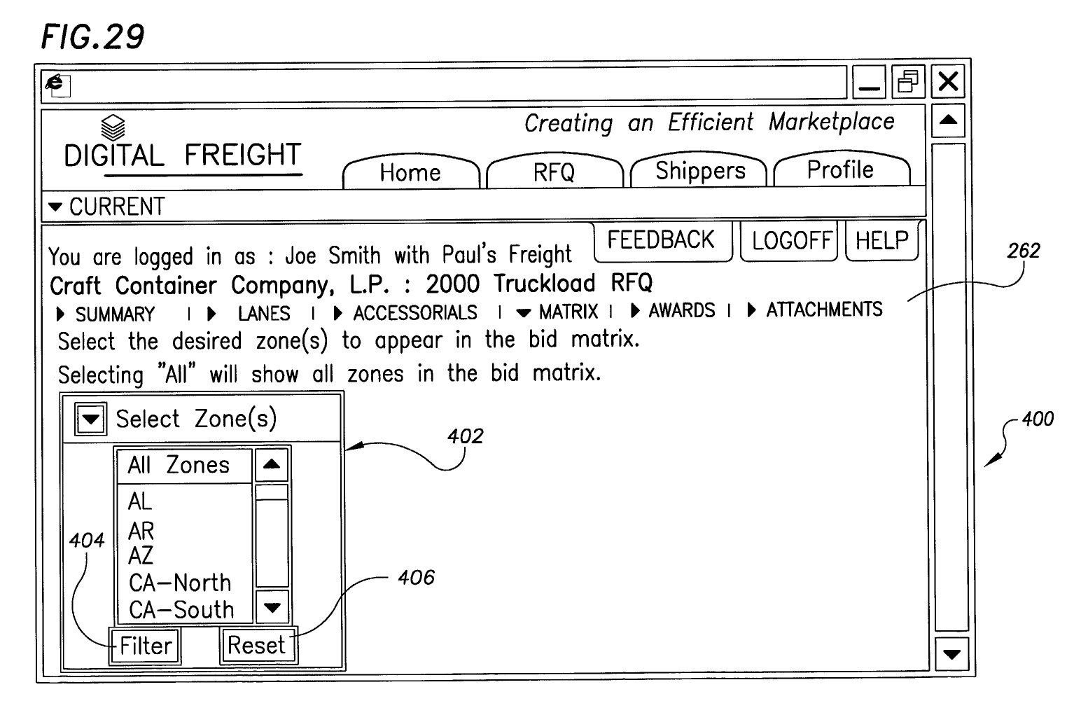

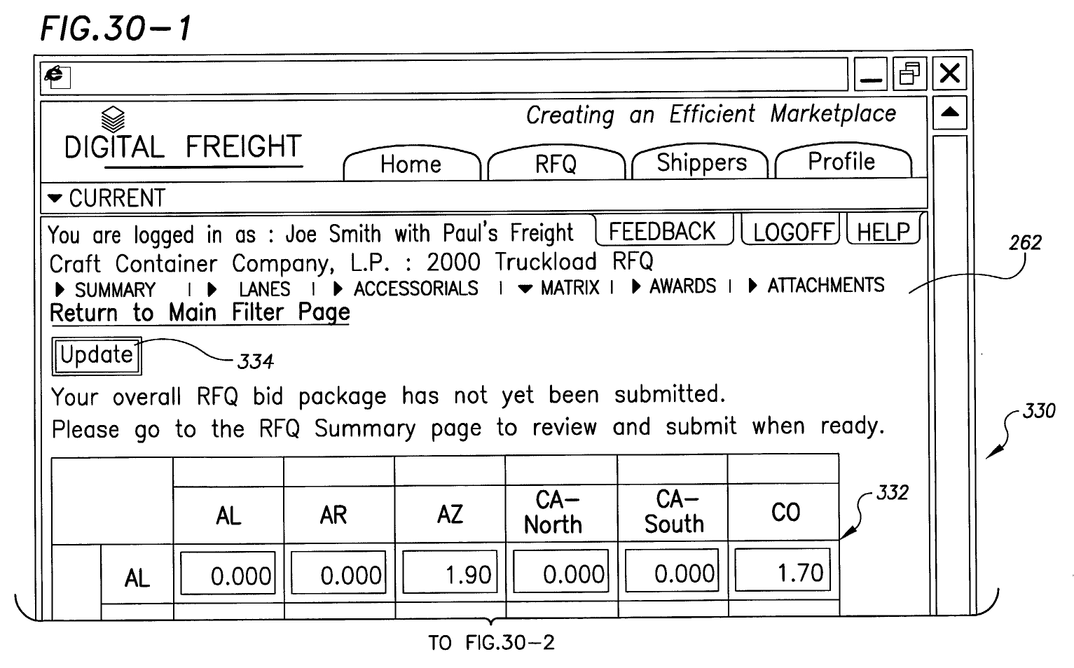

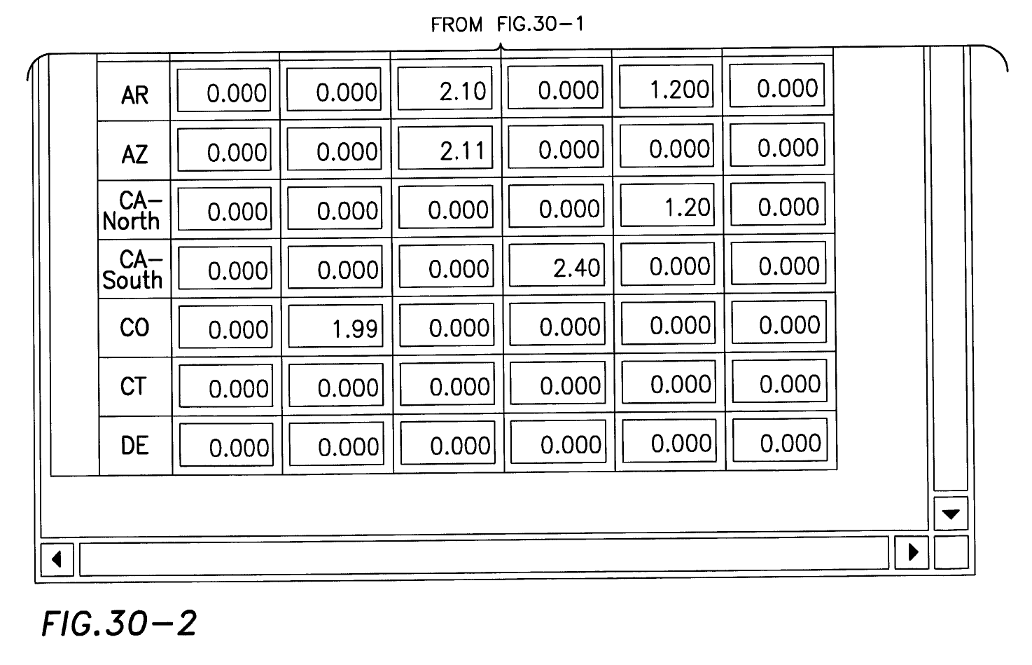

Returning to the RFQ SUMMARY SCREEN 290 of FIG. 26, by selecting the “Matrix” hyperlink 292d in the central display window 262, the carrier is re-directed to a RFQ MATRIX FILTER SCREEN 400, an example of which is depicted in FIG. 29. In the central display window 262 of the RFQ MATRIX FILTER SCREEN 400, there is a pull-down menu 402 that allows the carrier to pick the desired matrices to display. Once the appropriate selections have been made, selection of the “Filter” button 404 re-directs the user to a RFQ MATRIX SCREEN 330, an example of which is depicted in FIG. 30, displaying matrices in accordance the carrier's filtering criteria. For the convenience of the carrier, in the central display window 262 of the RFQ MATRIX FILTER SCREEN 400, there is also a “Reset” button 406 that clears selections made in the pull-down menu 402.

Referring now to the RFQ MATRIX SCREEN 330 of FIG. 30, in the central display window 262 of the RFQ MATRIX SCREEN 330, there are one or more matrices which display the carrier's rate-per-mile bids submitted by zone. For purposes of example, a single matrix (generally indicated by reference numeral 332) is displayed in the central display window 262 of the RFQ MATRIX SCREEN 330 of FIG. 30.

As with RFQ MATRIX SCREEN 130 of FIG. 11, state or regional codes are used to identify both the rows (origin) and the columns (destination) that comprise the matrix 332. By referring to the appropriate cell in the matrix 332, a carrier can enter its bid (rate-per-mile) for a particular transportation zone. In this regard, each cell of the matrix 332 contains an appropriate data entry field. Once the carrier has submitted such bids, selection of UPDATE button 334 causes the bid data to be maintained and stored in the integral database.

As mentioned above, matrix bidding does not directly affect lane bidding but is an important feature of the present invention as it allows carriers participating in an RFQ to submit rate-per-mile bids for particular transportation zones other than those defined by the lanes.

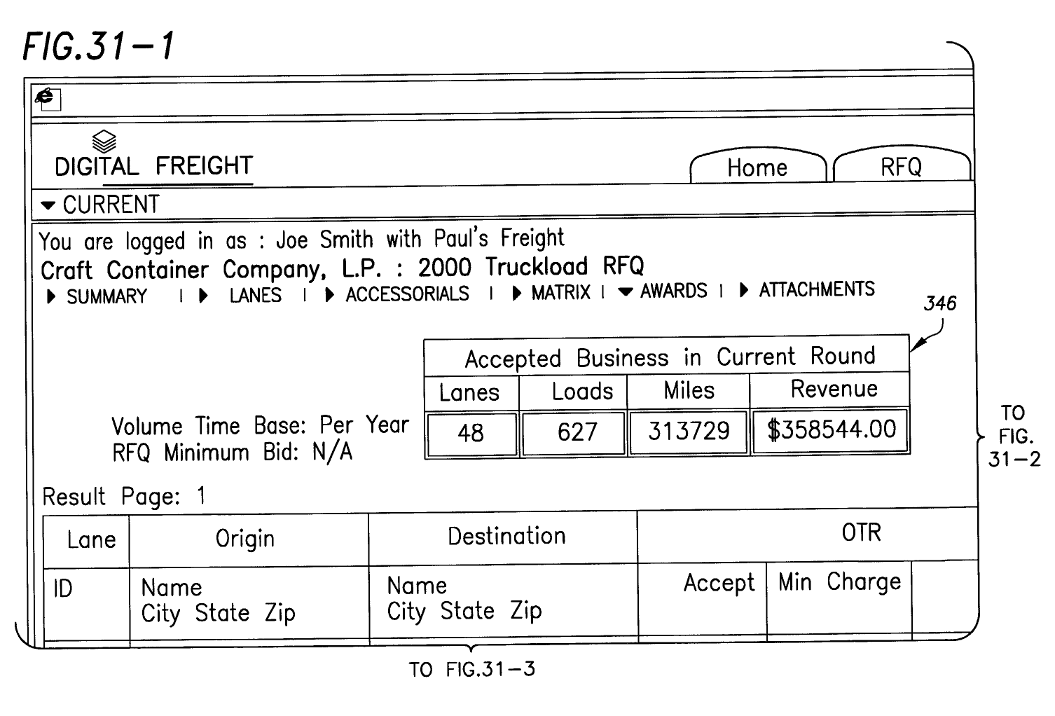

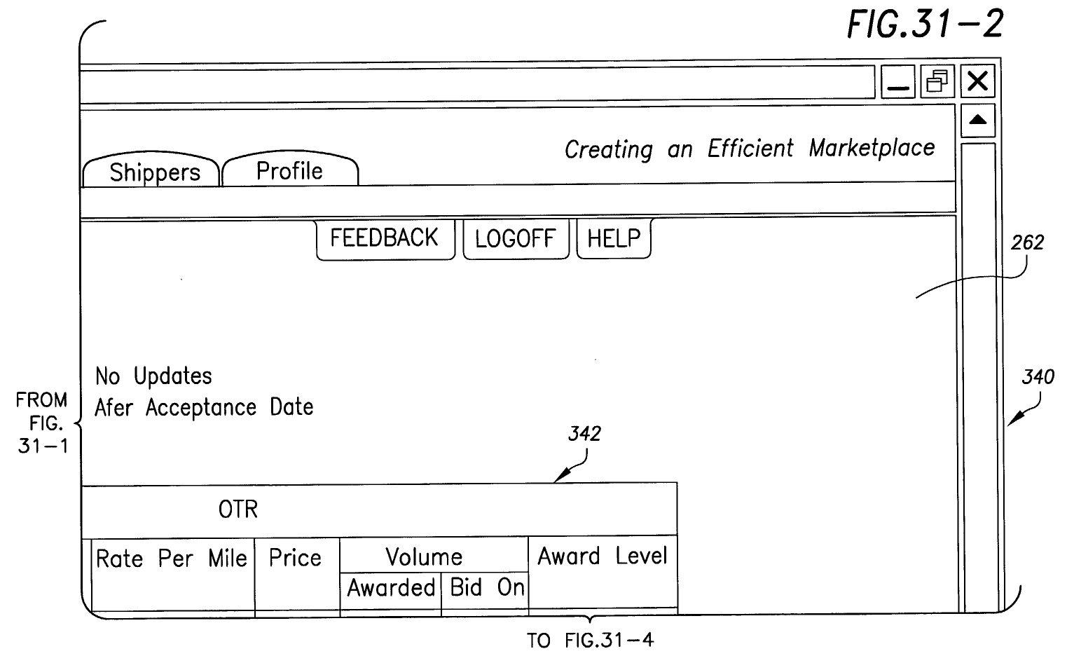

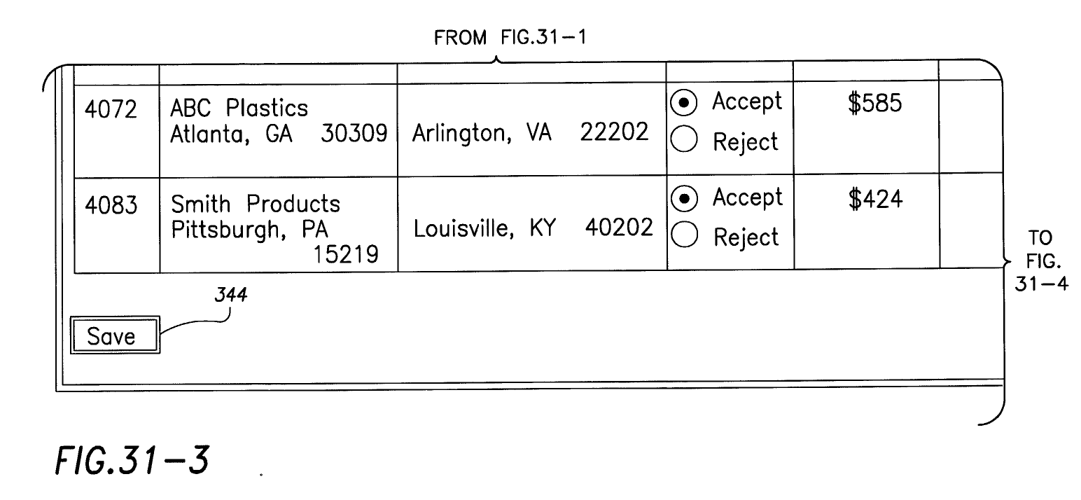

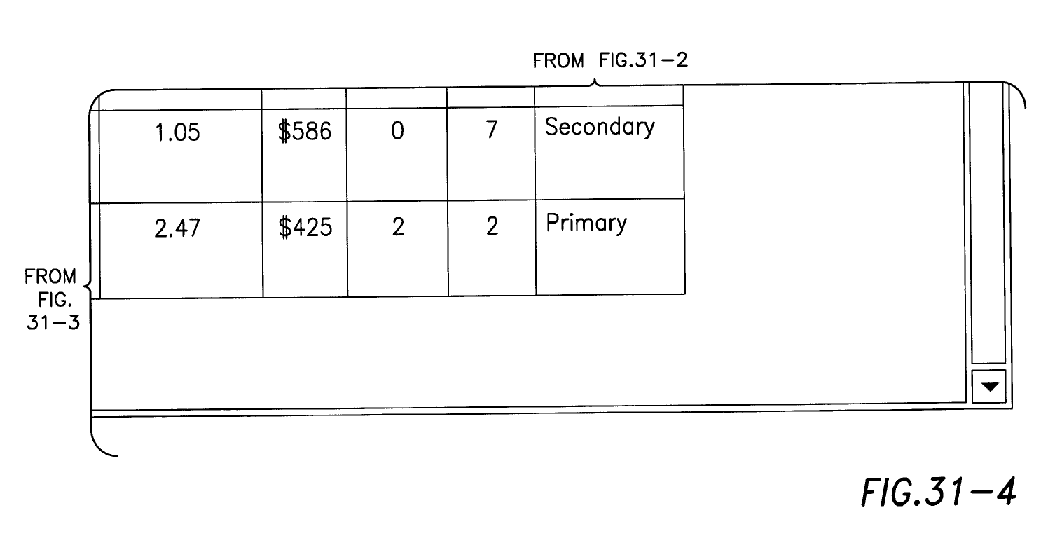

Returning to the RFQ SUMMARY SCREEN 290 of FIG. 26, by selecting the “Awards” hyperlink 292e in the central display window 262, the carrier is re-directed to an AWARDS DETAIL SCREEN 340, an example of which is depicted in FIG. 31. Most prominently, included in the central display window 262 of the AWARDS DETAIL SCREEN 340 is table 342 that provides detailed information about awards the carrier has been offered by the shipper in a particular RFQ. In the particular embodiment shown in FIG. 31, for purposes of simplicity and clarity, only OTR awards have been made, and there are only two lanes displayed. The following information is displayed in table 342 with respect to each lane:

TABLE L

| | | |
|---|---|---|
| Lane | Origin | Destination |
| ID | Name; City, State, Zip | Name; City, State, Zip |

OTR

| Accept | Min Charge | Rate Per | Price | Volume | | Award |
|---|---|---|---|---|---|---|
| | | Mile | | Awarded | Bid On | Level |

The first three data columns—“Lane,”“Origin,” and “Destination”—identify the particular lane for which an award has been made. The next data column is labeled “Award” and allows a carrier to accept or reject an award, as will be further described below. The next three data columns—“Min Charge,” “Rate Per Mile,” and “Price”—provide information about the bid that was accepted by the shipper leading to the award. The next two data columns are under the “Volume” umbrella and are labeled “Awarded” and “Bid On.” As the labels suggest, the information in these two data columns indicate the number of loads awarded to a carrier and the number of loads which the carrier bid on with respect to a particular lane. Lastly, the final data column is labeled “Award Level” and identifies the level of award that has been made, such a “primary” or “secondary.”

Returning to the “Accept” data column of the table 342, located in this data column with respect to each lane are two check boxes or bubbles respectively labeled “Accept” and “Reject.” The carrier fills in the appropriate check box or bubble for each lane and then clicks on the “Save” button 344 located in the lower portion of the central display window 262. The rejection or acceptance of each award is stored and maintained in the integral database when the carrier selects the “Publish Acceptance” button—a button appearing in the central display window 262 of the RFQ SUMMARY SCREEN 290 of FIG. 26 only during the awards acceptance time period. The rejections and acceptances are then open to viewing by the shipper sponsoring the RFQ. Provided the carrier accepts one or more awards, the shipper would then typically finalize the negotiation by tendering a written contract for all lanes accepted by the carrier.

As an additional refinement, a second summary table 346 is located in the upper portion of the central display window 262 of the AWARDS DETAIL SCREEN 340. Displayed in this table 346 is summary information regarding accepted awards in the current round of bidding, including (1) the number of lanes that have been awarded and accepted, (2) the number of loads that have been awarded and accepted, (3) the number of miles represented by the accepted loads, and (4) the monetary value of all awarded and accepted bids.

Finally, with respect to the tables 342, 346 displayed in the central display window 262 of the AWARDS DETAIL SCREEN 340, the tables 342, 346 are but examples of preferred selections and layouts of data. It is contemplated and preferred that the user can customize the selection and layout of the data to meets its individual needs.

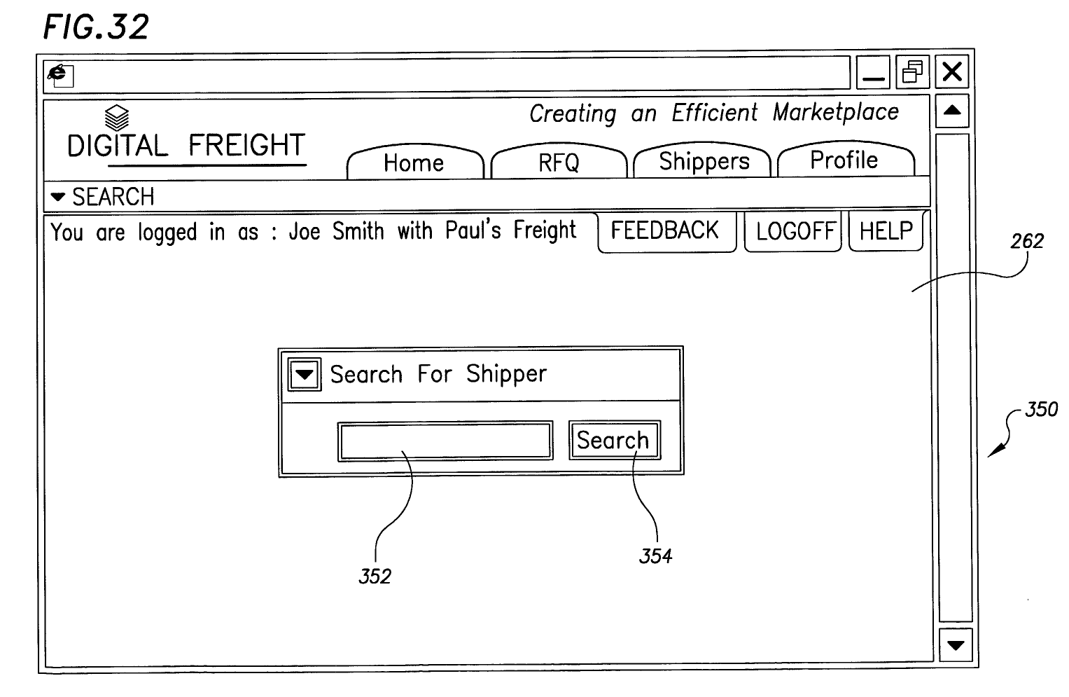

FIGS. 24-31 thus demonstrate the general navigation through the preferred method and system from the perspective of a carrier seeking to submit bids and/or to review awards. FIGS. 32-35 are also associated with carrier navigation, but are supplemental in nature and thus are not shown in FIG. 23.

Returning to the RFQ SUMMARY SCREEN 290 of FIG. 26, by selecting the “Attachments” hyperlink 292f in the central display window 262, the user is re-directed to a screen (not shown) displaying hyperlinks to current attachments as submitted and posted by the shipper sponsoring the RFQ.

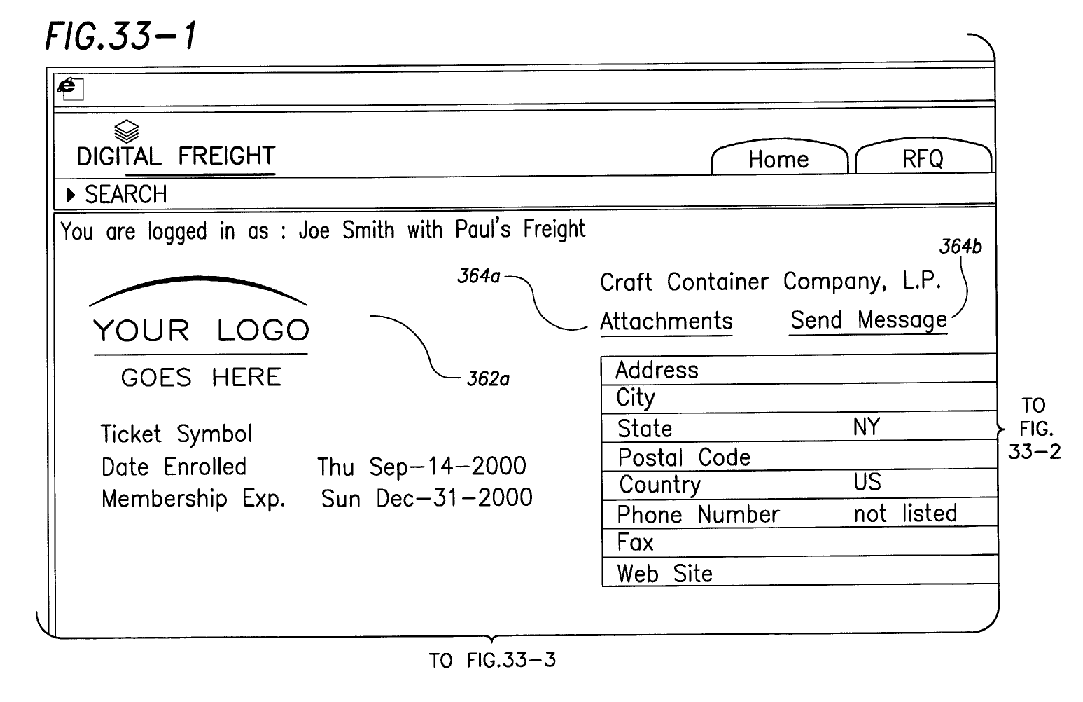

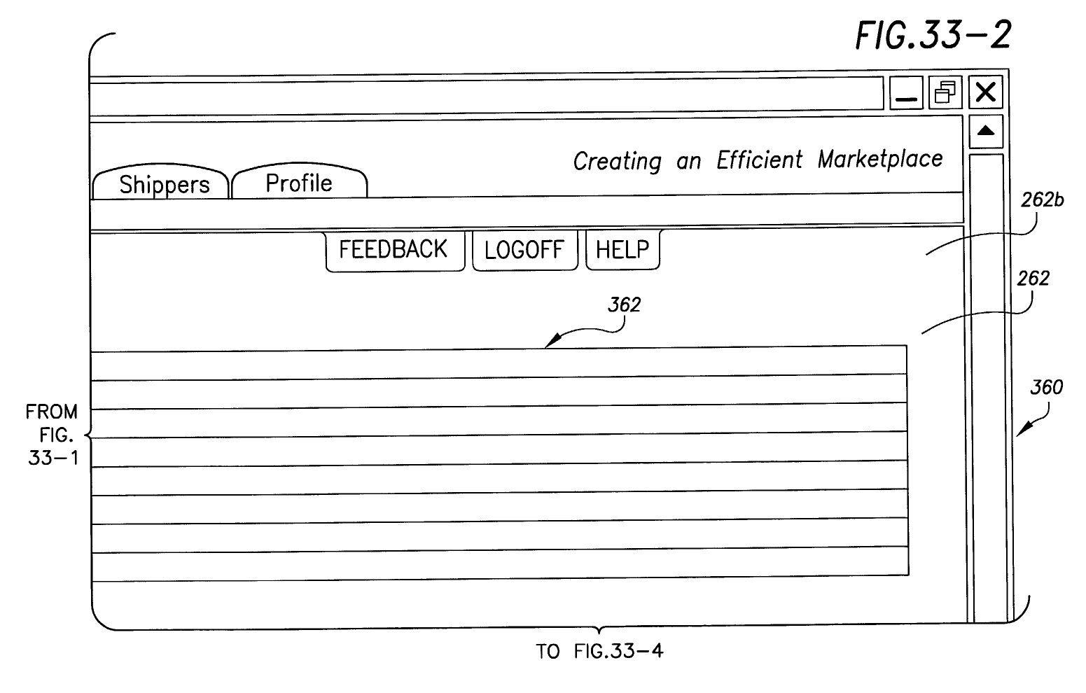

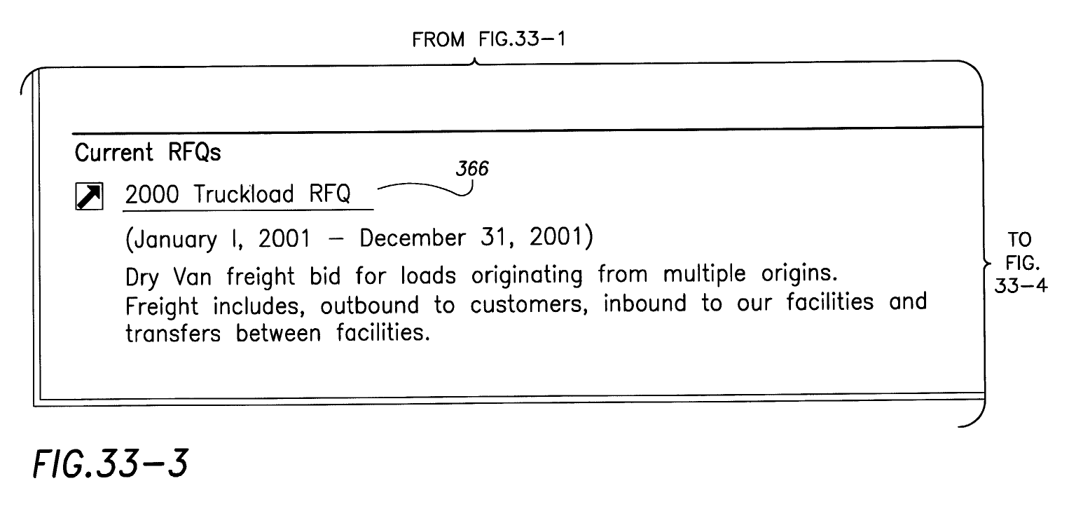

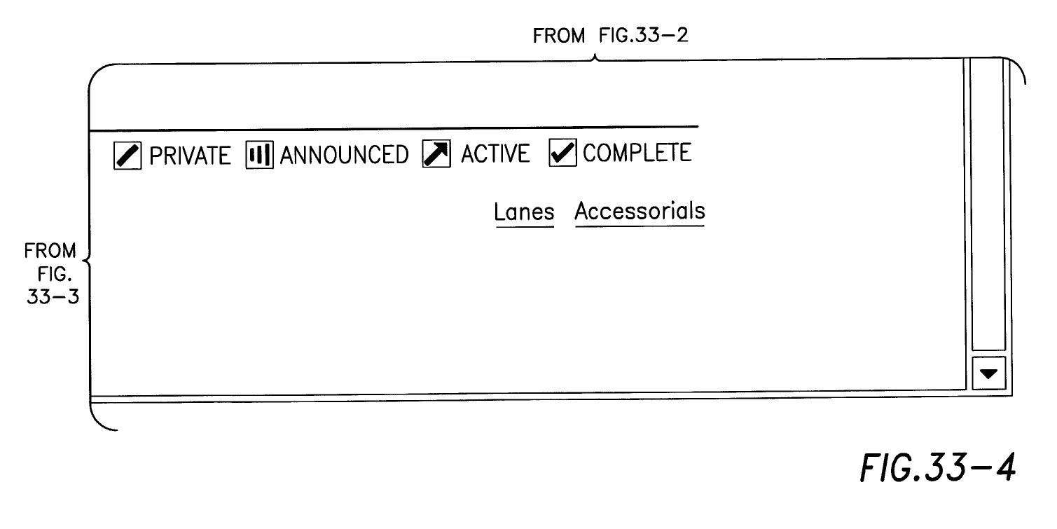

FIG. 32 is a sample SHIPPERS SEARCH SCREEN 350, which is accessed through the selection of the SHIPPERS tab 264c from a carrier screen. In the central display window 262 of the SHIPPERS SEARCH SCREEN 350 is a data entry field 352 labeled “Search for Shipper” and associated “Search” button 354. By entering the appropriate text string in the data entry field 352 and then selecting the “Search” button 354, the appropriate shipper is identified in the integral database, and the carrier is re-directed to a SHIPPER STOREFRONT SCREEN 360, an example of which is depicted in FIG. 33. In this regard, if the data entry field 352 is left blank, or if there are multiple matches to the entered text string, the carrier will be re-directed to a list of shippers from which an appropriate selection can be made.

Referring now to the SHIPPER STOREFRONT SCREEN 360 of FIG. 33, various information and hyperlinks can be displayed in the central display window 262. In this particular example, in a left pane 262a of the central display window 262, there is an image field for the inclusion of a company logo, and information about the “Date Enrolled” with the system information about the “Date Enrolled” with the system and associated “Membership Exp[iration]” date. Secondly, and more prominently, in the right pane 262b of the central display window 262, there is a table 362 providing identifying information about the selected shipper, including address, city, state, postal code, country, phone number, fax, and web site address.

Also, appearing in the upper portion of the central display window 262, just above the table 362, there are hyperlinks labeled: (1) “Attachments” 364a that re-direct the carrier to a screen that displays attachments associated with and posted by the shipper; and (2) “Send Message” 364b which re-directs the carrier to an internal message form (not shown) that can be used to send electronic messages to the shipper.

Finally, in the lower portion of the central display window 262, it is contemplated and preferred pending requests for quotation (“RFQ”) by the particular shipper be displayed. In the example of FIG. 33, one RFQ 366 is displayed, the same RFQ that is displayed in the right pane 262b of the central display window 262 of the MAIN SHIPPER SCREEN 260.

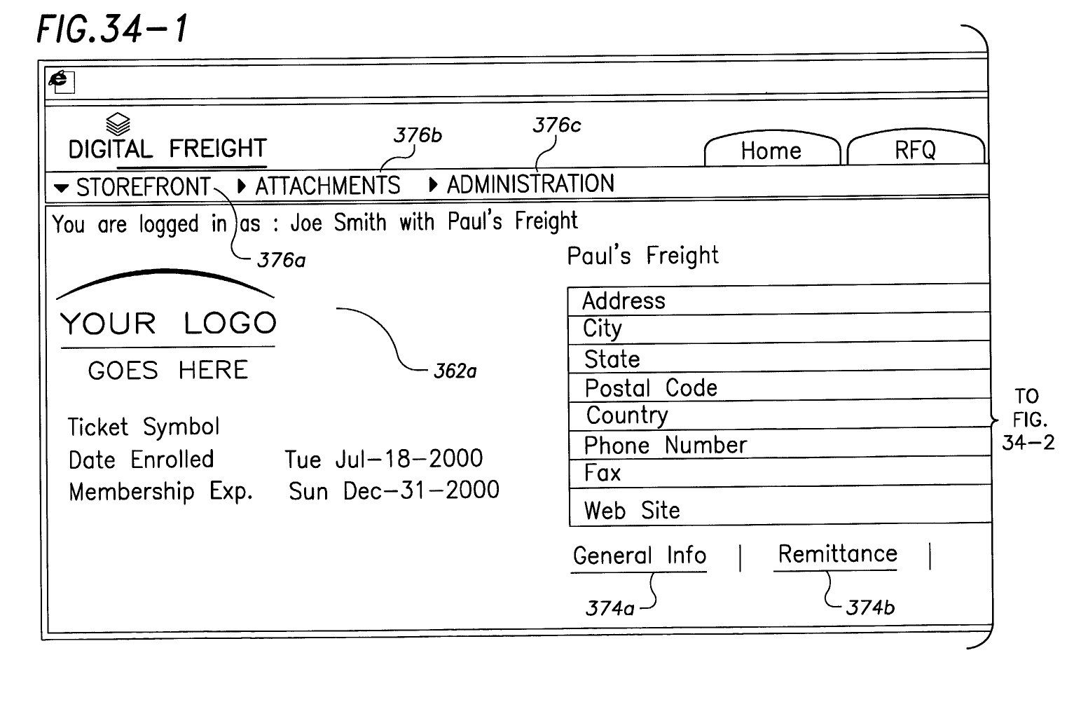

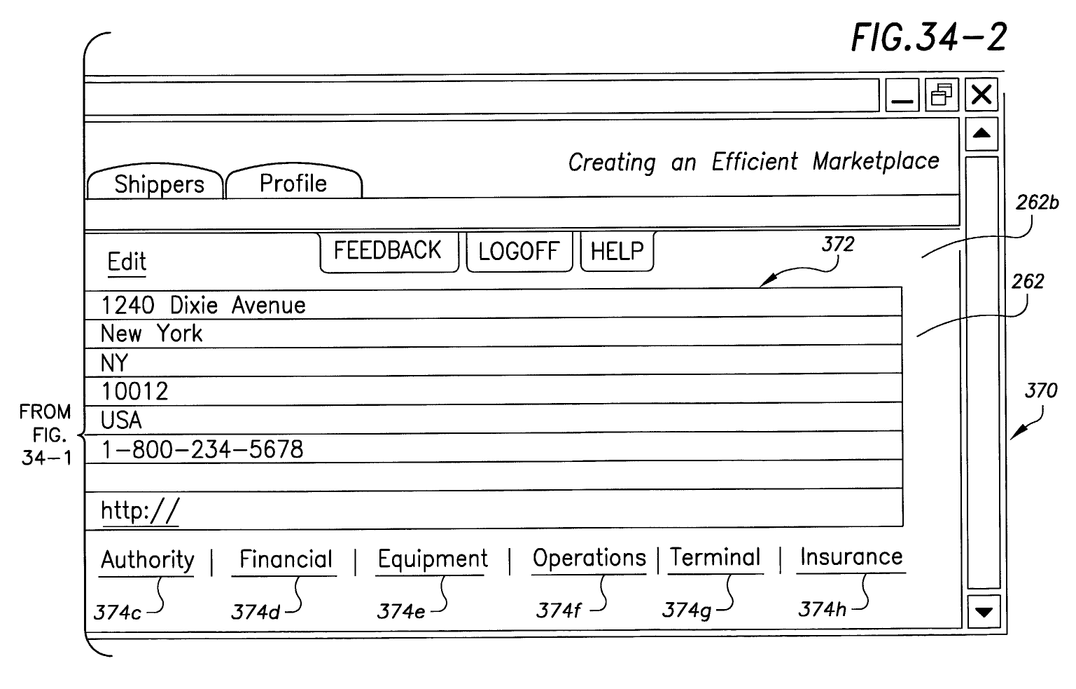

FIG. 34 depicts a preferred CARRIER PROFILE SCREEN 370 in the preferred embodiment described herein, a screen that is accessed through the selection of the PROFILE tab 264d from a carrier screen. The CARRIER PROFILE SCREEN 370 of FIG. 34 is essentially identical to the CARRIER STOREFRONT SCREEN 220 of FIG. 19.

Various information and hyperlinks can be displayed in the central display window 262 of the CARRIER PROFILE SCREEN 370. In this particular example, in a left pane 262a of the central display window 262, there is an image field for the inclusion of a company logo, and information about the “Date Enrolled” with the system information about the “Date Enrolled” with the system and associated “Membership Exp[iration]” date. Secondly, and most prominently, in the right pane 262b of the central display window 262, there is a table 372 providing identifying information about the carrier, including address, city, state, postal code, country, phone number, fax, and web site address.

Appearing in the lower portion of the central display window 262, just below the table 372, there are hyperlinks labeled: (1) “General Info” 374a; (2) “Remittance” 374b; (3) “Authority” 374c; (4) “Financial” 374d; (5) “Equipment” 374e; (6) “Operations” 374f; “Terminal” 374g; and (7) “Insurance” 374h.

By selecting the “General Info” hyperlink 374a, the carrier is re-directed to a screen (not shown) displaying its detailed identifying and contact information.

By selecting the “Remittance” hyperlink 374b,the shipper is re-directed to a screen (not shown) displaying its remittance contact information.

By selecting the “Authority” hyperlink 374c, the carrier is re-directed to a screen (not shown) displaying detailed information about its authority to operate in various jurisdictions and under various licenses.

By selecting the “Financial” hyperlink 374d, the carrier is re-directed to a screen (not shown) displaying detailed information about its financial status, including, but not limited to, gross revenues, operating ratio, and debt/equity ratio.

By selecting the “Equipment” 374e hyperlink, the carrier is re-directed to a screen (not shown) displaying detailed information about its equipment, including, but not limited to, number of tractors owned, leased trailers, total trailers, number of driving teams, etc.

By selecting the “Operations” 374f hyperlink, the carrier is re-directed to a screen (not shown) displaying detailed information about its operations, including, but not limited to, mileage standard, most desirable origins and destinations, least desirable origins and destinations, and Department of Transportation (“DOT”) safety rating data.

By selecting the “Terminal” 374g, the carrier is re-directed to a screen (not shown) displaying detailed information about its terminal locations.

By selecting the “Insurance” 374h hyperlink, the carrier is re-directed to a screen (not shown) displaying detailed information about its insurance coverage.

As mentioned above, it is contemplated that a great breadth of information could be maintained in the integral database associated with the method and system of the present invention creating a valuable document repository for the shipping and transportation industry.

As yet a further refinement, as shown in FIG. 34, there is a series hyperlinks 376 on the menu bar 267 that is positioned between the tabs 264 and buttons 266 of the CARRIER PROFILE SCREEN 370. The first hyperlink 376a is labeled “STOREFRONT” and its function is described below.

The second hyperlink 376b is labeled “ATTACHMENTS.” By selecting the ATTACHMENTS hyperlink 376b on the menu bar 267, the carrier is re-directed to a screen (not shown) that allows it to review, delete, or add attachments. As defined above, an “attachment” may be a letter, table, spreadsheet or other electronic document.

The third hyperlink 376c is labeled “ADMINISTRATION.” By selecting the ADMINISTRATION hyperlink 376c on the menu bar 267, the carrier is re-directed to a screen (not shown) that displays a list of the individual authorized users.

Returning now to the “STOREFRONT” hyperlink 376a, when the carrier is on a screen related to the ATTACHMENTS or ADMINISTRATION functions, selection of this hyperlink 376a returns the carrier to the CARRIER PROFILE SCREEN 370 of FIG. 34.

Lastly, with respect to the CARRIER PROFILE SCREEN 370 of FIG. 34, appearing in the upper portion of the central display window 262, just above the table 372, there is a hyperlink labeled “Edit.” Selection of this hyperlink re-directs the carrier to a screen (not shown) from which changes to any of the identifying information described above can be made and saved in the integral database.

Finally, as mentioned above, FIG. 35 depicts a pop-up window 380 displayed in the Internet browser, a window that is open through the selection of the HELP button 266c of a carrier screen. Displayed in this pop-window is various information about this preferred embodiment of the present invention, along with hyperlinks directing the carrier to other useful information about this preferred embodiment of the present invention.

As mentioned at the outset, to carry out execution of the routines and subroutines of the preferred method and system described above, it is understood that standard Hypertext Markup Language (HTML) and associated programming languages and techniques would be used. With benefit of the foregoing description, such programming is readily accomplished by one of ordinary skill in the art.

Thus, this preferred embodiment of the method and system of the present invention achieves the paramount object of the present invention and establishes an efficient marketplace for the negotiation of transportation contracts between shippers and carriers. At the same time, it can be easily seen that the preferred method and system as described herein provides numerous other advantages to both shippers and carriers in the process of negotiating transportation contracts.

Furthermore, it will be obvious to those skilled in the art that modifications may be made to the preferred embodiments described herein without departing from the spirit and scope of the present invention.

1. A system for negotiating transportation contracts through a computer network, comprising:
a database storing and maintaining identifying information related to a plurality of users, said users having registered with the system and being classified as either a shipper or a carrier;
wherein said database also stores and maintains data associated with at least one request for quotation defining a particular shipper's transportation requirements and comprised of a plurality of transportation lanes;
wherein one or more carriers access said system through the computer network to review said at least one request for quotation; and
wherein each of said carriers can submit bids on one or more of the plurality of transportation lanes comprising said request for quotation.

2. A system as recited in claim 1, wherein the particular shipper can review bids submitted by said carriers, and then can award transportation lanes to one or more carriers based on said submitted bids.

3. A system as recited in claim 2, wherein each of said carriers can review awards made by the particular shipper and can accept the award of one or more transportation lanes.

4. A system as recited in claim 1, wherein said at least one request for quotation further comprises one or more accessorials, and wherein, when said one or more carriers access said system through the computer network to review said at least one request for quotation, said carriers can also review said accessorials and can submit bids on said accessorials.

5. A system as recited in claim 4, wherein the particular shipper can review bids submitted by said carriers for said lanes and accessorials, and then can award transportation lanes to one or more carriers based on said submitted bids.

6. A system as recited in claim 5, wherein each of said carriers can review awards made by the particular shipper and can accept the award of one or more transportation lanes.

7. A system as recited in claim 1, wherein said at least one request for quotation further comprises at least one FAK bidding matrix, and wherein, when said one or more carriers access said system through the computer network to review said at least one request for quotation, said carriers can also review said matrix and can submit bids on one or more transportation routes defined by said matrix.

8. A system as recited in claim 7, wherein the particular shipper can review bids submitted by said carriers for said lanes and matrix, and then can award transportation lanes to one or more carriers based on said submitted bids.

9. A system as recited in claim 8, wherein each of said carriers can review awards made by the particular shipper and can accept the award of one or more transportation lanes.

10. A system as recited in claim 1, and furthering comprising a filtering mechanism, thereby allowing each of said carriers to filter and view said transportation lanes comprising said at least one request for quotation based on one or more criteria.

11. A system as recited in claim 10, wherein said one or more criteria is selected from the group consisting of: origin, destination, range of miles, and equipment type.

12. A system as recited in claim 1, wherein said computer network is the World Wide Web portion of the global Internet.

13. A system as recited in claim 12, wherein said system is accessed by users through an Internet browser.

14. A method for negotiating transportation contracts through a computer network between a shipper and one or more carriers, comprising the steps of:
providing said shipper access to a computer server through said computer network, wherein a database resident on said server stores and maintains data associated with at least one request for quotation defining said shipper's transportation requirements and comprised of a plurality of transportation lanes; and
providing said one or more carriers access to said computer server through said computer network such that said carriers can review said at least one request for quotation and can submit bids on one or more transportation lanes that comprise said request for quotation.

15. A method as recited in claim 14, wherein can said shipper accessing the computer server can view bids submitted by said carriers and then can award transportation lanes to one or more of said carriers based on said submitted bids.

16. A method as recited in claim 15, wherein said carriers accessing the computer server can review awards made by said shipper and can accept the award of one or more transportation lanes.

17. A method as recited in claim 15, wherein said at least one request for quotation further comprises one or more accessorials, and wherein, when said one or more carriers review said at least one request for quotation, said carriers can also review said accessorials and can submit bids on said accessorials.

18. A method as recited in claim 15, wherein said at least one request for quotation further comprises at least one FAK bidding matrix, and wherein, when said one or more carriers review said at least one request for quotation, said carriers can also review said matrix and can submit bids on one or more transportation routes defined by said matrix.

19. A method as recited in claim 14, wherein said computer network is the World Wide Web portion of the global Internet.

20. A system as recited in claim 19, wherein said shipper and said carriers access to said computer server through said computer network through an Internet browser.

21. A method for negotiating transportation contracts through a computer network in which:
a shipper submits a request for quotation defining said shipper's transportation requirements and comprised of a plurality of transportation lanes, said request for quotation being stored and maintained on a computer server accessible through said computer network;
one or more carriers review said request for quotation by accessing said server through said computer network, and said one or more carriers submit bids on one or more transportation lanes comprising said request for quotation; and
said shipper awards one or more transportation lanes to one or more of said carriers based on a review of the bids submitted by each said carrier.

22. A method as recited in claim 21 in which:
each of said carriers reviews awards of transportation lanes made by said shipper, and then can accept the award of one or more transportation lanes.

23. A network for negotiating transportation contracts, including:
a multiplicity of individual carrier computers for accessing a database resident on a central computer that is integrally connected to said network, said database storing and maintaining identifying information related to said carrier computers;
at least one shipper computer for accessing the database resident on the central computer that is integrally connected to said network, said database also storing and maintaining identifying information related to said at least one shipper computer, and said database also storing and maintaining data associated with at least one request for quotation comprised of a plurality of transportation lanes;
wherein said carrier computers access said network to review said at least one request for quotation; and
wherein said carrier computers can submit bids on one or more of the plurality of transportation lanes comprising said request for quotation.

24. A network as recited in claim 23, wherein said central computer, in response to the receipt of one or more bids on the plurality of transportation lanes comprising said request for quotation, notifies said at least one shipper computer of such receipt.

25. A network as recited in claim 24, wherein said shipper computer, in response to the notification from said central computer, can review bids submitted by said carriers, and then can award transportation lanes to one or more carriers based on said submitted bids.

26. A system for communicating among shippers and carriers requests for quotations for shipping and bids for shipping through a computer network, comprising:
(a) a database for storing and maintaining
(i) identifying information related to a plurality of users, said users having registered with the system and being classified as either a shipper or a carrier, and
(ii) data associated with at least one request for quotation defining a particular shipper's transportation requirements and comprised of a plurality of transportation lanes; and
(b) computer network access means for
(i) allowing access by one or more carriers for the review of said request for quotations and for submitting bids to accomplish said transportation requirements including one or more of the plurality of transportation lanes, and
(ii) allowing said particular shipper to accept a particular carrier's bid from among one or more said carriers .
